(19) United States
(12) Patent Application Publication
(10) Pub. No.: US 2025/0227761 A1
(43) Pub. Date: Jul. 10, 2025

(54) ADAPTING RANDOM ACCESS OPPORTUNITIES PER SYNCHRONIZATION SIGNAL BLOCK INDEX FOR NETWORK ENERGY SAVINGS

(71) Applicant: QUALCOMM Incorporated, San Diego, CA (US)

(72) Inventors: Ahmed Attia ABOTABL, San Diego, CA (US); Hung Dinh LY, San Diego, CA (US)

(21) Appl. No.: 18/405,745

(22) Filed: Jan. 5, 2024

(51) Int. Cl. H04W 74/0833; H04W 48/08

(52) U.S. Cl. CPC H04W 74/0833; H04W 48/08

(57) ABSTRACT

Methods, systems, and devices for wireless communication are described. In some aspects, a network entity may allocate or configure multiple different quantities of random access channel (RACH) occasions and/or random access preambles, with each of the multiple different quantities of RACH occasions and/or random access preambles being associated with a respective synchronization signal block (SSB) index of a set of SSB indices. The network entity may allocate or configure a quantity of RACH occasions and/or random access preambles per SSB index based on a quantity of user equipments (UEs) served by the network entity in a direction associated with that SSB index. For example, the network entity may serve a coverage region associated with an SSB index and may allocate a quantity of RACH occasions and/or random access preambles for the SSB index based on a quantity of UEs within the coverage region.

### INTRODUCTION

The following relates to wireless communication, including managing random access opportunities for network energy savings (NES).

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

A method for wireless communication by a UE is described. The method may include receiving information indicative of a set of multiple quantities of random access channel (RACH) occasions associated with a set of multiple synchronization signal (SS) block (SSB) indices, each quantity of RACH occasions of the set of multiple quantities of RACH occasions associated with a respective SSB index of the set of multiple SSB indices and transmitting a message via a RACH occasion in accordance with the information.

An apparatus for wireless communication at a UE is described. The apparatus may include one or more memories and one or more processors coupled with the one or more memories. The one or more processors may be configured to cause the UE to receive information indicative of a set of multiple quantities of RACH occasions associated with a set of multiple SSB indices, each quantity of RACH occasions of the set of multiple quantities of RACH occasions associated with a respective SSB index of the set of multiple SSB indices and transmit a message via a RACH occasion in accordance with the information.

Another apparatus for wireless communication at a UE is described. The apparatus may include means for receiving information indicative of a set of multiple quantities of RACH occasions associated with a set of multiple SSB indices, each quantity of RACH occasions of the set of multiple quantities of RACH occasions associated with a respective SSB index of the set of multiple SSB indices and means for transmitting a message via a RACH occasion in accordance with the information.

A non-transitory computer-readable medium storing code for wireless communication at a UE is described. The code may include instructions executable by one or more processors to receive information indicative of a set of multiple quantities of RACH occasions associated with a set of multiple SSB indices, each quantity of RACH occasions of the set of multiple quantities of RACH occasions associated with a respective SSB index of the set of multiple SSB indices and transmit a message via a RACH occasion in accordance with the information.

In some examples of the method, UEs, and non-transitory computer-readable medium described herein, receiving the information may include operations, features, means, or instructions for receiving the information via one or more fields of a RACH configuration information element.

In some examples of the method, UEs, and non-transitory computer-readable medium described herein, the one or more fields includes a single field, the single field including an indication of each quantity of RACH occasions of the set of multiple quantities of RACH occasions.

In some examples of the method, UEs, and non-transitory computer-readable medium described herein, a length of the single field may be based on a quantity of the set of multiple SSB indices.

In some examples of the method, UEs, and non-transitory computer-readable medium described herein, the one or more fields include a first field and a second field, the first field including an indication of a baseline quantity of RACH occasions and the second field including a set of multiple deltas from the baseline quantity of RACH occasions, each quantity of RACH occasions of the set of multiple quantities of RACH occasions being associated with a respective delta, of the set of multiple deltas, from the baseline quantity of RACH occasions.

In some examples of the method, UEs, and non-transitory computer-readable medium described herein, a length of the second field may be based on a quantity of the set of multiple SSB indices.

Some examples of the method, UEs, and non-transitory computer-readable medium described herein may further include operations, features, means, or instructions for mapping the set of multiple SSB indices to RACH occasions in accordance with the information, the transmitting of the message based on the mapping of the set of multiple SSB indices to the RACH occasions.

In some examples of the method, UEs, and non-transitory computer-readable medium described herein, mapping the set of multiple SSB indices to the RACH occasions may include operations, features, means, or instructions for mapping a first SSB index to a first subset of RACH occasions, the first subset of RACH occasions including a first quantity of RACH occasions, the first quantity of RACH occasions associated with the first SSB index in accordance with the information and mapping a second SSB index to a second subset of RACH occasions, the second subset of RACH occasions including a second quantity of RACH occasions, the second quantity of RACH occasions associated with the second SSB index in accordance with the information, the mapping of the second SSB index to the second subset of RACH occasions occurring after the mapping of the first SSB index to the first subset of RACH occasions in accordance with a mapping order.

In some examples of the method, UEs, and non-transitory computer-readable medium described herein, mapping the set of multiple SSB indices to the RACH occasions may include operations, features, means, or instructions for mapping a first SSB index to a first subset of RACH occasions, the first subset of RACH occasions including a largest quantity of RACH occasions of the set of multiple quantities of RACH occasions and obtaining a remainder of the first subset of RACH occasions based on a removal of one or more RACH occasions from the first subset of RACH occasions, the remainder of the first subset of RACH occasions including a first quantity of RACH occasions, the first quantity of RACH occasions associated with the first SSB index in accordance with the information.

Some examples of the method, UEs, and non-transitory computer-readable medium described herein may further include operations, features, means, or instructions for receiving the information indicative of the set of multiple quantities of RACH occasions associated with the set of multiple SSB indices via a paging indication.

Some examples of the method, UEs, and non-transitory computer-readable medium described herein may further include operations, features, means, or instructions for receiving the information indicative of the set of multiple quantities of RACH occasions associated with the set of multiple SSB indices via radio resource control (RRC) signaling.

Some examples of the method, UEs, and non-transitory computer-readable medium described herein may further include operations, features, means, or instructions for receiving the information indicative of the set of multiple quantities of RACH occasions associated with the set of multiple SSB indices via a system information block (SIB).

Some examples of the method, UEs, and non-transitory computer-readable medium described herein may further include operations, features, means, or instructions for receiving an indication of an SSB index of the set of multiple SSB indices, the SSB index being associated with a directional communication between the UE and a network entity and selecting the RACH occasion from a quantity of RACH occasions associated with the SSB index.

A method for wireless communication by a UE is described. The method may include receiving information indicative of a set of multiple quantities of random access preambles associated with a set of multiple SSB indices, each quantity of random access preambles of the set of multiple quantities of random access preambles associated with a respective SSB index of the set of multiple SSB indices and transmitting, via a RACH occasion, a message including a random access preamble in accordance with the information.

An apparatus for wireless communication at a UE is described. The apparatus may include one or more memories and one or more processors coupled with the one or more memories. The one or more processors may be configured to cause the UE to receive information indicative of a set of multiple quantities of random access preambles associated with a set of multiple SSB indices, each quantity of random access preambles of the set of multiple quantities of random access preambles associated with a respective SSB index of the set of multiple SSB indices and transmit, via a RACH occasion, a message including a random access preamble in accordance with the information.

Another apparatus for wireless communication at a UE is described. The apparatus may include means for receiving information indicative of a set of multiple quantities of random access preambles associated with a set of multiple SSB indices, each quantity of random access preambles of the set of multiple quantities of random access preambles associated with a respective SSB index of the set of multiple SSB indices and means for transmitting, via a RACH occasion, a message including a random access preamble in accordance with the information.

A non-transitory computer-readable medium storing code for wireless communication at a UE is described. The code may include instructions executable by one or more processors to receive information indicative of a set of multiple quantities of random access preambles associated with a set of multiple SSB indices, each quantity of random access preambles of the set of multiple quantities of random access preambles associated with a respective SSB index of the set of multiple SSB indices and transmit, via a RACH occasion, a message including a random access preamble in accordance with the information.

In some examples of the method, UEs, and non-transitory computer-readable medium described herein, receiving the information may include operations, features, means, or instructions for receiving the information via one or more fields of a RACH configuration information element.

In some examples of the method, UEs, and non-transitory computer-readable medium described herein, the one or more fields include a single field, the single field including an indication of each quantity of random access preambles of the set of multiple quantities of random access preambles.

In some examples of the method, UEs, and non-transitory computer-readable medium described herein, a length of the single field may be based on a quantity of the set of multiple SSB indices.

In some examples of the method, UEs, and non-transitory computer-readable medium described herein, the one or more fields include a first field and a second field, the first field including an indication of a baseline quantity of random access preambles and the second field including a set of multiple deltas from the baseline quantity of random access preambles, each quantity of random access preambles of the set of multiple quantities of random access preambles being associated with a respective delta, of the set of multiple deltas, from the baseline quantity of random access preambles.

In some examples of the method, UEs, and non-transitory computer-readable medium described herein, a length of the second field may be based on a quantity of the set of multiple SSB indices.

Some examples of the method, UEs, and non-transitory computer-readable medium described herein may further include operations, features, means, or instructions for selecting a first upper limit quantity of random access preambles per RACH occasion associated with a first SSB index of the set of multiple SSB indices, the first upper limit quantity of random access preambles per RACH occasion being equal to a product of a first quantity of random access preambles and a larger of a value of one or a quantity of SSB indices per RACH occasion, the first quantity of random access preambles associated with the first SSB index in accordance with the information and selecting a second upper limit quantity of random access preambles per RACH occasion associated with a second SSB index of the set of multiple SSB indices, the second upper limit quantity of random access preambles per RACH occasion being equal to a product of a second quantity of random access preambles and a larger of the value of one or the quantity of SSB indices per RACH occasion, the second quantity of random access preambles associated with the second SSB index in accordance with the information.

Some examples of the method, UEs, and non-transitory computer-readable medium described herein may further include operations, features, means, or instructions for selecting an upper limit quantity of random access preambles per RACH occasion in accordance with a product of a quantity of random access preambles and a larger of a value of one or a quantity of SSB indices per RACH occasion, the quantity of random access preambles being a largest quantity of random access preambles of the set of multiple quantities of random access preambles.

In some examples of the method, UEs, and non-transitory computer-readable medium described herein, the upper limit quantity of random access preambles per RACH occasion may be used equally across the set of multiple SSB indices.

Some examples of the method, UEs, and non-transitory computer-readable medium described herein may further include operations, features, means, or instructions for receiving the information indicative of the set of multiple quantities of RACH occasions associated with the set of multiple SSB indices via a paging indication.

Some examples of the method, UEs, and non-transitory computer-readable medium described herein may further include operations, features, means, or instructions for receiving the information indicative of the set of multiple quantities of RACH occasions associated with the set of multiple SSB indices via RRC signaling.

Some examples of the method, UEs, and non-transitory computer-readable medium described herein may further include operations, features, means, or instructions for receiving the information indicative of the set of multiple quantities of RACH occasions associated with the set of multiple SSB indices via an SIB.

Some examples of the method, UEs, and non-transitory computer-readable medium described herein may further include operations, features, means, or instructions for receiving an indication of an SSB index of the set of multiple SSB indices, the SSB index being associated with a directional communication between the UE and a network entity and selecting the random access preamble from a quantity of random access preambles associated with the SSB index.

A method for wireless communication by a network entity is described. The method may include outputting information indicative of a set of multiple quantities of RACH occasions associated with a set of multiple SSB indices, each quantity of RACH occasions of the set of multiple quantities of RACH occasions associated with a respective SSB index of the set of multiple SSB indices and obtaining one or more messages via one or more RACH occasions in accordance with the information.

An apparatus for wireless communication at a network entity is described. The apparatus may include one or more memories and one or more processors coupled with the one or more memories. The one or more processors may be configured to cause the network entity to output information indicative of a set of multiple quantities of RACH occasions associated with a set of multiple SSB indices, each quantity of RACH occasions of the set of multiple quantities of RACH occasions associated with a respective SSB index of the set of multiple SSB indices and obtain one or more messages via one or more RACH occasions in accordance with the information.

Another apparatus for wireless communication at a network entity is described. The apparatus may include means for outputting information indicative of a set of multiple quantities of RACH occasions associated with a set of multiple SSB indices, each quantity of RACH occasions of the set of multiple quantities of RACH occasions associated with a respective SSB index of the set of multiple SSB indices and means for obtaining one or more messages via one or more RACH occasions in accordance with the information.

A non-transitory computer-readable medium storing code for wireless communication at a network entity is described. The code may include instructions executable by one or more processors to output information indicative of a set of multiple quantities of RACH occasions associated with a set of multiple SSB indices, each quantity of RACH occasions of the set of multiple quantities of RACH occasions associated with a respective SSB index of the set of multiple SSB indices and obtain one or more messages via one or more RACH occasions in accordance with the information.

In some examples of the method, network entities, and non-transitory computer-readable medium described herein, outputting the information may include operations, features, means, or instructions for outputting the information via one or more fields of a RACH configuration information element.

In some examples of the method, network entities, and non-transitory computer-readable medium described herein, the one or more fields include a single field, the single field including an indication of each quantity of RACH occasions of the set of multiple quantities of RACH occasions.

In some examples of the method, network entities, and non-transitory computer-readable medium described herein, a length of the single field may be based on a quantity of the set of multiple SSB indices.

In some examples of the method, network entities, and non-transitory computer-readable medium described herein, the one or more fields include a first field and a second field, the first field including an indication of a baseline quantity of RACH occasions and the second field including a set of multiple deltas from the baseline quantity of RACH occasions, each quantity of RACH occasions of the set of multiple quantities of RACH occasions being associated with a respective delta, of the set of multiple deltas, from the baseline quantity of RACH occasions.

In some examples of the method, network entities, and non-transitory computer-readable medium described herein, a length of the second field may be based on a quantity of the set of multiple SSB indices.

Some examples of the method, network entities, and non-transitory computer-readable medium described herein may further include operations, features, means, or instructions for mapping the set of multiple SSB indices to RACH occasions in accordance with the information, the obtaining of the one or more messages based on the mapping of the set of multiple SSB indices to the RACH occasions.

In some examples of the method, network entities, and non-transitory computer-readable medium described herein, mapping the set of multiple SSB indices to the RACH occasions may include operations, features, means, or instructions for mapping a first SSB index to a first subset of RACH occasions, the first subset of RACH occasions including a first quantity of RACH occasions, the first quantity of RACH occasions associated with the first SSB index in accordance with the information and mapping a second SSB index to a second subset of RACH occasions, the second subset of RACH occasions including a second quantity of RACH occasions, the second quantity of RACH occasions associated with the second SSB index in accordance with the information, the mapping of the second SSB index to the second subset of RACH occasions occurring after the mapping of the first SSB index to the first subset of RACH occasions in accordance with a mapping order.

In some examples of the method, network entities, and non-transitory computer-readable medium described herein, mapping the set of multiple SSB indices to the RACH occasions may include operations, features, means, or instructions for mapping a first SSB index to a first subset of RACH occasions, the first subset of RACH occasions including a largest quantity of RACH occasions of the set of multiple quantities of RACH occasions and obtaining a remainder of the first subset of RACH occasions based on a removal of one or more RACH occasions from the first subset of RACH occasions, the remainder of the first subset of RACH occasions including a first quantity of RACH occasions, the first quantity of RACH occasions associated with the first SSB index in accordance with the information.

Some examples of the method, network entities, and non-transitory computer-readable medium described herein may further include operations, features, means, or instructions for outputting the information indicative of the set of multiple quantities of RACH occasions associated with the set of multiple SSB indices via a paging indication.

Some examples of the method, network entities, and non-transitory computer-readable medium described herein may further include operations, features, means, or instructions for outputting the information indicative of the set of multiple quantities of RACH occasions associated with the set of multiple SSB indices via RRC signaling.

Some examples of the method, network entities, and non-transitory computer-readable medium described herein may further include operations, features, means, or instructions for outputting the information indicative of the set of multiple quantities of RACH occasions associated with the set of multiple SSB indices via an SIB.

Some examples of the method, network entities, and non-transitory computer-readable medium described herein may further include operations, features, means, or instructions for outputting, to a UE, an indication of an SSB index of the set of multiple SSB indices, the SSB index being associated with a directional communication between the UE and the network entity and obtaining a message from the UE via at least one RACH occasion of a quantity of RACH occasions associated with the SSB index.

A method for wireless communication by a network entity is described. The method may include outputting information indicative of a set of multiple quantities of random access preambles associated with a set of multiple SSB indices, each quantity of random access preambles of the set of multiple quantities of random access preambles associated with a respective SSB index of the set of multiple SSB indices and obtaining one or more messages via one or more RACH occasions, each message of the one or more messages including a respective random access preamble in accordance with the information.

An apparatus for wireless communication at a network entity is described. The apparatus may include one or more memories and one or more processors coupled with the one or more memories. The one or more processors may be configured to cause the network entity to output information indicative of a set of multiple quantities of random access preambles associated with a set of multiple SSB indices, each quantity of random access preambles of the set of multiple quantities of random access preambles associated with a respective SSB index of the set of multiple SSB indices and obtain one or more messages via one or more RACH occasions, each message of the one or more messages including a respective random access preamble in accordance with the information.

Another apparatus for wireless communication at a network entity is described. The apparatus may include means for outputting information indicative of a set of multiple quantities of random access preambles associated with a set of multiple SSB indices, each quantity of random access preambles of the set of multiple quantities of random access preambles associated with a respective SSB index of the set of multiple SSB indices and means for obtaining one or more messages via one or more RACH occasions, each message of the one or more messages including a respective random access preamble in accordance with the information.

A non-transitory computer-readable medium storing code for wireless communication at a network entity is described. The code may include instructions executable by one or more processors to output information indicative of a set of multiple quantities of random access preambles associated with a set of multiple SSB indices, each quantity of random access preambles of the set of multiple quantities of random access preambles associated with a respective SSB index of the set of multiple SSB indices and obtain one or more messages via one or more RACH occasions, each message of the one or more messages including a respective random access preamble in accordance with the information.

In some examples of the method, network entities, and non-transitory computer-readable medium described herein, outputting the information may include operations, features, means, or instructions for outputting the information via one or more fields of a RACH configuration information element.

In some examples of the method, network entities, and non-transitory computer-readable medium described herein, the one or more fields include a single field, the single field including an indication of each quantity of random access preambles of the set of multiple quantities of random access preambles.

In some examples of the method, network entities, and non-transitory computer-readable medium described herein, a length of the single field may be based on a quantity of the set of multiple SSB indices.

In some examples of the method, network entities, and non-transitory computer-readable medium described herein, the one or more fields include a first field and a second field, the first field including an indication of a baseline quantity of random access preambles and the second field including a set of multiple deltas from the baseline quantity of random access preambles, each quantity of random access preambles of the set of multiple quantities of random access preambles being associated with a respective delta, of the set of multiple deltas, from the baseline quantity of random access preambles.

In some examples of the method, network entities, and non-transitory computer-readable medium described herein, a length of the second field may be based on a quantity of the set of multiple SSB indices.

Some examples of the method, network entities, and non-transitory computer-readable medium described herein may further include operations, features, means, or instructions for selecting a first upper limit quantity of random access preambles per RACH occasion associated with a first SSB index of the set of multiple SSB indices, the first upper limit quantity of random access preambles per RACH occasion being equal to a product of a first quantity of random access preambles and a larger of a value of one or a quantity of SSB indices per RACH occasion, the first quantity of random access preambles associated with the first SSB index in accordance with the information and selecting a second upper limit quantity of random access preambles per RACH occasion associated with a second SSB index of the set of multiple SSB indices, the second upper limit quantity of random access preambles per RACH occasion being equal to a product of a second quantity of random access preambles and a larger of the value of one or the quantity of SSB indices per RACH occasion, the second quantity of random access preambles associated with the second SSB index in accordance with the information.

Some examples of the method, network entities, and non-transitory computer-readable medium described herein may further include operations, features, means, or instructions for selecting an upper limit quantity of random access preambles per RACH occasion in accordance with a product of a quantity of random access preambles and a larger of a value of one or a quantity of SSB indices per RACH occasion, the quantity of random access preambles being a largest quantity of random access preambles of the set of multiple quantities of random access preambles.

In some examples of the method, network entities, and non-transitory computer-readable medium described herein, the upper limit quantity of random access preambles per RACH occasion may be used equally across the set of multiple SSB indices.

Some examples of the method, network entities, and non-transitory computer-readable medium described herein may further include operations, features, means, or instructions for outputting the information indicative of the set of multiple quantities of RACH occasions associated with the set of multiple SSB indices via a paging indication.

Some examples of the method, network entities, and non-transitory computer-readable medium described herein may further include operations, features, means, or instructions for outputting the information indicative of the set of multiple quantities of RACH occasions associated with the set of multiple SSB indices via RRC signaling.

Some examples of the method, network entities, and non-transitory computer-readable medium described herein may further include operations, features, means, or instructions for outputting the information indicative of the set of multiple quantities of RACH occasions associated with the set of multiple SSB indices via an SIB.

Some examples of the method, network entities, and non-transitory computer-readable medium described herein may further include operations, features, means, or instructions for outputting, to a UE, an indication of an SSB index of the set of multiple SSB indices, the SSB index being associated with a directional communication between the UE and the network entity and obtaining a message from the UE via a RACH occasion, the message including a random access preamble from a quantity of random access preambles associated with the SSB index.

### BRIEF DESCRIPTION OF THE DRAWINGS

FIG. 1 shows an example of a wireless communications system that supports adapting random access opportunities per SSB index for NES in accordance with one or more aspects of the present disclosure.

FIG. 2 shows an example of a network architecture that supports adapting random access opportunities per SSB index for NES in accordance with one or more aspects of the present disclosure.

FIG. 3 shows an example of a network deployment that supports adapting random access opportunities per SSB index for NES in accordance with one or more aspects of the present disclosure.

FIG. 4 shows an example of a signaling diagram that supports adapting random access opportunities per SSB index for NES in accordance with one or more aspects of the present disclosure.

FIGS. 5 through 7 show examples of mapping schemes that support adapting random access opportunities per SSB index for NES in accordance with one or more aspects of the present disclosure.

FIG. 8 shows an example of a signaling diagram that supports adapting random access opportunities per SSB index for NES in accordance with one or more aspects of the present disclosure.

FIG. 9 shows examples of selection schemes that support adapting random access opportunities per SSB index for NES in accordance with one or more aspects of the present disclosure.

FIG. 10 shows an example of a process flow that supports adapting random access opportunities per SSB index for NES in accordance with one or more aspects of the present disclosure.

FIG. 11 shows examples of RACH configuration elements that support adapting random access opportunities per SSB index for NES in accordance with one or more aspects of the present disclosure.

FIGS. 12 and 13 show block diagrams of devices that support adapting random access opportunities per SSB index for NES in accordance with one or more aspects of the present disclosure.

FIG. 14 shows a block diagram of a communications manager that supports adapting random access opportunities per SSB index for NES in accordance with one or more aspects of the present disclosure.

FIG. 15 shows a diagram of a system including a device that supports adapting random access opportunities per SSB index for NES in accordance with one or more aspects of the present disclosure.

FIGS. 16 and 17 show block diagrams of devices that support adapting random access opportunities per SSB index for NES in accordance with one or more aspects of the present disclosure.

FIG. 18 shows a block diagram of a communications manager that supports adapting random access opportunities per SSB index for NES in accordance with one or more aspects of the present disclosure.

FIG. 19 shows a diagram of a system including a device that supports adapting random access opportunities per SSB index for NES in accordance with one or more aspects of the present disclosure.

FIGS. 20 through 23 show flowcharts illustrating methods that support adapting random access opportunities per SSB index for NES in accordance with one or more aspects of the present disclosure.

### DETAILED DESCRIPTION

In some wireless communications systems, a UE may attempt to establish a connection with a network entity by transmitting, to the network entity, an initial access message via a RACH occasion. A RACH occasion, which may equivalently be referred to or understood as a physical random access channel (PRACH) occasion, may be a time-frequency resource (e.g., a set or group of time and frequency resources) that a network entity allocates or configures for random access communication (e.g., for random access preamble transmissions and/or for other random access signaling by one or more UEs). For example, a network entity may allocate or configure a quantity of RACH occasions, broadcast information indicative of the RACH occasions (e.g., via one or more system information blocks (SIBs)), and monitor each of the RACH occasions to attempt to detect or receive (via blind decoding) one or more random access messages (each including a random access preamble) from one or more UEs. A random access message may include or be a message 1 (msg1) or a message A (msgA) (or a portion, such as a PRACH portion, of a msgA) that includes a random access preamble (e.g., a preamble from a set of preambles configured for random access communication, such as a set of contention based preambles). In some cases, a network entity may allocate or configure a same (single) quantity of RACH occasions for each of various directions via which the network entity may serve UEs. Further, in some cases, a network entity may allocate or configure a same (single) quantity of available random access preambles for each of various directions via which the network entity may serve UEs. For example, a network entity may provide network coverage in various (and potentially many) directions, with each direction having a same quantity of (available or valid) RACH occasions and a same quantity of (available or valid) random access preambles.

A direction via which a network entity provides coverage may be associated with an SSB index. For example, a network entity may transmit an SSB in each direction (e.g., a different SSB in each different direction) for which the network entity provides coverage, with each SSB being associated with (e.g., identifiable by) a corresponding SSB index. Thus, an SSB index may be associated with a direction in which a corresponding SSB is transmitted by the network entity. Accordingly, different SSB indices (or, “indexes”) may be associated with different directions and/or coverage regions served by the network entity. In some systems, different directions and/or coverage regions may serve differing quantities of UEs. For example, a first coverage region served by a network entity may include a relatively large quantity of UEs (e.g., the first coverage region may include an office building) and a second coverage region served by the network entity may include a relatively small quantity of UEs (e.g., the second coverage region may include a lake next to the office building). In systems in which the network entity allocates or configures a same quantity of RACH occasions and a same quantity of random access preambles for each SSB index, RACH occasions and/or preambles associated with the first coverage region may be highly congested while one or more RACH occasions and/or preambles associated with the second coverage region may be unused (e.g., wasted). In other words, allocating or configuring a same quantity of RACH occasions and a same quantity of random access preambles for each SSB index may result in an inefficient resource usage. Moreover, a network entity may be expected to blind decode all RACH occasions and search for (e.g., via one or more blind decoding hypotheses) all random access preambles allocated or configured for each SSB index. In some scenarios, this may result in unnecessary power consumption related to monitoring if the network entity blind decodes unused RACH occasions and/or searches for unused random access preambles (which may be a relatively common or frequent occurrence in directions associated with relatively few UEs).

In some implementations of the present disclosure, a network entity may allocate or configure one or more different quantities of RACH occasions and/or one or more different quantities of random access preambles, with each of the one or more different quantities of RACH occasions and/or each of the one or more different quantities of random access preambles being associated with a respective SSB index of a set of SSB indices. As used herein, unless specified otherwise, a “set” may be a set of one or more. Further, a “subset” may be a set of one or more, but less than a complete (e.g., whole or full) set. For example, the network entity may serve a first coverage region associated with a first SSB index and a second coverage region associated with a second SSB index. In such examples, the network entity may allocate or configure a first quantity of RACH occasions and/or a first quantity of random access preambles for the first SSB index and a second quantity of RACH occasions and/or a second quantity of random access preambles for the second SSB index. In some implementations, the network entity may allocate or configure a quantity of RACH occasions and/or a quantity of random access preambles per SSB index (e.g., on an SSB index-basis) based on (or otherwise in accordance with) a quantity of UEs served (or likely served) by the network entity in a direction associated with that SSB index. For example, if the first coverage region serves or is likely to serve a greater quantity of UEs as compared to the second coverage region, the first quantity of RACH occasions and/or the first quantity of random access preambles may be greater than the second quantity of RACH occasions and/or the second quantity of random access preambles, respectively.

The network entity may determine (e.g., identify, ascertain, estimate, learn, or otherwise obtain) information indicative of a quantity of UEs served in each coverage region served by the network entity in one or more of various ways. In some examples, the network entity may determine how many UEs (as an estimated quantity or as an actual quantity) are served in each coverage region in accordance with detecting (e.g., counting) how many RACH attempts are made on RACH occasions corresponding to an SSB index associated with that coverage region. In such examples, the network entity may (subsequently) update the allocation or configuration of RACH occasions and/or quantities of random access preambles per SSB index based on the detected quantities of RACH attempts. Additionally, or alternatively, the network entity may determine (e.g., identify, ascertain, estimate, learn, or otherwise obtain) information associated with a geography of the coverage regions served by the network entity and determine (e.g., estimate) a quantity of UEs in a coverage region based on a geography of that coverage region. For example, the network entity may determine, based on signaling from one or more UEs and/or other network entities or based on sensing by the network entity, a location of one or more office buildings, a location of one or more parks, a location of one or more parking garages, a location of one or more apartment buildings, and/or a location of one or more lakes. In such examples, the network entity may allocate or configure relatively more RACH occasions and/or random access preambles to SSB indices associated with coverage regions inclusive of an office building and/or an apartment building and may allocate relatively fewer RACH occasions and/or random access preambles to SSB indices associated with coverage regions inclusive of a park, a parking garage, and/or a lake.

The network entity may transmit information indicative of the one or more different quantities of RACH occasions and/or the one or more different quantities of random access preambles associated with the set of SSB indices in one or more of various ways (where a quantity of RACH occasions or random access preambles may be understood as being different from another quantity of RACH occasions or random access preambles by differing by any increment, including 1, 2, 3, etc.). For example, such information indicative of the one or more different quantities of RACH occasions and/or the one or more different quantities of random access preambles may include one or more information elements, one or more fields (e.g., one or more fields within the one or more information elements), one or more bitmaps (e.g., one or more bitmaps within the one or more fields), or any combination thereof. In some implementations, the network entity may transmit the information via a single field of a RACH configuration information element (e.g., a RACH-ConfigCommon information element), with the single field including a respective indication of a quantity of RACH occasions and/or a quantity of random access preambles for each SSB index. In other words, the single field may include a first indication of a first quantity of RACH occasions and/or a second quantity of random access preambles for a first SSB index and may include a second indication of a third quantity of RACH occasions and/or a fourth quantity of random access preambles for a second SSB index, where any one or more of the various indicated quantities may be the same as or different from one or more of the other indicated quantities.

Additionally, or alternatively, the network entity may transmit the information via multiple fields of the RACH configuration information element, with a first field including an indication of a baseline and at least a second field indicating one or more deltas from the baseline. In some examples, the first field may include an indication of a baseline quantity of RACH occasions and the second field may indicate one or more deltas from the baseline quantity of RACH occasions, each of the one or more different quantities of RACH occasions being associated with (e.g., calculated or determined by) a respective delta from the baseline quantity of RACH occasions. In other words, the second field may include a first indication of a first delta for a first SSB index and the network entity and/or a UE may calculate a first quantity of RACH occasions for the first SSB index by adding (or subtracting) the first delta to (from) the baseline quantity of RACH occasions. The second field may additionally include a second indication of a second delta for a second SSB index and the network entity and/or a UE may calculate a second quantity of RACH occasions for the second SSB index by adding (or subtracting) the second delta to (from) the baseline quantity of RACH occasions, where the second delta may be the same as or different from the first delta.

Additionally, or alternatively, the first field may include an indication of a baseline quantity of random access preambles and the second field (or a third field) may indicate one or more deltas from the baseline quantity of random access preambles, each of the one or more different quantities of random access preambles being associated with (e.g., calculated or determined by) a respective delta from the baseline quantity of random access preambles. In other words, the second or third field may include a first indication of a first delta for a first SSB index and the network entity and/or a UE may calculate a first quantity of random access preambles for the first SSB index by adding (or subtracting) the first delta to (from) the baseline quantity of random access preambles. The second or third field may additionally include a second indication of a second delta for a second SSB index and the network entity and/or a UE may calculate a second quantity of random access preambles for the second SSB index by adding (or subtracting) the second delta to (from) the baseline quantity of random access preambles, where the second delta may be the same as or different from the first delta.

By non-uniformly mapping RACH occasions and/or random access preambles to different SSB indices, a network entity may allocate resources more efficiently, which may enable the network entity to avoid unnecessary monitoring and/or blind decoding and provide relatively more time-frequency resources usable for other communication. Thus, the network entity may achieve energy savings along with supporting relatively higher data rates, greater system capacity, higher throughput, and lower latency (which may result from having more time-frequency resources usable for other communication). Further, by supporting one or more of various signaling mechanisms via which information associated with multiple quantities of RACH occasions and/or multiple quantities of random access preambles are conveyed, the described techniques may collectively or individually support relatively low signaling overhead and/or backwards compatibility, or an efficient balance of both. For example, implementations in which the information is provided via a single field may maintain a relatively lowest signaling overhead. Implementations in which the information is provided via multiple (e.g., two or three) fields may more efficiently support backwards compatibility while still maintaining a relatively low signaling overhead, as devices (e.g., UEs) that support a single quantity of RACH occasions and/or a single quantity of random access preambles may parse the first field and ignore a remainder of the multiple fields.

Similarly, by supporting one or more of various mapping schemes between SSB indices and RACH occasions, the described techniques may collectively or individually support efficient resource usage and/or backwards compatibility, or an efficient balance of both. For example, some mapping schemes may support a relatively higher resource usage efficiency and some other mapping schemes may support more efficient backwards compatibility while still enabling or realizing a same or similar resource usage efficiency. Further, the network entity may apply a specific mapping scheme in accordance with whether the network entity aims to reduce how many slots and/or symbols during which the network entity is in an awake state or aims to operate with a relatively lower (peak or average) processing workload. For example, by mapping each SSB index to different subsets of RACH occasions, each subset including a separately indicated or defined quantity of RACH occasions, the network entity may reduce how many slots and/or symbols during which the network entity is in an awake state. By mapping each SSB index to different subsets of RACH occasions, each subset initially including a same quantity of RACH occasions that is subsequently reduced to obtain different remaining quantities of RACH occasions for each SSB index, the network entity may reduce a peak or average processing workload (by reducing, for at least a subset of symbols, how many RACH occasions the network entity simultaneously processes).

Moreover, by supporting one or more of various selection schemes according to which one or more upper limit quantities of random access preambles per RACH occasion can be determined (in implementations in which a quantity of random access preambles is associated with a respective SSB index), UEs and network entities may further support greater energy savings by potentially reducing how many blind decoding attempts are made across a given RACH occasion (in addition to potentially reducing how many RACH occasions are actually used). In this way, UEs and network entities may achieve greater synchronization through a mutual understanding of a same selection scheme, along with greater power savings associated with reducing blind decoding attempts and/or quantities of RACH occasions a network entity expects to monitor. Further, by using different upper limit quantities of random access preambles per RACH occasion for different SSB indices, the network entity may lower a peak or average processing workload (which may relate to power consumption by the network entity) by way of reducing how many random access preambles the network entity processes (e.g., searches for) during a given RACH occasion. By mapping a same upper limit quantity of preambles to each RACH occasion, the network entity may reduce how many RACH occasions the network entity processes (e.g., blind decodes over) by leveraging how different SSB indices are potentially or selectively associated with different total quantities of random access preambles, which may reduce power consumption and potentially enable the network entity to enter a sleep state relatively more often.

Aspects of the disclosure are initially described in the context of wireless communications systems. Aspects of the disclosure are also illustrated by and described with reference to an example network deployment, signaling diagrams, mapping schemes, selection schemes, and a process flow. Aspects of the disclosure are further illustrated by and described with reference to apparatus diagrams, system diagrams, and flowcharts that relate to adapting random access opportunities per SSB index for NES. A random access opportunity may be understood as a RACH occasion or a random access preamble, or both (such as a specific permutation of a RACH occasion and a random access preamble).

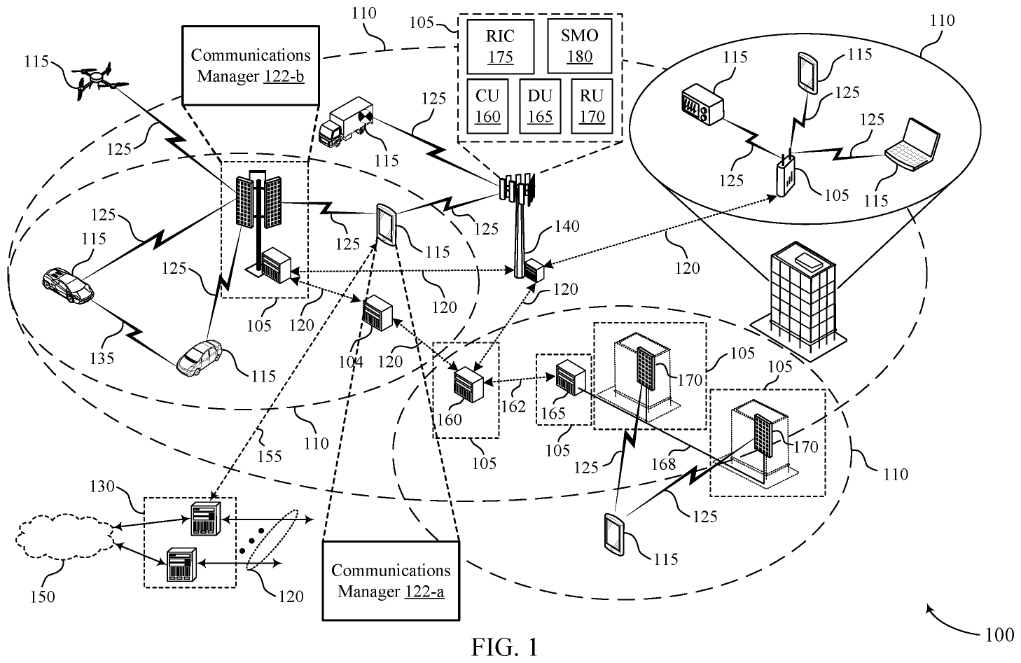

FIG. 1 shows an example of a wireless communications system 100 that supports adapting random access opportunities per SSB index for NES in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a node, a network node, or a wireless node, may be a network entity 105 (e.g., any network entity described herein, such as a base station), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support adapting random access opportunities per SSB index for NES as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The electromagnetic spectrum is often subdivided, based on frequency/wavelength, into various classes, bands, channels, etc. In 5G NR two initial operating bands have been identified as frequency range designations FR1 (410 MHz-7.125 GHZ) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

One or more wireless communication devices (e.g., one or more network entities 105 or one or more UEs 115, or any combination thereof) may support one or more mechanisms, rules, operational procedures, or operating modes associated with NES (via, for example, a communications manager). For example, one or more wireless communication devices may achieve NES via dynamic adaptation of spatial and power domain, cell discontinuous transmission (DTX), cell discontinuous reception (DRX), or any combination thereof. In some aspects, NES may be associated with relatively less power or energy (e.g., electrical energy) consumption (e.g., battery power consumption or power grid pull) at the network side to allow the network to have a longer sleep duration. For that purpose, various wireless communications systems and devices may support a relatively more compact SSB transmission, relatively more dynamic PRACH, clustered paging indications, or any combination thereof. In accordance with such techniques, a network entity 105 may transmit and/or receive signaling in a relatively short duration and, accordingly, save energy by entering and remaining in a sleep state for a relatively longer duration.

In accordance with some example implementations, one or more wireless communication devices may allow or otherwise enable direction-specific configurability for random access communication in accordance with supporting a non-uniform mapping of SSBs to RACH occasions and/or random access preambles. Such direction-specific configurability for random access communication may reduce some amount of unnecessarily configured RACH occasions and/or more efficiently tailor a quantity of available random access preambles based on (e.g., in accordance with) a projected, anticipated, known, predicted, estimated, calculated, or otherwise determined quantity of UEs 115 in a given direction (relative to a network entity 105). For example, different SSBs may relate to different directions relative to a network entity 105, and allocating or configuring a quantity of RACH occasions and/or a quantity of random access preambles per SSB may enable a network entity 105 to provide relatively more RACH occasions and/or random access preambles to directions in which there (likely) is relatively more UEs 115 and to provide relatively fewer RACH occasions and/or random access preambles to directions in which there (likely) is relatively fewer UEs 115. In accordance with reducing some amount of unnecessarily configured RACH occasions and/or more efficiently tailoring a quantity of available random access preambles, a network entity 105 may enter a relatively deeper sleep state. Such a relatively deeper sleep state may be a relatively longer sleep state and/or a state in which a network entity 105 performs relatively fewer operations (as compared to, for example, a less deep sleep state or an awake state).

For example, a UE 115, via or in accordance with a communications manager 122-a, may receive information indicative of multiple quantities of RACH occasions associated with multiple SSB indices, each quantity of RACH occasions of the multiple quantities of RACH occasions associated with a respective SSB index of the multiple SSB indices. In other words, the UE 115, via or in accordance with the communications manager 122-a, may receive an indication of a first quantity of RACH occasions associated with a first SSB index, a second quantity of RACH occasions associated with a second SSB index, and so on. The UE 115, via or in accordance with the communications manager 122-a, may transmit a message via a RACH occasion in accordance with the information. For example, directional communication between the UE 115 and a network entity 105 may be associated with the first SSB index and, in such examples, the UE 115, via or in accordance with the communications manager 122-a, may select the RACH occasion from a subset of RACH occasions to which the first quantity of RACH occasions is mapped. In some implementations, the UE 115, via or in accordance with the communications manager 122-a, may receive an indication of the first SSB index from the network entity and may determine the subset of RACH occasions based on the indication.

Additionally, or alternatively, a network entity 105, via or in accordance with a communications manager 122-b, may transmit (e.g., output, provide) information indicative of multiple quantities of RACH occasions associated with multiple SSB indices, each quantity of RACH occasions of the multiple quantities of RACH occasions associated with a respective SSB index of the multiple SSB indices. In other words, the network entity 105, via or in accordance with the communications manager 122-b, may transmit an indication of a first quantity of RACH occasions associated with a first SSB index, a second quantity of RACH occasions associated with a second SSB index, and so on. The network entity 105, via or in accordance with the communications manager 122-b, may receive (e.g., obtain) one or more messages via one or more RACH occasions in accordance with the information. For example, directional communication between a UE 115 and the network entity 105 may be associated with the first SSB index and, in such examples, the network entity 105, via or in accordance with the communications manager 122-b, may monitor a subset of RACH occasions to which the first quantity of RACH occasions is mapped to receive the message (such that the RACH occasion via which the message is received is within the subset of RACH occasions to which the first quantity of RACH occasions is mapped).

Additionally, or alternatively, the UE 115, via or in accordance with the communications manager 122-a, may receive information indicative of multiple quantities of random access preambles associated with multiple SSB indices, each quantity of random access preambles of the multiple quantities of random access preambles associated with a respective SSB index of the multiple SSB indices. In other words, the UE 115, via or in accordance with the communications manager 122-a, may receive an indication of a first quantity of random access preambles associated with a first SSB index, a second quantity of random access preambles associated with a second SSB index, and so on. The UE 115, via or in accordance with the communications manager 122-a, may transmit, via a RACH occasion, a message that includes a random access preamble in accordance with the information. For example, the UE 115, via or in accordance with the communications manager 122-a, may receive an indication of the first SSB index of the multiple SSB indices (the SSB index associated with a directional communication between the UE 115 and the network entity 105) and may select the random access preamble from the first quantity of random access preambles associated with the first SSB index.

Additionally, or alternatively, the network entity 105, via or in accordance with a communications manager 122-b, may transmit (e.g., output, provide) information indicative of multiple quantities of random access preambles associated with multiple SSB indices, each quantity of random access preambles of the multiple quantities of random access preambles associated with a respective SSB index of the multiple SSB indices. In other words, the network entity 105, via or in accordance with a communications manager 122-b, may transmit an indication of a first quantity of random access preambles associated with a first SSB index, a second quantity of random access preambles associated with a second SSB index, and so on. The network entity 105, via or in accordance with the communications manager 122-b, may receive (e.g., obtain) one or more messages, via one or more RACH occasions, in accordance with the information. For example, network entity 105, via or in accordance with a communications manager 122-b, may transmit, to a UE 115, an indication of the first SSB index of the multiple SSB indices (the SSB index associated with a directional communication between the UE 115 and the network entity 105) and may blind decode for a random access preamble from the first quantity of random access preambles associated with the first SSB index.

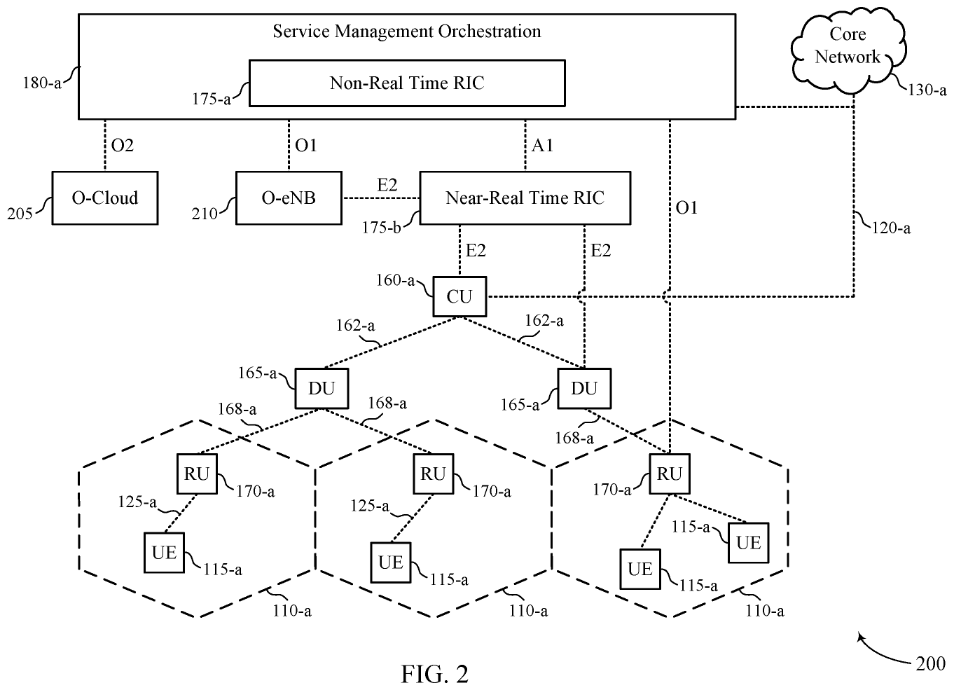

FIG. 2 shows an example of a network architecture 200 (e.g., a disaggregated base station architecture, a disaggregated RAN architecture) that supports adapting random access opportunities per SSB index for NES in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., A1 policies).

In accordance with some example implementations, a network entity 105 may non-uniformly map SSBs to quantities of RACH occasions and/or quantities of random access preambles via any one or more of a CU 160-a, a DU 165-a, an RU 170-a, a Non-RT RIC 175-a, a Near-RT RIC 175-b, an SMO 180-a, an O-Cloud 205, or an O-eNB 210. For example, any one or more of a CU 160-a, a DU 165-a, an RU 170-a, a Non-RT RIC 175-a, a Near-RT RIC 175-b, an SMO 180-a, an O-Cloud 205, or an O-eNB 210 may determine how many UEs 115 are (or are likely) served by each of a set of SSBs and may allocate or configure a quantity of RACH occasions and/or a quantity of random access preambles for each respective SSB of the set of SSBs based on how many UEs 115 are served by that respective SSB.

A UE 115 being served by an SSB of a set of SSBs may be understood as or relate to how a UE 115 is associated with a direction from the network entity that corresponds to the SSB. In other words, a UE 115 may be understood as being served by an SSB if the UE 115 measures that SSB with a relatively greatest signal strength relative to other SSBs of the set of SSBs. In accordance with such example implementations, different SSBs may be associated with (e.g., allocated or configured with) different quantities of RACH occasions and/or different quantities of random access preambles based on a distribution of UEs 115 around a network entity 105. For example, if a distribution of UEs 115 places relatively more UEs 115 within a coverage region associated with a first SSB (and likewise a first SSB index) and relatively fewer UEs 115 within a coverage region associated with a second SSB (and likewise a second SSB index), a network entity 105 may allocate or configure relatively more RACH occasions and/or relatively more random access preambles for the first SSB than for the second SSB.

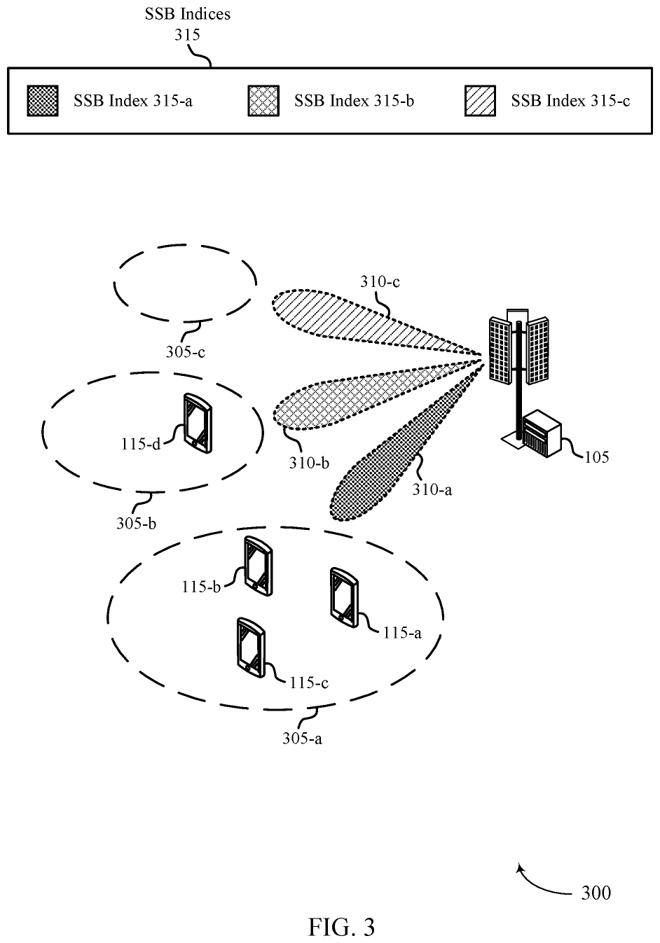

FIG. 3 shows an example of a network deployment 300 that supports adapting random access opportunities per SSB index for NES in accordance with one or more aspects of the present disclosure. The network deployment 300 may implement or be implemented to realize aspects of the wireless communications system 100 or the network architecture 200. For example, the network deployment 300 illustrates a deployment scenario in which a network entity 105 provides coverage for multiple UEs 115, with the network entity 105 and the multiple UEs 115 being examples of corresponding devices as described herein.

The multiple UEs 115 may include a UE 115-a, a UE 115-b, a UE 115-c, and a UE 115-d and may be scattered (e.g., distributed or located) throughout a coverage area (e.g., a coverage area 110) provided by the network entity 105. The coverage area provided by the network entity 105 may include a coverage region 305-a, a coverage region 305-b, and a coverage region 305-c, among other possible coverage regions. In the example of the network deployment 300, the coverage region 305-a may include the UE 115-a, the UE 115-b, and the UE 115-c, the coverage region 305-b may include the UE 115-d, and the coverage region 305-c may be absent of any UEs 115. In some aspects, each of the coverage region 305-a, the coverage region 305-b, and the coverage region 305-c may be associated with a different configuration for directional communication from the network entity 105. For example, each of the coverage region 305-a, the coverage region 305-b, and the coverage region 305-c may be associated with a different directional communication beam from the network entity 105.

As illustrated in the example of the network deployment 300, the coverage region 305-a may be associated with a directional communication beam 310-a, the coverage region 305-b may be associated with a directional communication beam 310-b, and the coverage region 305-c may be associated with a directional communication beam 310-c. In other words, the network entity 105 may provide coverage to the coverage region 305-a via the directional communication beam 310-a, may provide coverage to the coverage region 305-b via the directional communication beam 310-b, and may provide coverage to the coverage region 305-c via the directional communication beam 310-c.

In some aspects, each of the different directional communication beams provided or supported by the network entity 105 may be associated with a different SSB index. For example, the network entity 105 may transmit an SSB via each of the different directional communication beams, with each respective SSB transmitted via a respective directional communication beam being associated with a different SSB index. As illustrated in the example of the network deployment 300, the directional communication beam 310-a may be associated with an SSB index 315-a, the directional communication beam 310-b may be associated with an SSB index 315-b, and the directional communication beam 310-c may be associated with an SSB index 315-c. In other words, an SSB transmitted via the directional communication beam 310-a may be associated with (e.g., identified by) the SSB index 315-a, an SSB transmitted via the directional communication beam 310-b may be associated with (e.g., identified by) the SSB index 315-b, and an SSB transmitted via the directional communication beam 310-c may be associated with (e.g., identified by) the SSB index 315-c. Likewise, the different directional communication beams of the network deployment 300 may be understood as different SSB beams. In accordance with the directional beams providing different coverage regions and being associated with different SSB indices 315, different coverage regions may be associated with different SSB indices 315. For example, the coverage region 305-a may be associated with the SSB index 315-a, the coverage region 305-b may be associated with the SSB index 315-b, and the coverage region 305-c may be associated with the SSB index 315-c. As described herein, an SSB index 315 may be equivalently understood or referred to as an SS/physical broadcast channel (PBCH) (SS/PBCH) block index.

In some wireless communications systems, RACH configurations may be common (e.g., the same) across SSB beams. In such systems, for example, a same quantity of RACH occasions and a same quantity of random access preambles per RACH occasion may be allocated or configured for all of the SSB indices 315 (e.g., for each of the SSB index 315-a, the SSB index 315-b, and the SSB index 315-c). In accordance with the network deployment 300, such as when a UE density changes across different directions, a quantity of random access message (such as msg1 or msgA) transmissions from different UEs 115 may be different. For example, the coverage region 305-a associated with the SSB index 315-a may include relatively more UEs 115 and, accordingly, an anticipated (e.g., projected, anticipated, known, predicted, estimated, calculated, or otherwise determined) quantity of random access message transmissions via RACH occasions associated with the SSB index 315-a may be relatively larger. For instance, an anticipated quantity of random access message transmissions via RACH occasions associated with the SSB index 315-a may be relatively larger than an anticipated quantity of random access message transmissions via RACH occasions associated with the SSB index 315-b, which in turn may be relatively larger than an anticipated quantity of random access message transmissions via RACH occasions associated with the SSB index 315-c.

For further example, the directional communication beam 310-a associated with the SSB index 315-a may point towards an office building, the directional communication beam 310-b associated with the SSB index 315-b may point towards a parking lot next to the building, and the directional communication beam 310-c associated with the SSB index 315-c may point towards a lake next to the building. In such examples, the network entity 105 may receive more RACH attempts on the RACH occasions corresponding to the SSB index 315-a directed toward the office building. In scenarios in which a same quantity of RACH occasions and random access preambles per RACH occasion are allocated or configured across the SSB indices 315, however, a same quantity of RACH occasions and random access preambles per RACH occasion may be allocated or configured (e.g., defined) corresponding to the SSB index 315-c directed toward the lake as are allocated or configured corresponding to the SSB index 315-a directed toward the office building.

Such a restriction of having a same quantity of RACH occasions and random access preambles per RACH occasion for all SSB indices 315 may result in various problems. For example, the network entity 105 may be expected to blindly decode in RACH occasions that are probably not being used. In particular, for example, the network entity 105 may blindly decode in RACH occasions associated with the SSB index 315-c directed toward the lake, which may have relatively high likelihoods of being unused by any UEs 115. Further, resources (e.g., time-frequency resources) that are reserved, allocated, or configured for RACH occasions (e.g., for RACH transmissions) may be unable to be used (e.g., repurposed) for other purposes (e.g., for other communication to or from the network entity 105). Moreover, an existence or presence of RACH occasions may prohibit the network entity 105 from going into a sleep state. In other words, if one or more RACH occasions remain left to be blindly decoded, the network entity 105 may not enter a sleep state until after all RACH occasions are blindly decoded, which may result in greater network power consumption and less NES.

In accordance with some example implementations, the network entity 105 may map the SSB indices 315 to RACH occasions, and/or tailor (e.g., indicate, select, configure, update, or map) a quantity of random access preambles, non-uniformly, which may enable the network entity to target optimizations (e.g., improve resource efficiency, among other examples) in different directions as well as reduce a quantity of unnecessarily configured (e.g., unused) RACH occasions. In accordance with reducing the quantity of unnecessarily configured RACH occasions, the network entity 105 may enter a deeper sleep state (for potentially a longer duration).

In some implementations, the network entity 105 may configure and indicate multiple different quantities of RACH occasions associated with the SSB indices 315, with each quantity of RACH occasions being associated with (such as mapping to) a respective SSB index 315. For example, the network entity 105 may configure and indicate a first quantity of RACH occasions for the SSB index 315-a, a second quantity of RACH occasions for the SSB index 315-b, and a third quantity of RACH occasions for the SSB index 315-c. In examples in which the coverage region 305-a associated with the SSB index 315-a includes a relatively largest quantity of UEs 115 and the coverage region 305-c associated with the SSB index 315-c includes a relatively smallest quantity of UEs 115, the first quantity of RACH occasions may be relatively larger than the third quantity of RACH occasions.

Additionally, or alternatively, the network entity 105 may configure and indicate multiple different quantities of random access preambles associated with the SSB indices 315, with each quantity of random access preambles being associated with (such as mapping to) a respective SSB index 315. For example, the network entity 105 may configure and indicate a first quantity of random access preambles for the SSB index 315-a, a second quantity of random access preambles for the SSB index 315-b, and a third quantity of random access preambles for the SSB index 315-c. In examples in which the coverage region 305-a associated with the SSB index 315-a includes a relatively largest quantity of UEs 115 and the coverage region 305-c associated with the SSB index 315-c includes a relatively smallest quantity of UEs 115, the first quantity of random access preambles may be relatively larger than the third quantity of random access preambles.

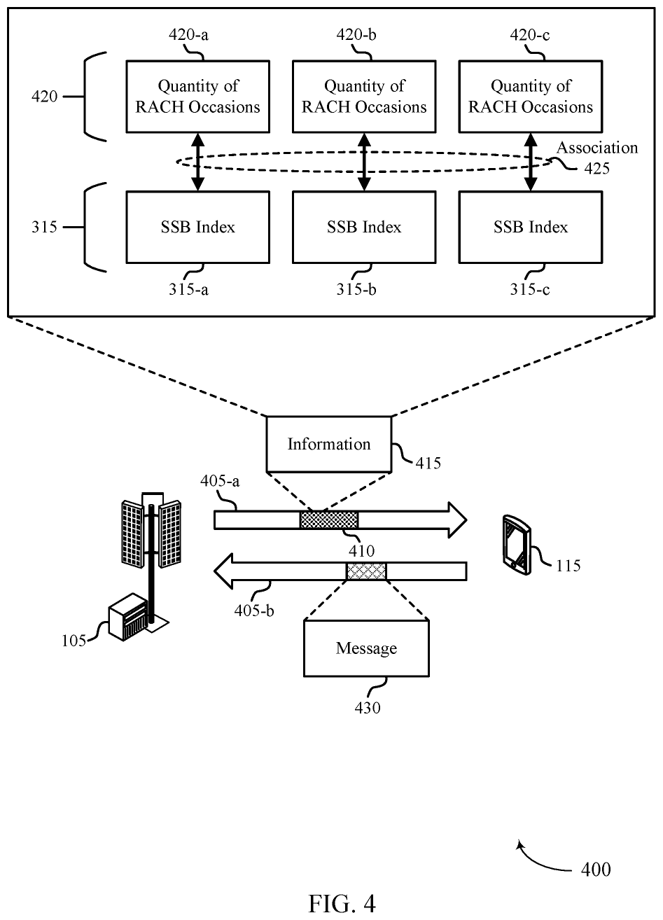

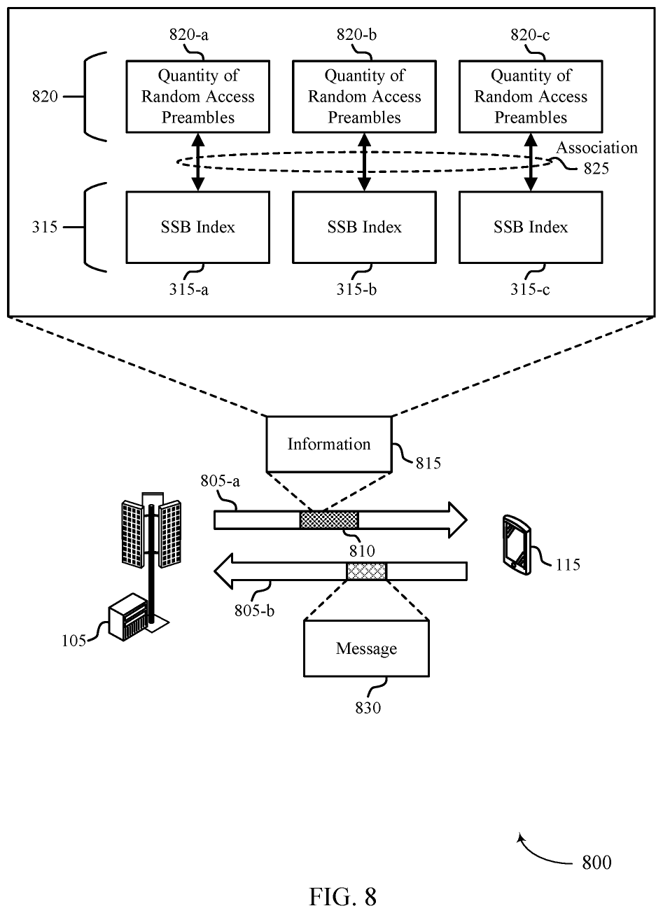

In accordance with any one or more of such example implementations, the network entity 105 may expend energy more proportionally to a quantity of UEs served in each of various directions. For example, the network entity 105 may monitor relatively more RACH occasions and/or blind decode in accordance with relatively more random access preambles in SSB beam directions associated with relatively more UEs 115 and may monitor relatively fewer RACH occasions and/or blind decode in accordance with relatively fewer random access preambles in SSB beam directions associated with relatively fewer UEs 115. Accordingly, the network entity 105 may spend more energy on random access communication associated with SSB indices 315 corresponding to (e.g., serving) more UEs 115 and may spend less energy on random access communication associated with SSB indices 315 corresponding to fewer UEs 115. In some implementations, a network entity 105 and a UE 115 (e.g., any one of the UE 115-a, the UE 115-b, the UE 115-c, or the UE 115-d) may support one or more signaling mechanisms associated with such a non-uniform mapping of SSB indices 315 to quantities of RACH occasions and/or quantities of random access preambles, as illustrated and described in more detail herein, including by and with reference to FIGS. 4 and 8.

FIG. 4 shows an example of a signaling diagram 400 that supports adapting random access opportunities per SSB index for NES in accordance with one or more aspects of the present disclosure. The signaling diagram 400 may implement or be implemented to facilitate or realize aspects of the wireless communications system 100, the network architecture 200, or the network deployment 300. For example, the signaling diagram 400 illustrates communication between a network entity 105 and a UE 115, which may be examples of corresponding device as described herein, including with reference to FIGS. 1-3. In some implementations, the network entity 105 and the UE 115 may achieve a non-uniform mapping of SSB indices 315 to quantities of RACH occasions 420 by supporting one or more aspects of the signaling diagram 400.

For example, the network entity 105 may transmit, to the UE 115 via a communication link 405-a (e.g., a downlink), a control message 410 including information 415 indicative of multiple (e.g., a multitude of, such as two or more) quantities of RACH occasions 420 associated with multiple (e.g., a multitude of, such as two or more) SSB indices 315, each quantity of RACH occasions 420 of the multiple quantities of RACH occasions 420 associated with a respective SSB index 315 of the multiple SSB indices 315. In some aspects, and as illustrated in the example of the signaling diagram 400, a quantity of the multiple quantities of RACH occasions 420 may be equal to the quantity of the multiple SSB indices 315, such that the multiple quantities of RACH occasions 420 are associated with the multiple SSB indices 315 on a one-to-one (e.g., 1:1) basis. In some other aspects, the quantities may be different, such that the multiple quantities of RACH occasions 420 are associated with the multiple SSB indices 315 on a one-to-many (e.g., 1:M) basis (e.g., with a given quantity of RACH occasions corresponding to two or more SSB indices 315), or such that the multiple SSB indices 315 are associated with the multiple quantities of RACH occasions 420 on a one-to-many (e.g., 1:M) basis (e.g., with a given SSB index 315 corresponding to two or more quantities of RACH occasions 420).

The control message 410 may be, include, or may be conveyed via a paging indication, RRC signaling, a SIB, or any combination thereof, among other examples. For example, the control message 410 may alternatively be conveyed as downlink control information (DCI) or one or more MAC control elements (MAC-CEs). Further, RRC connected UEs 115 may receive the same configuration (e.g., the information 415) for different numbers of RACH occasions per SSB with an RRC configuration (e.g., in addition to via a paging indication, a SIB, or other signaling). The control message 410 may include a single control message 410 or may include multiple control messages 410. In examples in which the network entity 105 transmits multiple control messages 410, each of the control messages 410 may convey the information 415 or the information 415 may be spread (e.g., split or distributed) across the multiple control messages 410 (e.g., different portions of the information 415 may be provided by different ones of the multiple control messages 410). Additionally, or alternatively, the information 415 may be pre-configured or pre-loaded in one or more memories of one or both of the network entity 105 and the UE 115.

The network entity 105 may convey, and the UE 115 may receive, the information 415 via one or more fields of the control message 410. For example, the control message 410 may include a RACH configuration information element and one or more fields (with a field being equivalently understood as an element, a parameter, or a parameter field that includes or indicates one or more parameters) of the RACH configuration information element may convey the information 415. In other words, the network entity 105 may transmit, in RACH configurations, the number of RACH occasions per beam. In some aspects, the RACH configuration information element may be a RACH-ConfigCommon information element.

In some implementations, the RACH configuration information element may convey the information 415 via a single field. Such a single field may be an ssb-perRACH-occasionAndCB-PreamblesPerSSB field. In such implementations, the ssb-perRACH-occasionAndCB-PreamblesPerSSB field may include multiple N values, with an N value indicating that a quantity N of SSB indices 315 is mapped to 1 RACH occasion (e.g., 1 PRACH occasion), and with each N value corresponding to an SSB index 315. In other words, an N value may be indicative of a quantity of RACH occasions 420 by way of indicating how many SSB indices 315 are mapped to 1 RACH occasion. For example, a first N value of the ssb-perRACH-occasionAndCB-PreamblesPerSSB field may correspond to the SSB index 315-a and indicate that a quantity of RACH occasions 420-a are associated with the SSB index 315-a, a second N value of the ssb-perRACH-occasionAndCB-PreamblesPerSSB field may correspond to the SSB index 315-b and indicate that a quantity of RACH occasions 420-b are associated with the SSB index 315-b, and a third N value of the ssb-perRACH-occasionAndCB-PreamblesPerSSB field may correspond to the SSB index 315-c and indicate that a quantity of RACH occasions 420-c are associated with the SSB index 315-c. As described herein, an N value of one-eighth may correspond to one SSB index 315 associated with eight RACH occasions, an N value of one-fourth may correspond to one SSB index 315 associated with four RACH occasions, and so on.

Each of the multiple N values of the ssb-perRACH-occasionAndCB-PreamblesPerSSB field may correspond to an SSB index 315 of the SSB indices 315 in accordance with a signaled and/or configured mapping. In some examples, a first (initial) ordered N value in a list of the multiple N values may correspond to a lowest SSB index 315, a second (subsequent to the initial) ordered N value in a list of the multiple N values may correspond to a second lowest SSB index 315, and so on. In some other examples, a first (initial) ordered N value in a list of the multiple N values may correspond to a highest SSB index 315, a second (subsequent to the initial) ordered N value in a list of the multiple N values may correspond to a second highest SSB index 315, and so on. Other mapping schemes between the multiple N values and the SSB indices 315 are possible without exceeding the scope of the present disclosure. In any of such example mappings, a length of the single field may be associated with (e.g., based on, such as directly proportional to or at least partially influenced by) a quantity of the multiple SSB indices 315. For example, a sequence of (ssb-perRACH-occasionAndCB-PreamblesPerSSB) may be of length equal to the quantity of SSB indices 315 (e.g., SS/PBCH block indices).

Additionally, or alternatively, the RACH configuration information element may convey the information 415 via multiple fields including a first field and a second field. Such a first field may be an ssb-perRACH-occasionAndCB-PreamblesPerSSB field including an indication of a baseline quantity of RACH occasions and such a second field may be an additional field including multiple deltas from the baseline quantity of RACH occasions. In such implementations, each quantity of RACH occasions 420 may be associated with a respective delta from the baseline quantity of RACH occasions. For example, the first field (e.g., the ssb-perRACH-occasionAndCB-PreamblesPerSSB field) may include a single N value that indicates the baseline quantity of RACH occasions (e.g., by indicating a quantity of N SS/PBCH block indices mapped to 1 PRACH occasion) and the second field may include deltas relative to the single N value, with each of the different deltas corresponding to a different SSB index 315, and with any one of the different deltas being a positive value or a negative value. In some aspects, the deltas of the second field may indicate a reduction in the number of RACH occasions per SSB index 315 (such that the deltas may be negative values or may be interpreted, used, or applied as negative values, and such that the second field may be understood as a reduction vector). In some other aspects, the deltas of the second field may indicate an increase in the number of RACH occasions per SSB index 315 (such that the deltas may be positive values or may be interpreted, used, or applied as positive values).

In an example, a first delta may correspond to the SSB index 315-a and indicate that the quantity of RACH occasions 420-a are associated with the SSB index 315-a in accordance with a summation of the baseline quantity of RACH occasions and the first delta equaling the quantity of RACH occasions 420-a. Similarly, a second delta may correspond to the SSB index 315-b and indicate that the quantity of RACH occasions 420-b are associated with the SSB index 315-b in accordance with a summation of the baseline quantity of RACH occasions and the second delta equaling the quantity of RACH occasions 420-b, and so on. Each of the multiple delta values of the second field may correspond to an SSB index 315 of the SSB indices 315 in accordance with a signaled and/or configured mapping, such as any of the example mappings described with reference to a mapping between multiple N values and the SSB indices 315. Accordingly, a length of the second field may be associated with (e.g., based on, such as directly proportional to or at least partially influenced by) a quantity of the multiple SSB indices 315.

In accordance with the information 415, the multiple quantities of RACH occasions 420 may be associated with (e.g., correspond or map to) the multiple SSB indices 315. In some aspects, the multiple quantities of RACH occasions 420 may be associated with the multiple SSB indices 315 in accordance with an association 425 (e.g., a mapping). As illustrated in the example of the signaling diagram 400, and in accordance with the association 425, the quantity of RACH occasions 420-a may be associated with (e.g., correspond or map to) the SSB index 315-a, the quantity of RACH occasions 420-b may be associated with (e.g., correspond or map to) the SSB index 315-b, and the quantity of RACH occasions 420-c may be associated with (e.g., correspond or map to) the SSB index 315-c. Each of the quantity of RACH occasions 420-a, the quantity of RACH occasions 420-b, and the quantity of RACH occasions 420-c may be the same or different quantities of a set of available quantities including, for example, one-sixteenth of a RACH occasion, one-eighth of a RACH occasion, one-fourth of a RACH occasion, one-half of a RACH occasion, one RACH occasion, two RACH occasions, four RACH occasions, eight RACH occasions, or any combination thereof.

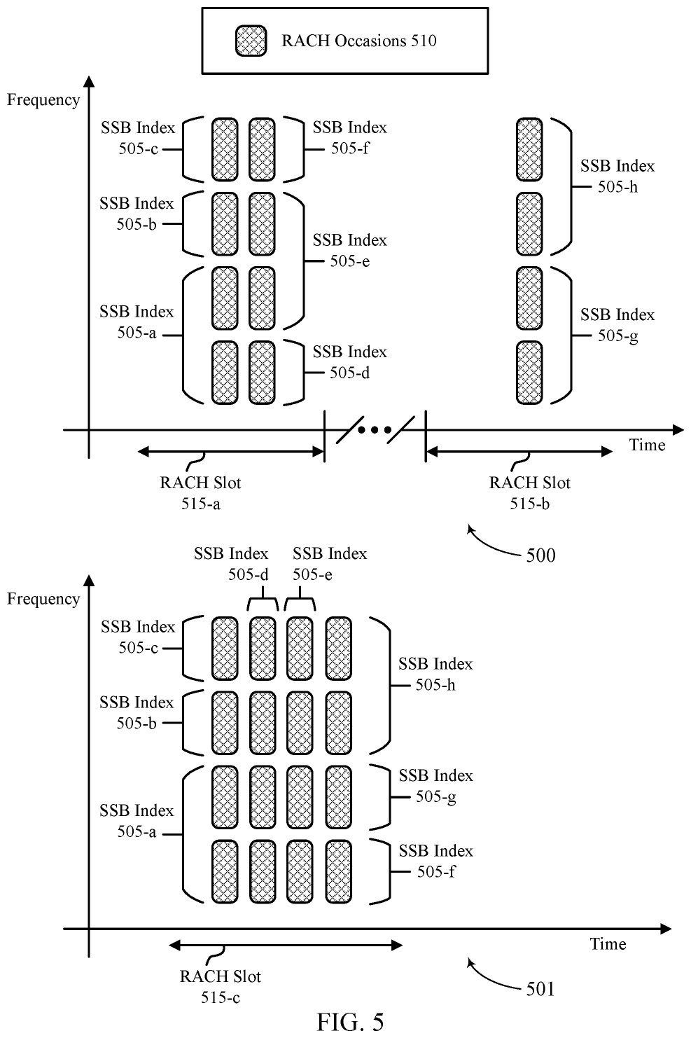

The UE 115 and the network entity 105 may map (e.g., build a correspondence between) the SSB indices 315 to RACH occasions in accordance with the information 415. In other words, the UE 115 and the network entity 105 may select, determine, identify, or otherwise ascertain which one or more RACH occasions are associated with each respective SSB index 315 in accordance with the information 415. For example, the UE 115 and the network entity 105 may select, determine, identify, or otherwise ascertain that the quantity of RACH occasions 420-a associated with the SSB index 315-a correspond to a first set of one or more RACH occasions, that the quantity of RACH occasions 420-b associated with the SSB index 315-b correspond to a second set of one or more RACH occasions, and that the quantity of RACH occasions 420-c associated with the SSB index 315-c correspond to a third set of one or more RACH occasions. Additional details relating to such a mapping of SSB indices 315 to RACH occasions are illustrated and described herein, including by and with reference to FIGS. 5-7.

The UE 115 may transmit, to the network entity 105 via a communication link 405-b (e.g., an uplink), a message 430 via a RACH occasion in accordance with the information 415 (and in accordance with the mapping of SSB indices 315 to RACH occasions). For example, the UE 115 may receive an indication of an SSB index 315 (e.g., any one of the SSB index 315-a, the SSB index 315-b, or the SSB index 315-c) of the multiple SSB indices 315, may select a RACH occasion from a quantity of RACH occasions 420 (e.g., any one of the quantity of RACH occasions 420-a, the quantity of RACH occasions 420-b, or the quantity of RACH occasions 420-c) associated with the SSB index 315, and may transmit the message 430 via the selected RACH occasion. The SSB index 315 of which the UE 115 receives an indication may be an SSB index 315 associated with a coverage region in which the UE 115 is located. For example, if the UE 115 is located within the coverage region 305-a (as illustrated by and described with reference to FIG. 3), the UE 115 may receive an indication of (or otherwise obtain, select, or identify) the SSB index 315-a and, accordingly, may select (e.g., determine or identify) a RACH occasion from the quantity of RACH occasions 420-a associated with the SSB index 315-a (in accordance with the association 425). The message 430 may be a random access message such as a msg1 or at least a portion (e.g., a PRACH portion) of a msgA. The message 430 may include a random access preamble (e.g., a PRACH preamble).

FIG. 5 shows examples of mapping schemes 500 and 501 that support adapting random access opportunities per SSB index for NES in accordance with one or more aspects of the present disclosure. The mapping schemes 500 and 501 may implement or be implemented to facilitate or realize aspects of the wireless communications system 100, the network architecture 200, the network deployment 300, or the signaling diagram 400. For example, the mapping schemes 500 and 501 illustrate how a network entity 105 and a UE 115, which may be examples of corresponding device as described herein, map SSB indices (e.g., SSB indices 315 as illustrated by and described with reference to FIGS. 3 and 4) to RACH occasions 510.

Although the multiple SSB indices 315 of FIGS. 3 and 4 are illustrated and described in the example context of including three SSB indices 315, the UE 115 and the network entity 105 may support any quantity of SSB indices 315. As illustrated in the example of the mapping schemes 500 and 501, the multiple SSB indices may include an SSB index 505-a, an SSB index 505-b, an SSB index 505-c, an SSB index 505-d, an SSB index 505-e, an SSB index 505-f, an SSB index 505-g, and an SSB index 505-h. As illustrated in the example of the mapping scheme 500, the SSB indices 505-a through 505-f may be mapped to RACH occasions 510 within a RACH slot 515-a (which may equivalently be understood as a PRACH slot) and the SSB indices 505-g and 505-h may be mapped to RACH occasions 510 within a RACH slot 515-b, although SSB indices may be mapped to any quantity (e.g., one, two, three, etc.) of RACH slots without exceeding the scope of the present disclosure. As illustrated in the example of the mapping scheme 501, the SSB indices 505-a through 505-h may be mapped to RACH occasions 510 within a RACH slot 515-c. The RACH slot 515-a and the RACH slot 515-b may be back-to-back (e.g., consecutive in time) or separated by some amount of time, such as by one or more other slots (e.g., one or more downlink slots). The RACH slot 515-a, the RACH slot 515-b, and the RACH slot 515-c may be examples of uplink slots.

In the example of the mapping schemes 500 and 501, the UE 115 and the network entity 105 may map SSB indices to RACH occasions 510 in order from a first (e.g., initial or lowest) SSB index to a last (e.g., final or highest) SSB index. For example, the SSB index 505-a may be an SSB index 0 (SSB0) and the SSB index 505-h may be an SSB index 7 (SSB7). In each SSB index mapping, the UE 115 and the network entity 105 may map a different (e.g., respective, specific, or separately indicated or defined) quantity of RACH occasions per SSB index (e.g., in accordance with the information 415). For example, in accordance with the example of the mapping scheme 500, the UE 115 and the network entity 105 may map the SSB index 505-a to two RACH occasions 510, may map the SSB index 505-b to one RACH occasion 510, may map the SSB index 505-c to one RACH occasion 510, may map the SSB index 505-d to one RACH occasion 510, may map the SSB index 505-e to two RACH occasions 510, may map the SSB index 505-f to one RACH occasion 510, may map the SSB index 505-g to two RACH occasions 510, and may map the SSB index 505-h to two RACH occasions 510. In such an example, the information 415 may convey, via one or more fields, a sequence (e.g., vector) of N values of N={½, 1, 1, 1, ½, 1, ½, ½}.

Further, in accordance with the example of the mapping scheme 501, the UE 115 and the network entity 105 may map the SSB index 505-a to two RACH occasions 510, may map the SSB index 505-b to one RACH occasion 510, may map the SSB index 505-c to one RACH occasion 510, may map the SSB index 505-d to four RACH occasions 510, may map the SSB index 505-e to four RACH occasions 510, may map the SSB index 505-f to one RACH occasion 510, may map the SSB index 505-g to one RACH occasion 510, and may map the SSB index 505-h to two RACH occasions 510. In such an example, the information 415 may convey, via one or more fields, a sequence (e.g., vector) of N values of N={½, 1, 1, ¼, ¼, 1, 1, ½}. As illustrated by the mapping schemes 500 and 501, RACH occasions 510 may be present in any quantity of symbols within a RACH slot, such as within one symbol, two symbols, three symbols, four symbols, and so on. The quantity of symbols allocated for RACH occasions 510 within a given RACH slot may vary in accordance with a slot format and/or a resource allocation by the network entity 105, such as in accordance with a TDM scheme configured by the network entity 105. Further, although each symbol including RACH occasions 510 is shown as including four RACH occasions 510 in the examples of the mapping schemes 500 and 501, a symbol including RACH occasions 510 may include any quantity of RACH occasions 510 depending on, for example, an FDM scheme configured by the network entity 105.

The UE 115 and the network entity 105 may map the SSB indices to the RACH occasions 510 in accordance with an ordering, priority, or hierarchy of preamble index, frequency resource index, time resource index, and RACH slot index. For example, SS/PBCH block indices provided, for example, by ssb-PositionsInBurst in SIB1 or in ServingCellConfigCommon are mapped to valid RACH occasions in an order of: first, in increasing order of preamble indices within a single RACH occasion; second, in increasing order of frequency resource indices for frequency multiplexed RACH occasions; third, in increasing order of time resource indices for time multiplexed RACH occasions within a RACH slot; and fourth, in increasing order of indices for RACH slots.

In accordance with some of the example implementations of the present disclosure, if a quantity of RACH occasions per SSB index i is N(i), starting from a lowest i to a highest i, the UE 115 and the network entity 105 may map the SSB index i to N(i) RACH occasions 510 in the order of preamble index first, frequency resource index second, time resource index third, and RACH slot index fourth. The UE 115 and the network entity 105 may select, determine, identify, obtain, receive, and/or transmit an indication of a quantity of the N(i) RACH occasions 510 associated with an SSB index i via the information 415. In accordance with the mapping schemes 500 and 501, the UE 115 and the network entity 105 may achieve more efficient resource usage, greater spectral efficiency, and greater power savings, including by reducing how many slots and/or symbols during which the network entity is in an awake state. Moreover, in accordance with such more efficient resource usage and greater spectral efficiency, the UE 115 and the network entity 105 may achieve or facilitate higher data rates and greater system capacity.

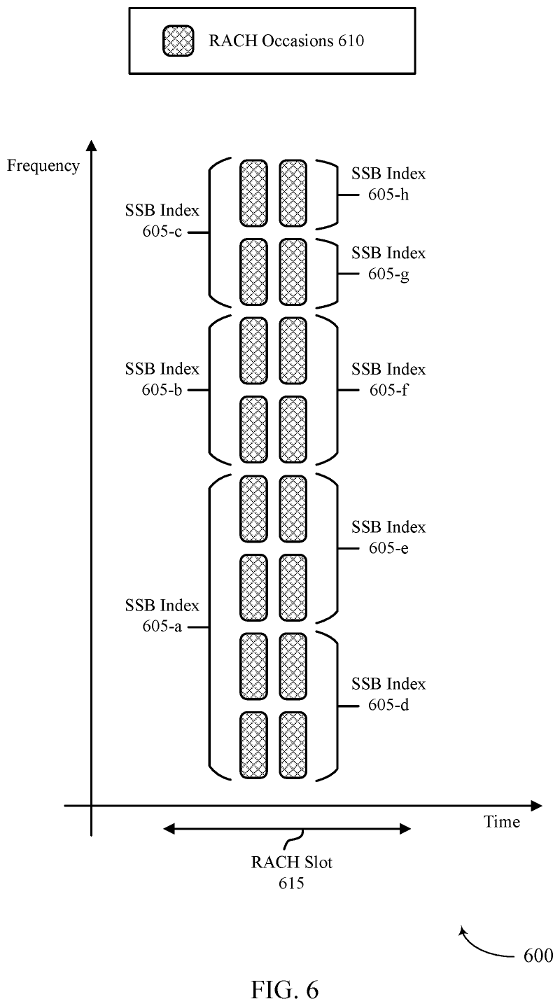

FIG. 6 shows an example of a mapping scheme 600 that supports adapting random access opportunities per SSB index for NES in accordance with one or more aspects of the present disclosure. The mapping scheme 600 may implement or be implemented to facilitate or realize aspects of the wireless communications system 100, the network architecture 200, the network deployment 300, or the signaling diagram 400. For example, the mapping scheme 600 illustrates how a network entity 105 and a UE 115, which may be examples of corresponding device as described herein, map SSB indices (e.g., SSB indices 315 as illustrated by and described with reference to FIGS. 3 and 4) to RACH occasions 610.

Although the multiple SSB indices 315 of FIGS. 3 and 4 are illustrated and described in the example context of including three SSB indices 315, the UE 115 and the network entity 105 may support any quantity of SSB indices 315. As illustrated in the example of the mapping scheme 600, the multiple SSB indices may include an SSB index 605-a, an SSB index 605-b, an SSB index 605-c, an SSB index 605-d, an SSB index 605-e, an SSB index 605-f, an SSB index 605-g, and an SSB index 605-h. As illustrated in the example of the mapping scheme 600, the SSB indices 605-a through 605-h may be mapped to RACH occasions 610 within a RACH slot 615 (which may equivalently be understood as a PRACH slot), although SSB indices may be mapped to any quantity (e.g., one, two, three, etc.) of RACH slots without exceeding the scope of the present disclosure.

In the example of the mapping scheme 600, the UE 115 and the network entity 105 may map SSB indices to RACH occasions 610 in order from a first (e.g., initial or lowest) SSB index to a last (e.g., final or highest) SSB index. For example, the SSB index 605-a may be an SSB index 0 (SSB0) and the SSB index 605-h may be an SSB index 7 (SSB7). In each SSB index mapping, the UE 115 and the network entity 105 may map a different (e.g., respective, specific, or separately indicated or defined) quantity of RACH occasions per SSB index (e.g., in accordance with the information 415). For example, the UE 115 and the network entity 105 may map the SSB index 605-a to four RACH occasions 610, may map the SSB index 605-b to two RACH occasions 610, may map the SSB index 605-c to two RACH occasions 610, may map the SSB index 605-d to two RACH occasions 610, may map the SSB index 605-e to two RACH occasions 610, may map the SSB index 605-f to two RACH occasions 610, may map the SSB index 605-g to one RACH occasion 610, and may map the SSB index 605-h to one RACH occasion 610. In such an example, the information 415 may convey, via one or more fields, a sequence (e.g., vector) of N values of N={¼, ½, ½, ½, ½, ½, 1, 1}.

The UE 115 and the network entity 105 may map the SSB indices to the RACH occasions 610 in accordance with an ordering, priority, or hierarchy of preamble index, frequency resource index, time resource index, and RACH slot index. For example, if a quantity of RACH occasions per SSB index i is N(i), starting from a lowest i to a highest i, the UE 115 and the network entity 105 may map the SSB index i to N(i) RACH occasions 610 in the order of preamble index first, frequency resource index second, time resource index third, and RACH slot index fourth. The UE 115 and the network entity 105 may select, determine, identify, obtain, receive, and/or transmit an indication of a quantity of the N(i) RACH occasions 610 associated with an SSB index i via the information 415. In accordance with the mapping scheme 600, the UE 115 and the network entity 105 may achieve more efficient resource usage, greater spectral efficiency, and greater power savings, including by reducing how many slots and/or symbols during which the network entity is in an awake state. Moreover, in accordance with such more efficient resource usage and greater spectral efficiency, the UE 115 and the network entity 105 may achieve or facilitate higher data rates and greater system capacity.

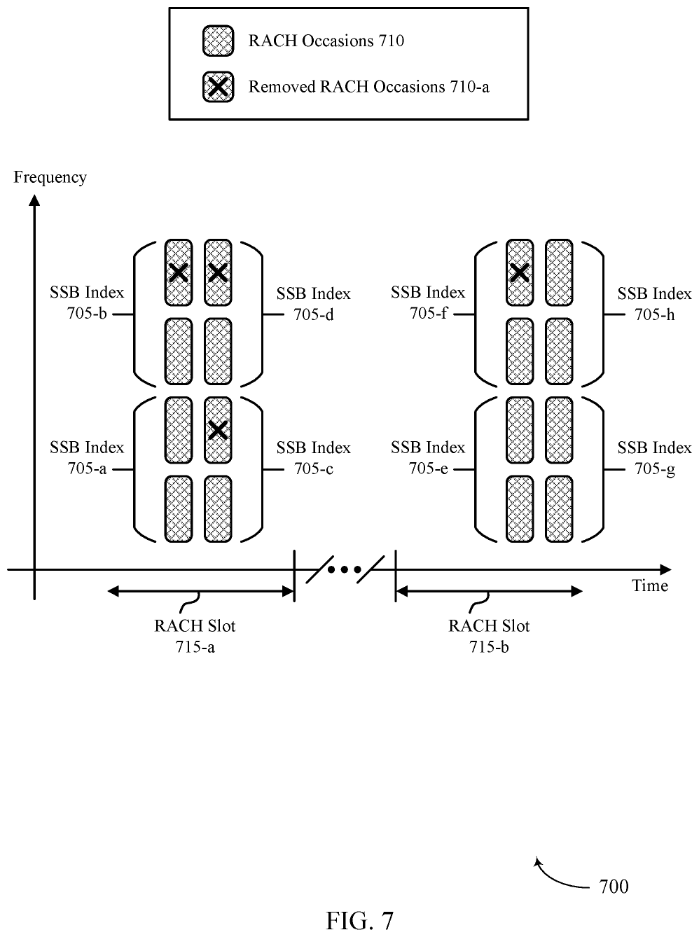

FIG. 7 shows an example of a mapping scheme 700 that supports adapting random access opportunities per SSB index for NES in accordance with one or more aspects of the present disclosure. The mapping scheme 700 may implement or be implemented to facilitate or realize aspects of the wireless communications system 100, the network architecture 200, the network deployment 300, or the signaling diagram 400. For example, the mapping scheme 700 illustrates how a network entity 105 and a UE 115, which may be examples of corresponding device as described herein, map SSB indices (e.g., SSB indices 315 as illustrated by and described with reference to FIGS. 3 and 4) to RACH occasions 710.

Although the multiple SSB indices 315 of FIGS. 3 and 4 are illustrated and described in the example context of including three SSB indices 315, the UE 115 and the network entity 105 may support any quantity of SSB indices 315. As illustrated in the example of the mapping scheme 700, the multiple SSB indices may include an SSB index 705-a, an SSB index 705-b, an SSB index 705-c, an SSB index 705-d, an SSB index 705-e, an SSB index 705-f, an SSB index 705-g, and an SSB index 705-h. As illustrated in the example of the mapping scheme 700, the SSB indices 705-a through 705-d may be mapped to RACH occasions 710 within a RACH slot 715-a (which may equivalently be understood as a PRACH slot) and the SSB indices 705-e through 705-h may be mapped to RACH occasions 710 within a RACH slot 715-b, although SSB indices may be mapped to any quantity (e.g., one, two, three, etc.) of RACH slots without exceeding the scope of the present disclosure. The RACH slot 715-a and the RACH slot 715-b may be back-to-back (e.g., consecutive in time) or separated by some amount of time, such as by one or more other slots (e.g., one or more downlink slots). The RACH slot 715-a and the RACH slot 715-b may be examples of uplink slots.

In the example of the mapping scheme 700, the UE 115 and the network entity 105 may map SSB indices to RACH occasions 710 assuming (e.g., expecting or in accordance with a default operation) that all SSB indices are mapped to a same (e.g., default) quantity of RACH occasions. Such a same (e.g., default) quantity of RACH occasions may be a highest quantity of RACH occasions of the multiple quantities of RACH occasions 420. In other words, the same (e.g., default) quantity of RACH occasions may be given by (e.g., defined, selected, calculated, or otherwise determined by) max (N(i)). For example, if the information 415 conveys, via one or more fields, a sequence (e.g., vector) of N values of N={½, 1, 1, 1, ½, 1, ½, ½}, the UE 115 and the network entity 105 may select, calculate, or otherwise determine that max (N(i))=½, as N(i)=½ may be indicative of two RACH occasions 710 for a corresponding SSB index i and N(i)=1 may be indicative of one RACH occasion 710 for a corresponding SSB index i. Thus, in the example of the mapping scheme 700, the UE 115 and the network entity 105 may initially map each SSB index to two RACH occasions 710.

In accordance with (e.g., after) performing the initial mapping, the UE 115 and the network entity 105 may reduce (e.g., decimate or trim) each group of RACH occasions 710 that map to a same SSB index such that a total quantity of RACH occasions that map to the same SSB index satisfies (e.g., is in accordance with) a corresponding N(i) as indicated via the information 415. In some implementations, the UE 115 and the network entity 105 may perform the reduction (e.g., decimation) in an inverse order as compared to how SSB indices are mapped to RACH occasions 710. For example, the UE 115 and the network entity 105 may perform the reduction (e.g., decimation) starting from RACH slot, then time resource index, then frequency resource index, and then preamble index. In some aspects, performing a “reduction” on a set of RACH occasions 710 may be understood as “removing” one or more RACH occasions 710 from the set of RACH occasions 710, which such removed RACH occasions 710-a becoming invalid RACH occasions accordingly.

As illustrated in the example of the mapping scheme 700, the UE 115 and the network entity 105 may remove a RACH occasion 710 from a first set of RACH occasions 710 associated with the SSB index 705-b, may remove a RACH occasion 710 from a second set of RACH occasions 710 associated with the SSB index 705-c, may remove a RACH occasion 710 from a third set of RACH occasions 710 associated with the SSB index 705-d, and may remove a RACH occasion 710 from a fourth set of RACH occasions 710 associated with the SSB index 705-f. Such a reduction to obtain the removed RACH occasions 710-a in such sets of RACH occasions 710 may result in a satisfaction of the sequence of N values of N={½, 1, 1, 1, ½, 1, ½, ½}. Accordingly, the mapping scheme 700 may be understood as a two-step mapping scheme. Such a two-step mapping scheme may provide greater backwards compatibility with various types of wireless communication devices, including devices that are unable to support a non-uniform mapping between SSB indices and RACH occasions, as the specific sets of RACH occasions 710 to which each SSB index is mapped remain similar (e.g., at least for an initial one or more RACH occasions 710 in each set of RACH occasions, due to the reduction being performed in the inverse order) to how they would be mapped if a uniform mapping between SSB indices and RACH occasions was used.

In accordance with the mapping scheme 700, the network entity 105 may reduce or lower how many RACH occasions 710 the network entity 105 may be expected to process simultaneously. For example, by initially mapping SSB indices to a same quantity of RACH occasions 710 and subsequently reducing the valid RACH occasions 710 for each SSB index on an SSB index basis, the network entity 105 may operate in accordance with a relatively more relaxed processing workload by way of reducing how many RACH occasions 710 the network entity 105 processes (e.g., blind decodes) simultaneously. Thus, the network entity 105 may selectively apply a mapping scheme of FIGS. 5 and 6 or a mapping scheme of FIG. 7 in accordance with whether the network entity 105 aims to reduce how many slots and/or symbols during which the network entity 105 is in an awake state or aims to operate with a relatively lower (peak or average) processing workload.

FIG. 8 shows an example of a signaling diagram 800 that supports adapting random access opportunities per SSB index for NES in accordance with one or more aspects of the present disclosure. The signaling diagram 800 may implement or be implemented to facilitate or realize aspects of the wireless communications system 100, the network architecture 200, the network deployment 300, or the signaling diagram 400. For example, the signaling diagram 800 illustrates communication between a network entity 105 and a UE 115, which may be examples of corresponding device as described herein, including with reference to FIGS. 1-4. In some implementations, the network entity 105 and the UE 115 may achieve a non-uniform mapping of SSB indices 315 to quantities of random access preambles 820 by supporting one or more aspects of the signaling diagram 800, which may be implemented together with or separate from aspects of the signaling diagram 400.

For example, the network entity 105 may transmit, to the UE 115 via a communication link 805-a (e.g., a downlink), a control message 810 including information 815 indicative of multiple (e.g., a multitude of, such as two or more) quantities of random access preambles 820 associated with multiple (e.g., a multitude of, such as two or more) SSB indices 315, each quantity of random access preambles 820 of the multiple quantities of random access preambles 820 associated with a respective SSB index 315 of the multiple SSB indices 315. In some aspects, and as illustrated in the example of the signaling diagram 800, a quantity of the multiple quantities of random access preambles 820 may be equal to the quantity of the multiple SSB indices 315, such that the multiple quantities of random access preambles 820 are associated with the multiple SSB indices 315 on a one-to-one (e.g., 1:1) basis. In some other aspects, the quantities may be different, such that the multiple quantities of random access preambles 820 are associated with the multiple SSB indices 315 on a one-to-many (e.g., 1:M) basis (e.g., with a given quantity of random access preambles 820 corresponding to two or more SSB indices 315), or such that the multiple SSB indices 315 are associated with the multiple quantities of random access preambles 820 on a one-to-many (e.g., 1:M) basis (e.g., with a given SSB index 315 corresponding to two or more quantities of random access preambles 820).

The control message 810 may be, include, or may be conveyed via a paging indication, RRC signaling, a SIB, or any combination thereof, among other examples. For example, the control message 810 may alternatively be conveyed as downlink control information (DCI) or one or more MAC control elements (MAC-CEs). Further, RRC connected UEs 115 may receive the same configuration (e.g., the information 415) for different numbers of random access preambles per SSB with an RRC configuration (e.g., in addition to via a paging indication, a SIB, or other signaling). The control message 810 may include a single control message 810 or may include multiple control messages 810. In examples in which the network entity 105 transmits multiple control messages 810, each of the control messages 810 may convey the information 815 or the information 815 may be spread (e.g., split or distributed) across the multiple control messages 810 (e.g., different portions of the information 815 may be provided by different ones of the multiple control messages 810). Additionally, or alternatively, the information 815 may be pre-configured or pre-loaded in one or more memories of one or both of the network entity 105 and the UE 115.

The network entity 105 may convey, and the UE 115 may receive, the information 815 via one or more fields of the control message 810. For example, the control message 810 may include a RACH configuration information element and one or more fields of the RACH configuration information element may convey the information 815. In other words, the network entity 105 may transmit, in RACH configurations, the number of random access preambles per beam. In some aspects, the RACH configuration information element may be a RACH-ConfigCommon information element.

In some implementations, the RACH configuration information element may convey the information 815 via a single field. Such a single field may be an ssb-perRACH-occasionAndCB-PreamblesPerSSB field. In such implementations, the ssb-perRACH-occasionAndCB-PreamblesPerSSB field may include multiple R values, with an R value indicating a quantity R of random access preambles, and with each R value corresponding to an SSB index 315. For example, a first R value of the ssb-perRACH-occasionAndCB-PreamblesPerSSB field may correspond to the SSB index 315-a and indicate that a quantity of random access preambles 820-a are associated with the SSB index 315-a, a second R value of the ssb-perRACH-occasionAndCB-PreamblesPerSSB field may correspond to the SSB index 315-b and indicate that a quantity of random access preambles 820-b are associated with the SSB index 315-b, and a third R value of the ssb-perRACH-occasionAndCB-PreamblesPerSSB field may correspond to the SSB index 315-c and indicate that a quantity of random access preambles 820-c are associated with the SSB index 315-c. In some aspects, the multiple R values may be conveyed via one or more enumerated parts of the ssb-perRACH-occasionAndCB-PreamblesPerSSB field. For example, a value R=n4 may correspond to (e.g., indicate) four contention based preambles, a value R=n8 may correspond to (e.g., indicate) 8 contention based preambles, and so on.

Each of the multiple R values of the ssb-perRACH-occasionAndCB-PreamblesPerSSB field may correspond to an SSB index 315 of the SSB indices 315 in accordance with a signaled and/or configured mapping. In some examples, a first (initial) ordered R value in a list of the multiple R values may correspond to a lowest SSB index 315, a second (subsequent to the initial) ordered R value in a list of the multiple R values may correspond to a second lowest SSB index 315, and so on. In some other examples, a first (initial) ordered R value in a list of the multiple R values may correspond to a highest SSB index 315, a second (subsequent to the initial) ordered R value in a list of the multiple R values may correspond to a second highest SSB index 315, and so on. Other mapping schemes between the multiple R values and the SSB indices 315 are possible without exceeding the scope of the present disclosure. In any of such example mappings, a length of the single field may be associated with (e.g., based on, such as directly proportional to or at least partially influenced by) a quantity of the multiple SSB indices 315. For example, a sequence of (ssb-perRACH-occasionAndCB-PreamblesPerSSB) may be of length equal to the quantity of SSB indices 315 (e.g., SS/PBCH block indices). In another example, each of the one or more enumerated parts of the ssb-perRACH-occasionAndCB-PreamblesPerSSB field may be of a length equal to the quantity of the multiple SSB indices 315, where a quantity of the one or more enumerated parts of the ssb-perRACH-occasionAndCB-PreamblesPerSSB field may also depend on (e.g., be equal to) the quantity of the multiple SSB indices 315.

Additionally, or alternatively, the RACH configuration information element may convey the information 815 via multiple fields including a first field and a second field. Such a first field may be an ssb-perRACH-occasionAndCB-PreamblesPerSSB field including an indication of a baseline quantity of random access preambles and such a second field may be an additional field including multiple deltas from the baseline quantity of random access preambles. In such implementations, each quantity of random access preambles 820 may be associated with a respective delta from the baseline quantity of random access preambles. For example, the first field (e.g., the ssb-perRACH-occasionAndCB-PreamblesPerSSB field) may include a single R value that indicates the baseline quantity of random access preambles and the second field may include deltas relative to the single R value, with each of the different deltas corresponding to a different SSB index 315, and with any one of the different deltas being a positive value or a negative value. In some aspects, the deltas of the second field may indicate a reduction in the number of random access preambles per SSB index 315 (such that the deltas may be negative values or may be interpreted, used, or applied as negative values). In some other aspects, the deltas of the second field may indicate an increase in the number of random access preambles per SSB index 315 (such that the deltas may be positive values or may be interpreted, used, or applied as positive values).

In an example, a first delta may correspond to the SSB index 315-a and indicate that the quantity of random access preambles 820-a are associated with the SSB index 315-a in accordance with a summation of the baseline quantity of random access preambles and the first delta equaling the quantity of random access preambles 820-a. Similarly, a second delta may correspond to the SSB index 315-b and indicate that the quantity of random access preambles 820-b are associated with the SSB index 315-b in accordance with a summation of the baseline quantity of random access preambles and the second delta equaling the quantity of random access preambles 820-b, and so on. Each of the multiple delta values of the second field may correspond to an SSB index 315 of the SSB indices 315 in accordance with a signaled and/or configured mapping, such as any of the example mappings described with reference to a mapping between multiple R values and the SSB indices 315. Accordingly, a length of the second field may be associated with (e.g., based on, such as directly proportional to or at least partially influenced by) a quantity of the multiple SSB indices 315.

In accordance with the information 815, the multiple quantities of random access preambles 820 may be associated with (e.g., correspond or map to) the multiple SSB indices 315. In some aspects, the multiple quantities of random access preambles 820 may be associated with the multiple SSB indices 315 in accordance with an association 825 (e.g., a mapping). As illustrated in the example of the signaling diagram 800, and in accordance with the association 825, the quantity of random access preambles 820-a may be associated with (e.g., correspond or map to) the SSB index 315-a, the quantity of random access preambles 820-b may be associated with (e.g., correspond or map to) the SSB index 315-b, and the quantity of random access preambles 820-c may be associated with (e.g., correspond or map to) the SSB index 315-c. Each of the quantity of random access preambles 820-a, the quantity of random access preambles 820-b, and the quantity of random access preambles 820-c may be the same or different quantities of a set of available quantities.

Such a set of available quantities may vary based on a quantity of RACH occasions 420 per SSB index 315 (if a single quantity of RACH occasions 420 is provided) or based on a quantity of RACH occasions 420 for each specific SSB index 315 (if multiple quantities of RACH occasions 420 are provided, with each different quantity of RACH occasions 420 potentially having a different set of available quantities of random access preambles 820). If at least one RACH occasion is available (e.g., for N values of N={1, ½, ¼, ⅛}), the set of available quantities of random access preambles 820 may include 4, 8, 12, 16, 20, 24, 28, 32, 36, 40, 44, 48, 52, 56, 60, and 64. If one-half of a RACH occasion is available, the set of the set of available quantities of random access preambles 820 may include 4, 8, 12, 16, 20, 24, 28, and 32. If one-fourth of a RACH occasion is available, the set of the set of available quantities of random access preambles 820 may include 1-16. If one-eighth of a RACH occasion is available, the set of the set of available quantities of random access preambles 820 may include 1-8. If one-sixteenth of a RACH occasion is available, the set of the set of available quantities of random access preambles 820 may include 1-4.

The multiple quantities of random access preambles 820 may include at least two quantities of random access preambles 820. For example, the multiple quantities of random access preambles 820 may include a first quantity of random access preambles 820-a, a second quantity of random access preambles 820-b, and a third quantity of random access preambles 820-c. The first quantity of random access preambles 820-a, the second quantity of random access preambles 820-b, and the third quantity of random access preambles 820-c may be the same or may be (at least partially) different. For example, the first quantity of random access preambles 820-a and the second quantity of random access preambles 820-b may be a same first value (e.g., 12) and the third quantity of random access preambles 820-c may be a different second value (e.g., 16). Alternatively, the first quantity of random access preambles 820-a, the second quantity of random access preambles 820-b, and the third quantity of random access preambles 820-c may all be the same or may all be different. In accordance with the association 825 (e.g., a mapping), the first quantity of random access preambles 820-a may be associated with the first SSB index 315-a, the second quantity of random access preambles 820-b may be associated with the second SSB index 315-b, and the third quantity of random access preambles 820-c may be associated with the third SSB index 315-c. The first SSB index 315-a, the second SSB index 315-b, and the third SSB index 315-c may be the same SSB indices or may be (at least partially) different SSB indices, depending on whether the association 825 is 1:1 or 1:M.

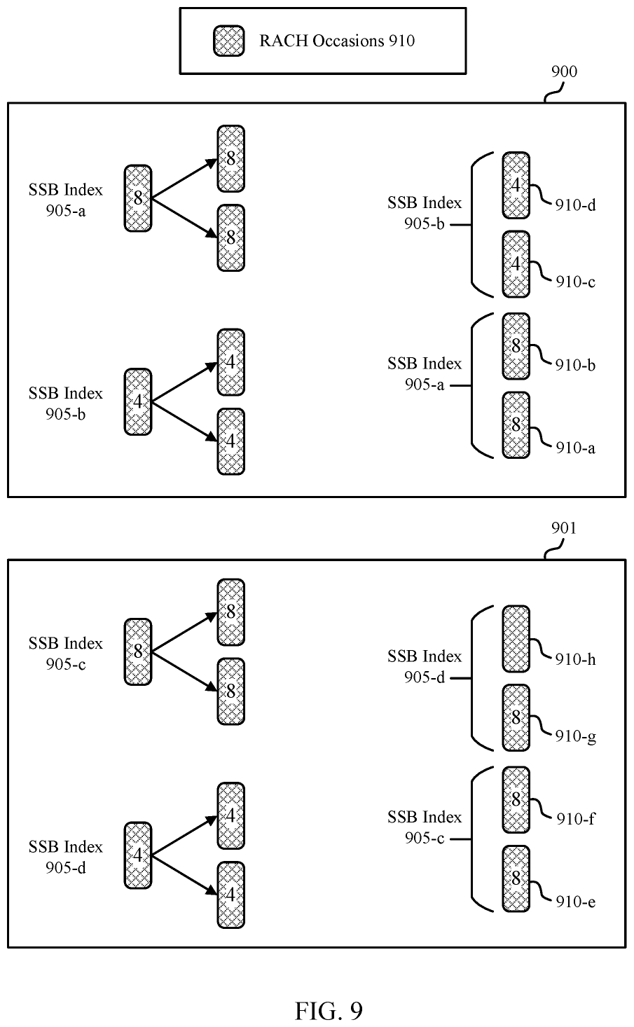

In accordance with the information 815, the UE 115 and the network entity 105 may select, calculate, or otherwise determine a quantity of random access preambles per RACH occasion in one or more of various ways. Such a quantity of random access preambles per RACH occasion may be understood as an upper limit quantity of random access preambles per RACH occasion. Additional details relating to such a selection of a quantity of random access preambles per RACH occasion are illustrated and described herein, including by and with reference to FIG. 9.

The UE 115 may transmit, to the network entity 105 via a communication link 805-b (e.g., an uplink), a message 830 via a RACH occasion in accordance with the information 815 (and in accordance with the selection of the upper limit quantities of random access preambles per RACH occasion). For example, the UE 115 may receive an indication of an SSB index 315 (e.g., any one of the SSB index 315-a, the SSB index 315-b, or the SSB index 315-c) of the multiple SSB indices 315, may select a RACH occasion via which to transmit the message 830, may select a random access preamble from a quantity of random access preambles 820 (e.g., any one of the quantity of random access preambles 820-a, the quantity of random access preambles 820-b, or the quantity of random access preambles 820-c) associated with the SSB index 315, and may transmit the message 830 via the selected RACH occasion and using (e.g., including) the selected random access preamble. The SSB index 315 of which the UE 115 receives an indication may be an SSB index 315 associated with a coverage region in which the UE 115 is located. For example, if the UE 115 is located within the coverage region 305-a (as illustrated by and described with reference to FIG. 3), the UE 115 may receive an indication of (or otherwise obtain, select, or identify) the SSB index 315-a and, accordingly, may select (e.g., determine or identify) a random access preamble from the quantity of random access preambles 820-a associated with the SSB index 315-a (in accordance with the association 825). The message 830 may be a random access message such as a msg1 or at least a portion (e.g., a PRACH portion) of a msgA.

FIG. 9 shows examples of selection schemes 900 and 901 that support adapting random access opportunities per SSB index for NES in accordance with one or more aspects of the present disclosure. The selection schemes 900 and 901 may implement or be implemented to facilitate or realize aspects of the wireless communications system 100, the network architecture 200, the network deployment 300, or the signaling diagram 800. For example, a network entity 105 and a UE 115, which may be examples of corresponding device as described herein, may select one or more upper limit quantities of random access preambles per RACH occasion 910 in accordance with at least one of the selection schemes 900 or the selection scheme 901.

In accordance with the selection scheme 900, the UE 115 and the network entity 105 may select an upper limit quantity of random access preambles per RACH occasion 910 in accordance with Equation 1, shown below. In accordance with Equation 1, R′(i) may denote a quantity of preambles per RACH occasion 910 associated to an SSB index i, R(i) may denote a quantity of random access preambles associated with the SSB index i (as provided via the information 815), and N may denote a quantity of SSB indices per RACH occasion 910 (as also potentially provided via the information 815, such as via an ssb-perRACH-occasionAndCB-PreamblesPerSSB field). In other words, Equation 1 may be understood as the quantity of preambles per RACH occasion 910 associated to SSB index i=the quantity of preambles per SSB index i multiplied by a max (e.g., larger) of (1, SSB-Per-RACH-occasion). N may be indicative of a single or baseline quantity of RACH occasions 420 per SSB index 315. In some aspects, instead of N, a value N(i) may be used, which may denote a quantity of RACH occasions 420 associated with the SSB index i.

$${R}^{′} ( i ) = R ( i ) * max ( 1 , N ) \qquad ( 1 )$$

In accordance with selecting or otherwise calculating or determining the upper limit quantity of random access preambles per RACH occasion 910, the UE 115 and the network entity 105 may map SSB indices 315 to RACH occasions 910 in accordance with first identifying (e.g., selecting or determining) the quantity of RACH occasions 910 per SSB index 315 and the quantity of random access preambles for each RACH occasion 910 and second mapping an SSB index 315 to one or more RACH occasions 910. The UE 115 and the network entity 105 may map an SSB index 315 to one or more RACH occasions 910 in order of random access preambles of this particular SSB index 315 first, frequency resource index second, time resource index third, and RACH slot index fourth.

In the example of the selection scheme 900, an SSB index 905-a may be associated with eight random access preambles and an SSB index 905-b may be associated with four random access preambles and, in accordance with the selection scheme 900, the UE 115 and the network entity 105 may select a first upper limit quantity of random access preambles per RACH occasion 910 of eight for the SSB index 905-a and may select a second upper limit quantity of random access preambles per RACH occasion 910 of four for the SSB index 905-b. Accordingly, the UE 115 and the network entity 105 may map the SSB index 905-a to a RACH occasion 910-a and a RACH occasion 910-b, each of the RACH occasion 910-a and the RACH occasion 910-b being associated with the first upper limit quantity of random access preambles of eight. Similarly, the UE 115 and the network entity 105 may map the SSB index 905-b to a RACH occasion 910-c and a RACH occasion 910-d, each of the RACH occasion 910-c and the RACH occasion 910-d being associated with the second upper limit quantity of random access preambles of four.

In accordance with the selection scheme 901, the UE 115 and the network entity 105 may select an upper limit quantity of random access preambles per RACH occasion in accordance with Equation 2, shown below. In accordance with Equation 2, R′ may denote a quantity of preambles per RACH occasion, Rₘₐₓ may denote the maximum (e.g., largest) quantity of preambles per SSB index 315 over a set of (e.g., all) SSB indices 315, and N may denote a quantity of SSB indices per RACH occasion. In other words, Equation 2 may be understood as the quantity of preambles per RACH occasion=max (e.g., largest) of (list of quantities of preambles per SSB over all SSB indices) multiplied by a max (e.g., larger) of (1, SSB-Per-RACH-occasion). N may be indicative of a single or baseline quantity of RACH occasions 420 per SSB index 315. In some aspects, instead of N, a value N(i) may be used, which may denote a quantity of RACH occasions 420 associated with the SSB index i.

$${R}^{′} = {R}_{max} * max ( 1 , N ) \qquad ( 2 )$$

In accordance with selecting or otherwise calculating or determining the upper limit quantity of random access preambles per RACH occasion, the UE 115 and the network entity 105 may map SSB indices 315 to RACH occasions in increasing order of preamble indices within a single RACH occasion first, in increasing order of frequency resource indices second, in increasing order of time resource indices third, and in increasing order of RACH slot indices fourth. The UE 115 and the network entity 105, due to (e.g., based on or in accordance with) having different quantities of preambles per RACH occasion, may map SSB indices 315 to RACH occasions such that there may be a different quantity of RACH occasions per SSB index 315.

In the example of the selection scheme 901, an SSB index 905-c may be associated with eight random access preambles and an SSB index 905-d may be associated with four random access preambles and, in accordance with the selection scheme 901, the UE 115 and the network entity 105 may select a same upper limit quantity of random access preambles per RACH occasion 910 of eight for the SSB index 905-c and the SSB index 905-d. Accordingly, the UE 115 and the network entity 105 may map the SSB index 905-c to a RACH occasion 910-e and a RACH occasion 910-f, each of the RACH occasion 910-e and the RACH occasion 910-f being associated with the upper limit quantity of random access preambles of eight. Similarly, the UE 115 and the network entity 105 may map the SSB index 905-d to a RACH occasion 910-g and a RACH occasion 910-h, each of the RACH occasion 910-g and the RACH occasion 910-h being associated with the upper limit quantity of random access preambles of eight. In accordance with the SSB index 905-d being associated with four random access preambles, the RACH occasion 910-h may effectively be allocated with zero random access preambles, such that the RACH occasion 910-h may be unused by a UE 115 and unmonitored by the network entity 105, which may facilitate greater power/energy savings at the network entity 105.

In accordance with the selection scheme 900, the network entity 105 may lower a peak or average processing workload (which may relate to power consumption by the network entity 105) by way of reducing how many random access preambles the network entity 105 may process (e.g., search for) during a given RACH occasion 910. In accordance with the selection scheme 901, the network entity 105 may reduce how many RACH occasions 910 the network entity 105 processes (e.g., blind decodes over) by way of mapping a same upper limit quantity of preambles to each RACH occasion 910 and by leveraging how different SSB indices are associated with different total quantities of random access preambles. Thus, the network entity 105 may selectively use the selection scheme 900 or the selection scheme 901 in accordance with whether the network entity 105 aims to reduce a peak or average processing workload or aims to reduce how many RACH occasions the network entity 105 expects to process.

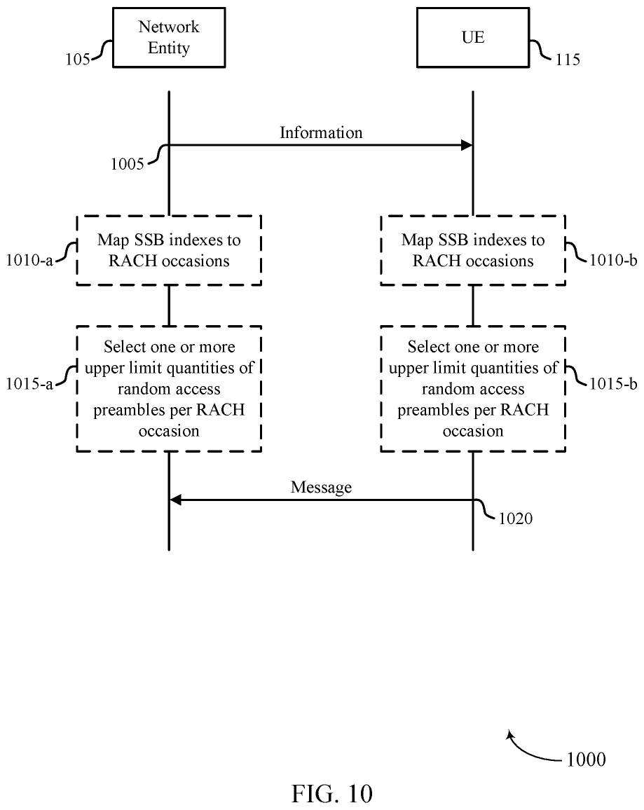

FIG. 10 shows an example of a process flow 1000 that supports adapting random access opportunities per SSB index for NES in accordance with one or more aspects of the present disclosure. In some examples, the process flow 1000 may implement or be implemented by aspects described herein. For example, the process flow 1000 may illustrate communication between a UE 115 and a network entity 105, which may be examples of corresponding devices described herein. In some implementations, the UE 115 and the network entity 105 may achieve, facilitate, or enable non-uniform mappings between quantities of RACH occasions and/or quantity of random access preambles on a per SSB index basis by communicating in accordance with the process flow 1000.

Alternative examples of the following may be implemented. Some steps are performed in a different order than described or are not performed at all. In some implementations, steps may include additional features not mentioned below, or further steps may be added. Further, although the UE 115 and the network entity 105 are shown performing the operations of the process flow 1000, some aspects of some operations may also be performed by one or more other wireless communication devices (such as by multiple network entities 105, or in accordance with coordination among multiple network entities 105).

At 1005, the network entity 105 may transmit, and the UE 115 may receive, information indicative of multiple quantities of RACH occasions and/or multiple quantities of random access preambles associated with multiple SSB indices. In some examples, each quantity of RACH occasions and/or each quantity of random access preambles may be associated with a respective SSB index. The network entity 105 may convey the information 415 for an initial access procedure, a paging sequence (such as for a PRACH responsive to a paging message), or a beam failure recovery procedure. If configured for a paging sequence or a beam failure recovery procedure, the non-uniform mapping of SSB indices to RACH occasions and/or random access preambles may be different than that configured or indicated for initial access. In some aspects, the network entity 105 may configure two or more an initial access procedure, a paging sequence, or a beam failure recovery procedure with different (e.g., respective) non-uniform mappings, such that the UE 115 may support two or more different non-uniform mappings of SSB indices to RACH occasions and/or random access preambles. Additional details relating to such information are illustrated and described herein, including by and with reference to FIGS. 4 and 8.

At 1010-a, the network entity 105 may map the multiple SSB indices to RACH occasions in accordance with the information. Similarly, at 1010-b, the UE 115 may map the multiple SSB indices to RACH occasions in accordance with the information. The UE 115 and the network entity 105 may map the multiple SSB indices to RACH occasions in one or more of various ways.

In some implementations, the UE 115 and the network entity 105 may map a first SSB index to a first subset of RACH occasions and may map a second SSB index to a second subset of RACH occasions. In such implementations, the first subset of RACH occasions may include a first quantity of RACH occasions associated with the first SSB index and the second subset of RACH occasions may include a second quantity of RACH occasions associated with the second SSB index. Further, in such implementations, the mapping of the second SSB index to the second subset of RACH occasions may occur after the mapping of the first SSB index to the first subset of RACH occasions in accordance with a mapping order, which may be associated with or equivalently referred to as a mapping scheme. Additional details relating to such a mapping are illustrated and described herein, including by and with reference to FIGS. 5 and 6.

Additionally, or alternatively, the UE 115 and the network entity 105 may map each SSB index to a respective subset of RACH occasions, each respective subset of RACH occasions including a (same) largest quantity of RACH occasions of the multiple quantities of RACH occasions and may obtain a respective remainder of each respective subset based on a removal of zero, one, or multiple RACH occasions from that respective subset. In such implementations, each remainder may correspond to a respective quantity of RACH occasions of the multiple quantities of RACH occasions provided by the information. For example, the UE 115 and the network entity 105 may map a first SSB index to a first subset of RACH occasions (the first subset of RACH occasions including the largest quantity of RACH occasions of the multiple quantities of RACH occasions) and may obtain a remainder of the first subset of RACH occasions based on a removal of one or more RACH occasions from the first subset of RACH occasions. The remainder of the first subset of RACH occasions may include a first quantity of RACH occasions associated with the first SSB index in accordance with the information. Additional details relating to such a mapping are illustrated and described herein, including by and with reference to FIG. 7.

At 1015-a, the network entity 105 may select one or more upper limit quantities of random access preambles per RACH occasion in accordance with the information. Similarly, at 1015-b, the UE 115 may select one or more upper limit quantities of random access preambles per RACH occasion in accordance with the information.

In some implementations, the UE 115 and the network entity 105 may select a different upper limit quantity of random access preambles per RACH occasion for each SSB index. In such implementations, for example, the UE 115 and the network entity 105 may select a first upper limit quantity of random access preambles per RACH occasion associated with a first SSB index of the multiple SSB indices and a second upper limit quantity of random access preambles per RACH occasion associated with a second SSB index of the multiple SSB indices. In some aspects, the first upper limit quantity of random access preambles per RACH occasion may be equal to a product of a first quantity of random access preambles associated with the first SSB index and a larger of a value of one (e.g., the numeric value “1”) or a quantity of SSB indices per RACH occasion. Similarly, in some aspects, the second upper limit quantity of random access preambles per RACH occasion may be equal to a product of a second quantity of random access preambles associated with the second SSB index and a larger of a value of one (e.g., the numeric value “1”) or a quantity of SSB indices per RACH occasion. Additional details relating to such a selection are described with reference to the selection scheme 900.

Additionally, or alternatively, the UE 115 and the network entity 105 may select a same upper limit quantity of random access preambles per RACH occasion for each SSB index. In such implementations, for example, the UE 115 and the network entity 105 may select an upper limit quantity of random access preambles per RACH occasion in accordance with a product of a quantity of random access preambles and a larger of a value of one (e.g., the numeric value “1”) or a quantity of SSB indices per RACH occasion, with the quantity of random access preambles being a largest quantity of random access preambles of the multiple quantities of random access preambles. Additional details relating to such a selection are described with reference to the selection scheme 901.

At 1020, the UE 115 may transmit, and the network entity 105 may receive, a message (e.g., a random access message, such as a msg1 or at least a portion of a msgA, such as a random access preamble and/or other random access signaling) via a RACH occasion in accordance with the information. Such a transmission and reception of the message in accordance with the information may include or be associated with how the message is transmitted via a RACH occasion of a specific quantity of RACH occasions (based on the serving SSB index for the UE 115) and/or how the message includes a random access preamble selected from a specific quantity of random access preambles (based on the serving SSB index for the UE 115). The UE 115 may transmit the message in accordance with an initial access procedure, in accordance with a paging sequence, or in accordance with a beam failure recovery procedure. Additional details relating to such a transmission and reception of the message are illustrated and described herein, including by and with reference to FIGS. 4 and 8.

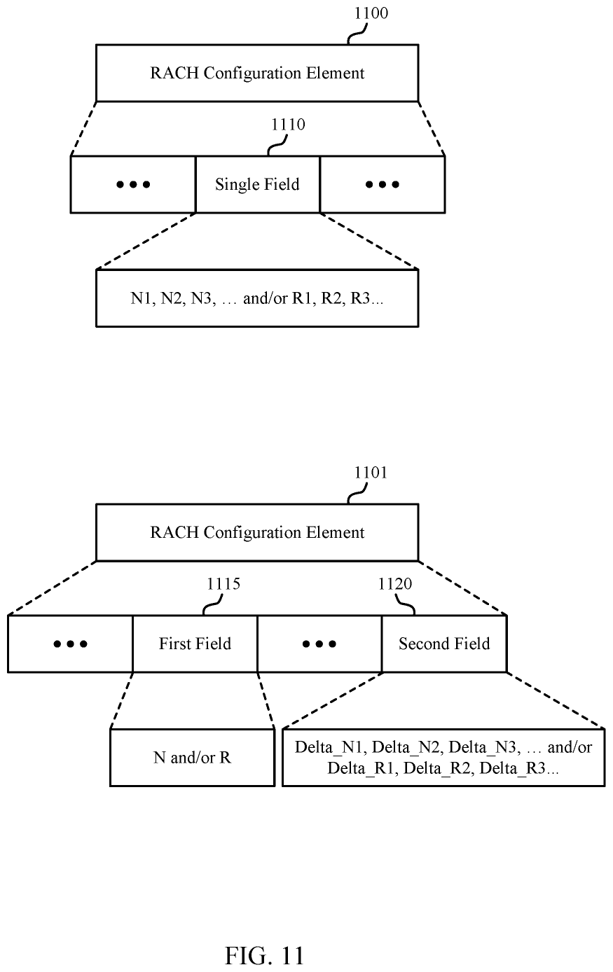

FIG. 11 shows examples of RACH configuration elements 1100 and 1101 that support adapting random access opportunities per SSB index for NES in accordance with one or more aspects of the present disclosure. In some examples, the RACH configuration elements 1100 and 1101 may implement or be implemented by aspects described herein. For example, a UE 115 and a network entity 105, which may be examples of corresponding devices described herein, may exchange (e.g., transmit and receive, communicate) a control message (e.g., a control message 410 or a control message 810 as illustrated by and described with reference to FIG. 4 and FIG. 8, respectively) that includes the RACH configuration element 1100 or the RACH configuration element 1101. In some implementations, the UE 115 and the network entity 105 may achieve, facilitate, or enable non-uniform mappings between quantities of RACH occasions and/or quantity of random access preambles on a per SSB index basis by communicating in accordance with the RACH configuration element 1100 or the RACH configuration element 1101.

The RACH configuration element 1100 and the RACH configuration element 1101 may each be an example of a RACH-ConfigCommon information element and may include information indicative of multiple quantities of RACH occasions and/or multiple quantities of random access preambles. A network entity 105 that transmits the control message including the RACH configuration element 1100 or the RACH configuration element 1101 may convey the information via a single field 1110 or via multiple fields including a first field 1115 and a second field 1120. Likewise, a UE 115 that receives the control message including the RACH configuration element 1100 or the RACH configuration element 1101 may parse (e.g., decode, extract, or obtain) the information via the single field 1110 or via the multiple fields including the first field 1115 and the second field 1120.

The single field 1110 may be an ssb-perRACH-occasionAndCB-PreamblesPerSSB field. In such implementations, the ssb-perRACH-occasionAndCB-PreamblesPerSSB field may include multiple (e.g., at least two) N values (e.g., N1, N2, N3, etc.) and/or multiple (e.g., at least two) R values (e.g., R1, R2, R3, etc.). An N value may indicate that a quantity N of SSB indices is mapped to 1 RACH occasion, and with each N value corresponding to an SSB index and being the same as or different from one or more other N values indicated by the single field 1110. An R value may indicate a quantity R of random access preambles, and with each R value corresponding to an SSB index and being the same as or different from one or more other R values indicated by the single field 1110.

For example, an N1 value of the single field 1110 may correspond to a first SSB index and indicate that a first quantity of RACH occasions is associated with the first SSB index, an N2 value of the single field 1110 may correspond to a second SSB index and indicate that a second quantity of RACH occasions is associated with the second SSB index, and an N3 value of the single field 1110 may correspond to a third SSB index and indicate that a third quantity of RACH occasions is associated with the third SSB index. For further example, an R1 value of the single field 1110 may correspond to a first SSB index and indicate that a first quantity of random access preambles is associated with the first SSB index, an R2 value of the single field 1110 may correspond to a second SSB index and indicate that a second quantity of random access preambles is associated with the second SSB index, and an R3 value of the single field 1110 may correspond to a third SSB index and indicate that a third quantity of random access preambles is associated with the third SSB index.

The first field 1115 may be an ssb-perRACH-occasionAndCB-PreamblesPerSSB field and may include an indication of a baseline quantity of RACH occasions and/or a baseline quantity of random access preambles. For example, the first field 1115 may include a single N value (e.g., a baseline quantity of RACH occasions) and/or a single R value (e.g., a baseline quantity of random access preambles). The second field 1120 may be an additional field including multiple deltas from the baseline quantity of RACH occasions and/or from the baseline quantity of random access preambles. For example, a quantity of RACH occasions for a given SSB index may be associated with a corresponding delta (e.g., delta_N) from the baseline quantity of RACH occasions N. Similarly, a quantity of random access preambles for a given SSB index may be associated with a corresponding delta (e.g., delta_R) from the baseline quantity of random access preambles R.

For example, a delta_N1 value of the second field 1120 may correspond to a first SSB index and may indicate, when summed with the N value provided by the first field 1115, that a first quantity of RACH occasions is associated with the first SSB index (e.g., N+delta_N1=first quantity of RACH occasions for the first SSB index). Similarly, a delta_N2 value of the second field 1120 may correspond to a second SSB index and may indicate, when summed with the N value provided by the first field 1115, that a second quantity of RACH occasions is associated with the second SSB index (e.g., N+delta_N2=second quantity of RACH occasions for the second SSB index). Further, a delta_N3 value of the second field 1120 may correspond to a third SSB index and may indicate, when summed with the N value provided by the first field 1115, that a third quantity of RACH occasions is associated with the third SSB index (e.g., N+delta_N3=third quantity of RACH occasions for the third SSB index).

For further example, a delta_R1 value of the second field 1120 may correspond to a first SSB index and may indicate, when summed with the R value provided by the first field 1115, that a first quantity of random access preambles is associated with the first SSB index (e.g., R+delta_R1=first quantity of random access preambles for the first SSB index). Similarly, a delta_R2 value of the second field 1120 may correspond to a second SSB index and may indicate, when summed with the R value provided by the first field 1115, that a second quantity of random access preambles is associated with the second SSB index (e.g., R+delta_R2=second quantity of random access preambles for the second SSB index). Further, a delta_R3 value of the second field 1120 may correspond to a third SSB index and may indicate, when summed with the R value provided by the first field 1115, that a third quantity of random access preambles is associated with the third SSB index (e.g., R+delta_R3=third quantity of random access preambles for the third SSB index).

Further, although shown as being included in the second field 1120, the delta_N values may be included in the second field 1120 and the delta_R values may be included in a third field of the RACH configuration element 1101. In some aspects, the second field 1120 (or the second field 1120 and the third field) may be included towards an end (e.g., at the end) of the RACH configuration element 1101. Thus, a non-compatible device (such as a UE 115 that does not support multiple quantities of RACH occasions and/or multiple quantities of random access preambles) may terminate parsing the RACH configuration element 1101 at the second field 1120 and still obtain the information that is relevant for the non-compatible device. For example, such a device may assume, in accordance with parsing the first field 1115 (and skipping the second field 1120 and the third field, if included), that the quantity of RACH occasions is equal to N and that the quantity of random access preambles is equal to R.

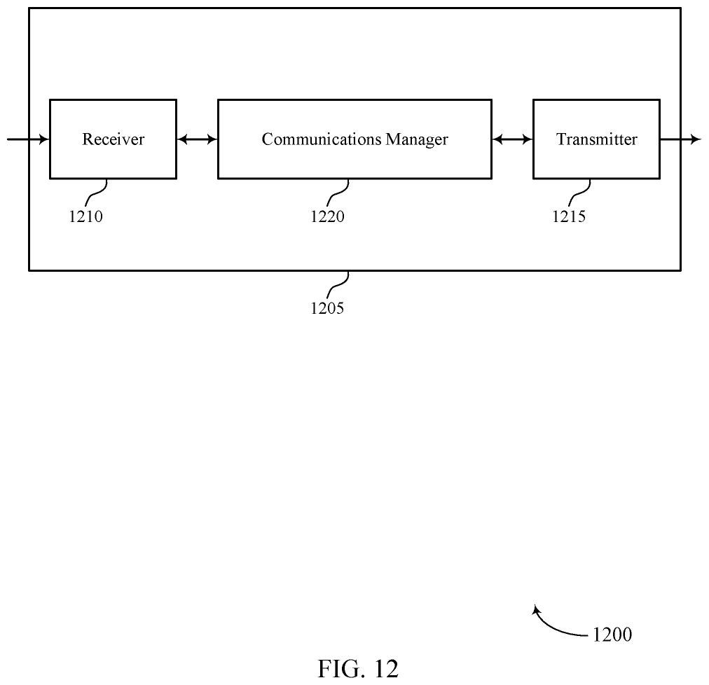

FIG. 12 shows a block diagram 1200 of a device 1205 that supports adapting random access opportunities per SSB index for NES in accordance with one or more aspects of the present disclosure. The device 1205 may be an example of aspects of a UE 115 as described herein. The device 1205 may include a receiver 1210, a transmitter 1215, and a communications manager 1220. The device 1205, or one or more components of the device 1205 (e.g., the receiver 1210, the transmitter 1215, and the communications manager 1220), may include at least one processor, which may be coupled with at least one memory, to, individually or collectively, support or enable the described techniques. Each of these components may be in communication with one another (e.g., via one or more buses).

The receiver 1210 may provide a means for receiving information such as packets, user data, control information, or any combination thereof associated with various information channels (e.g., control channels, data channels, information channels related to adapting random access opportunities per SSB index for NES). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to adapting random access opportunities per SSB index for NES). In some examples, the transmitter 1215 may be co-located with a receiver 1210 in a transceiver module. The transmitter 1215 may utilize a single antenna or a set of multiple antennas.

The communications manager 1220, the receiver 1210, the transmitter 1215, or various combinations thereof or various components thereof may be examples of means for performing various aspects of adapting random access opportunities per SSB index for NES as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor. If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, determining, selecting, mapping, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication in accordance with examples as disclosed herein. For example, the communications manager 1220 is capable of, configured to, or operable to support a means for receiving information indicative of a set of multiple quantities of RACH occasions associated with a set of multiple SSB indices, each quantity of RACH occasions of the set of multiple quantities of RACH occasions associated with a respective SSB index of the set of multiple SSB indices. The communications manager 1220 is capable of, configured to, or operable to support a means for transmitting a message via a RACH occasion in accordance with the information.

Additionally, or alternatively, the communications manager 1220 may support wireless communication in accordance with examples as disclosed herein. For example, the communications manager 1220 is capable of, configured to, or operable to support a means for receiving information indicative of a set of multiple quantities of random access preambles associated with a set of multiple SSB indices, each quantity of random access preambles of the set of multiple quantities of random access preambles associated with a respective SSB index of the set of multiple SSB indices. The communications manager 1220 is capable of, configured to, or operable to support a means for transmitting, via a RACH occasion, a message including a random access preamble in accordance with the information.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for reduced processing, reduced power consumption, and more efficient utilization of communication resources.

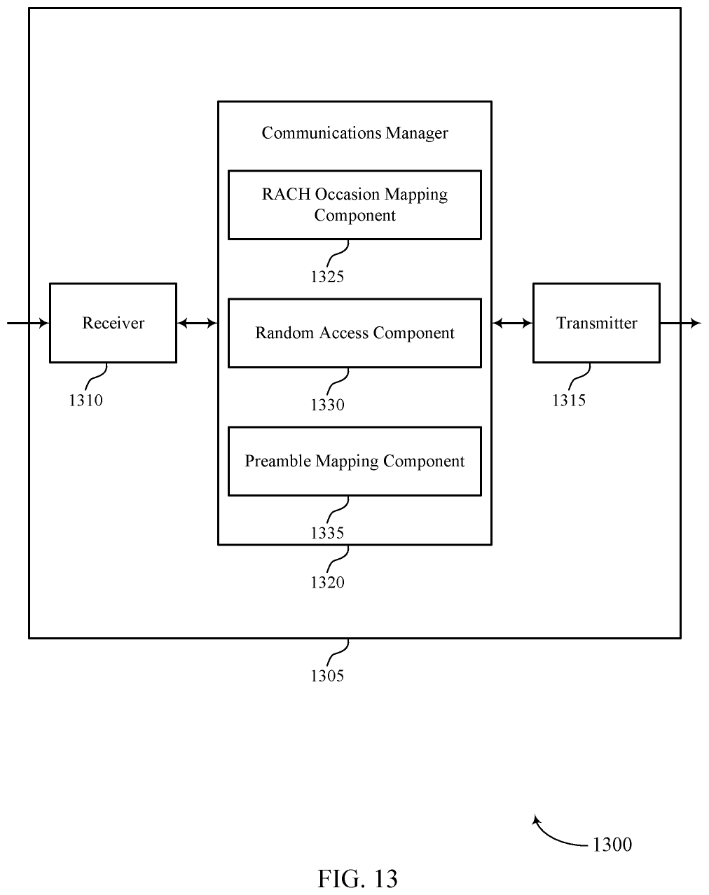

FIG. 13 shows a block diagram 1300 of a device 1305 that supports adapting random access opportunities per SSB index for NES in accordance with one or more aspects of the present disclosure. The device 1305 may be an example of aspects of a device 1205 or a UE 115 as described herein. The device 1305 may include a receiver 1310, a transmitter 1315, and a communications manager 1320. The device 1305, or one or more components of the device 1305 (e.g., the receiver 1310, the transmitter 1315, and the communications manager 1320), may include at least one processor, which may be coupled with at least one memory, to support the described techniques. Each of these components may be in communication with one another (e.g., via one or more buses).

The receiver 1310 may provide a means for receiving information such as packets, user data, control information, or any combination thereof associated with various information channels (e.g., control channels, data channels, information channels related to adapting random access opportunities per SSB index for NES). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to adapting random access opportunities per SSB index for NES). In some examples, the transmitter 1315 may be co-located with a receiver 1310 in a transceiver module. The transmitter 1315 may utilize a single antenna or a set of multiple antennas.

The device 1305, or various components thereof, may be an example of means for performing various aspects of adapting random access opportunities per SSB index for NES as described herein. For example, the communications manager 1320 may include a RACH occasion mapping component 1325, a random access component 1330, a preamble mapping component 1335, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication in accordance with examples as disclosed herein. The RACH occasion mapping component 1325 is capable of, configured to, or operable to support a means for receiving information indicative of a set of multiple quantities of RACH occasions associated with a set of multiple SSB indices, each quantity of RACH occasions of the set of multiple quantities of RACH occasions associated with a respective SSB index of the set of multiple SSB indices. The random access component 1330 is capable of, configured to, or operable to support a means for transmitting a message via a RACH occasion in accordance with the information.

Additionally, or alternatively, the communications manager 1320 may support wireless communication in accordance with examples as disclosed herein. The preamble mapping component 1335 is capable of, configured to, or operable to support a means for receiving information indicative of a set of multiple quantities of random access preambles associated with a set of multiple SSB indices, each quantity of random access preambles of the set of multiple quantities of random access preambles associated with a respective SSB index of the set of multiple SSB indices. The random access component 1330 is capable of, configured to, or operable to support a means for transmitting, via a RACH occasion, a message including a random access preamble in accordance with the information.

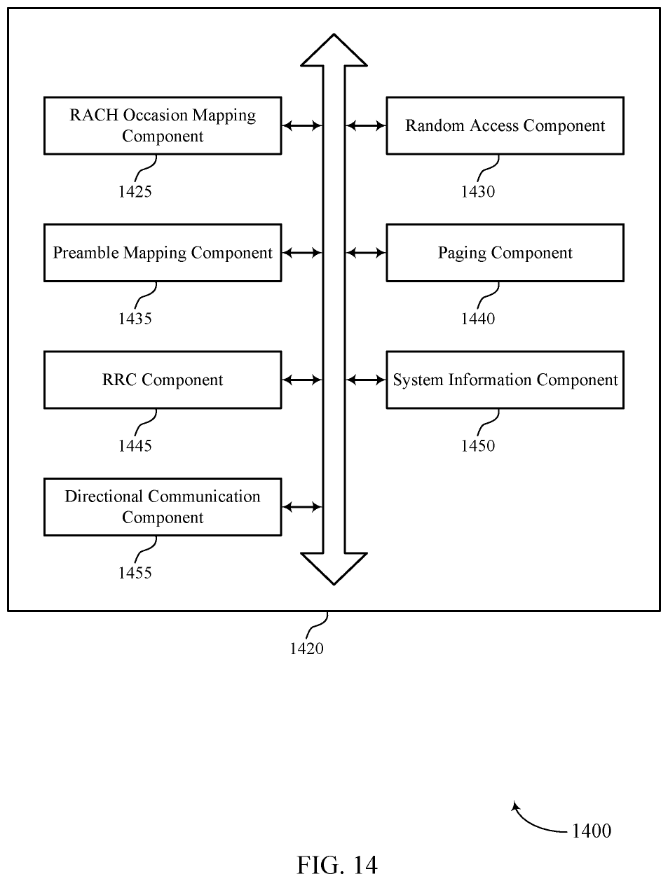

FIG. 14 shows a block diagram 1400 of a communications manager 1420 that supports adapting random access opportunities per SSB index for NES in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of adapting random access opportunities per SSB index for NES as described herein. For example, the communications manager 1420 may include a RACH occasion mapping component 1425, a random access component 1430, a preamble mapping component 1435, a paging component 1440, an RRC component 1445, a system information component 1450, a directional communication component 1455, or any combination thereof. Each of these components, or components or subcomponents thereof (e.g., one or more processors, one or more memories), may communicate, directly or indirectly, with one another (e.g., via one or more buses).

The communications manager 1420 may support wireless communication in accordance with examples as disclosed herein. The RACH occasion mapping component 1425 is capable of, configured to, or operable to support a means for receiving information indicative of a set of multiple quantities of RACH occasions associated with a set of multiple SSB indices, each quantity of RACH occasions of the set of multiple quantities of RACH occasions associated with a respective SSB index of the set of multiple SSB indices. The random access component 1430 is capable of, configured to, or operable to support a means for transmitting a message via a RACH occasion in accordance with the information.

In some examples, to support receiving the information, the RACH occasion mapping component 1425 is capable of, configured to, or operable to support a means for receiving the information via one or more fields of a RACH configuration information element.

In some examples, the one or more fields includes a single field, the single field including an indication of each quantity of RACH occasions of the set of multiple quantities of RACH occasions.

In some examples, a length of the single field is based on a quantity of the set of multiple SSB indices.

In some examples, the one or more fields include a first field and a second field, the first field including an indication of a baseline quantity of RACH occasions and the second field including a set of multiple deltas from the baseline quantity of RACH occasions, each quantity of RACH occasions of the set of multiple quantities of RACH occasions being associated with a respective delta, of the set of multiple deltas, from the baseline quantity of RACH occasions.

In some examples, a length of the second field is based on a quantity of the set of multiple SSB indices.

In some examples, the RACH occasion mapping component 1425 is capable of, configured to, or operable to support a means for mapping the set of multiple SSB indices to RACH occasions in accordance with the information, the transmitting of the message based on the mapping of the set of multiple SSB indices to the RACH occasions.

In some examples, to support mapping the set of multiple SSB indices to the RACH occasions, the RACH occasion mapping component 1425 is capable of, configured to, or operable to support a means for mapping a first SSB index to a first subset of RACH occasions, the first subset of RACH occasions including a first quantity of RACH occasions, the first quantity of RACH occasions associated with the first SSB index in accordance with the information. In some examples, to support mapping the set of multiple SSB indices to the RACH occasions, the RACH occasion mapping component 1425 is capable of, configured to, or operable to support a means for mapping a second SSB index to a second subset of RACH occasions, the second subset of RACH occasions including a second quantity of RACH occasions, the second quantity of RACH occasions associated with the second SSB index in accordance with the information, the mapping of the second SSB index to the second subset of RACH occasions occurring after the mapping of the first SSB index to the first subset of RACH occasions in accordance with a mapping order.

In some examples, to support mapping the set of multiple SSB indices to the RACH occasions, the RACH occasion mapping component 1425 is capable of, configured to, or operable to support a means for mapping a first SSB index to a first subset of RACH occasions, the first subset of RACH occasions including a largest quantity of RACH occasions of the set of multiple quantities of RACH occasions. In some examples, to support mapping the set of multiple SSB indices to the RACH occasions, the RACH occasion mapping component 1425 is capable of, configured to, or operable to support a means for obtaining a remainder of the first subset of RACH occasions based on a removal of one or more RACH occasions from the first subset of RACH occasions, the remainder of the first subset of RACH occasions including a first quantity of RACH occasions, the first quantity of RACH occasions associated with the first SSB index in accordance with the information.

In some examples, the paging component 1440 is capable of, configured to, or operable to support a means for receiving the information indicative of the set of multiple quantities of RACH occasions associated with the set of multiple SSB indices via a paging indication.

In some examples, the RRC component 1445 is capable of, configured to, or operable to support a means for receiving the information indicative of the set of multiple quantities of RACH occasions associated with the set of multiple SSB indices via RRC signaling.

In some examples, the system information component 1450 is capable of, configured to, or operable to support a means for receiving the information indicative of the set of multiple quantities of RACH occasions associated with the set of multiple SSB indices via an SIB.

In some examples, the directional communication component 1455 is capable of, configured to, or operable to support a means for receiving an indication of an SSB index of the set of multiple SSB indices, the SSB index being associated with a directional communication between the UE and a network entity. In some examples, the random access component 1430 is capable of, configured to, or operable to support a means for selecting the RACH occasion from a quantity of RACH occasions associated with the SSB index.

Additionally, or alternatively, the communications manager 1420 may support wireless communication in accordance with examples as disclosed herein. The preamble mapping component 1435 is capable of, configured to, or operable to support a means for receiving information indicative of a set of multiple quantities of random access preambles associated with a set of multiple SSB indices, each quantity of random access preambles of the set of multiple quantities of random access preambles associated with a respective SSB index of the set of multiple SSB indices. In some examples, the random access component 1430 is capable of, configured to, or operable to support a means for transmitting, via a RACH occasion, a message including a random access preamble in accordance with the information.

In some examples, to support receiving the information, the preamble mapping component 1435 is capable of, configured to, or operable to support a means for receiving the information via one or more fields of a RACH configuration information element.

In some examples, the one or more fields include a single field, the single field including an indication of each quantity of random access preambles of the set of multiple quantities of random access preambles.

In some examples, a length of the single field is based on a quantity of the set of multiple SSB indices.

In some examples, the one or more fields include a first field and a second field, the first field including an indication of a baseline quantity of random access preambles and the second field including a set of multiple deltas from the baseline quantity of random access preambles, each quantity of random access preambles of the set of multiple quantities of random access preambles associated with a respective delta, of the set of multiple deltas, from the baseline quantity of random access preambles.

In some examples, a length of the second field is based on a quantity of the set of multiple SSB indices.

In some examples, the preamble mapping component 1435 is capable of, configured to, or operable to support a means for selecting a first upper limit quantity of random access preambles per RACH occasion associated with a first SSB index of the set of multiple SSB indices, the first upper limit quantity of random access preambles per RACH occasion being equal to a product of a first quantity of random access preambles and a larger of a value of one or a quantity of SSB indices per RACH occasion, the first quantity of random access preambles associated with the first SSB index in accordance with the information. In some examples, the preamble mapping component 1435 is capable of, configured to, or operable to support a means for selecting a second upper limit quantity of random access preambles per RACH occasion associated with a second SSB index of the set of multiple SSB indices, the second upper limit quantity of random access preambles per RACH occasion being equal to a product of a second quantity of random access preambles and a larger of the value of one or the quantity of SSB indices per RACH occasion, the second quantity of random access preambles associated with the second SSB index in accordance with the information.

In some examples, the preamble mapping component 1435 is capable of, configured to, or operable to support a means for selecting an upper limit quantity of random access preambles per RACH occasion in accordance with a product of a quantity of random access preambles and a larger of a value of one or a quantity of SSB indices per RACH occasion, the quantity of random access preambles being a largest quantity of random access preambles of the set of multiple quantities of random access preambles.

In some examples, the upper limit quantity of random access preambles per RACH occasion is used equally across the set of multiple SSB indices.

In some examples, the paging component 1440 is capable of, configured to, or operable to support a means for receiving the information indicative of the set of multiple quantities of RACH occasions associated with the set of multiple SSB indices via a paging indication.

In some examples, the RRC component 1445 is capable of, configured to, or operable to support a means for receiving the information indicative of the set of multiple quantities of RACH occasions associated with the set of multiple SSB indices via RRC signaling.

In some examples, the system information component 1450 is capable of, configured to, or operable to support a means for receiving the information indicative of the set of multiple quantities of RACH occasions associated with the set of multiple SSB indices via an SIB.

In some examples, the directional communication component 1455 is capable of, configured to, or operable to support a means for receiving an indication of an SSB index of the set of multiple SSB indices, the SSB index being associated with a directional communication between the UE and a network entity. In some examples, the random access component 1430 is capable of, configured to, or operable to support a means for selecting the random access preamble from a quantity of random access preambles associated with the SSB index.

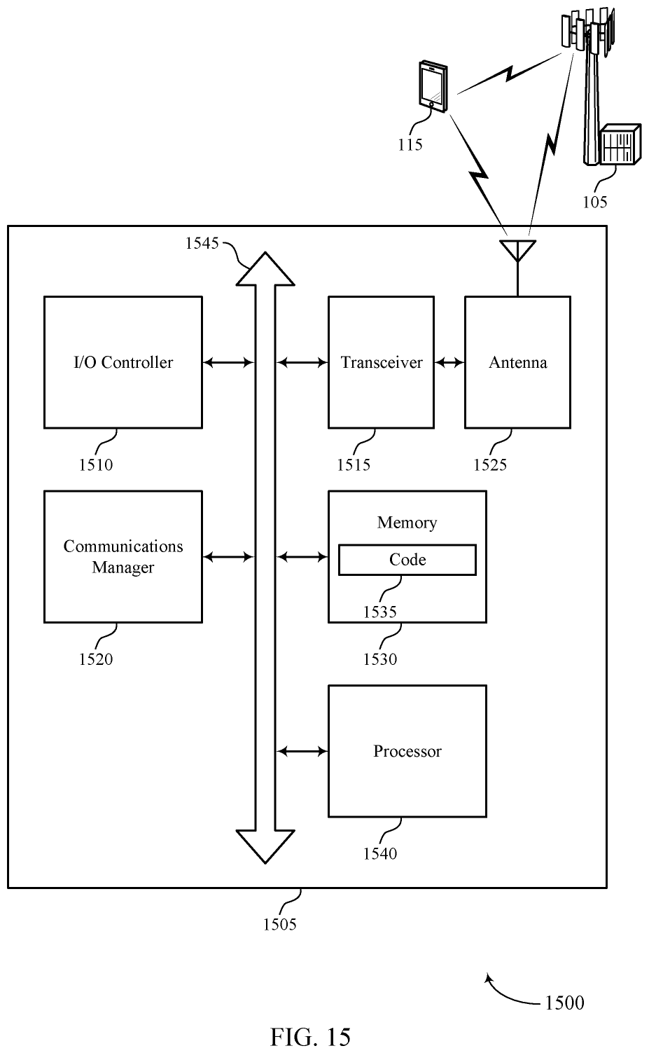

FIG. 15 shows a diagram of a system 1500 including a device 1505 that supports adapting random access opportunities per SSB index for NES in accordance with one or more aspects of the present disclosure. The device 1505 may be an example of or include the components of a device 1205, a device 1305, or a UE 115 as described herein. The device 1505 may communicate (e.g., wirelessly) with one or more network entities 105, one or more UEs 115, or any combination thereof. The device 1505 may include components for bi-directional voice and data communications including components for transmitting and receiving communications, such as a communications manager 1520, an input/output (I/O) controller 1510, a transceiver 1515, an antenna 1525, at least one memory 1530, code 1535, and at least one processor 1540. These components may be in electronic communication or otherwise coupled (e.g., operatively, communicatively, functionally, electronically, electrically) via one or more buses (e.g., a bus 1545).

The I/O controller 1510 may manage input and output signals for the device 1505. The I/O controller 1510 may also manage peripherals not integrated into the device 1505. In some cases, the I/O controller 1510 may represent a physical connection or port to an external peripheral. In some cases, the I/O controller 1510 may utilize an operating system such as iOS®, ANDROID®, MS-DOS®, MS-WINDOWS®, OS/2®, UNIX®, LINUX®, or another known operating system. Additionally, or alternatively, the I/O controller 1510 may represent or interact with a modem, a keyboard, a mouse, a touchscreen, or a similar device. In some cases, the I/O controller 1510 may be implemented as part of one or more processors, such as the at least one processor 1540. In some cases, a user may interact with the device 1505 via the I/O controller 1510 or via hardware components controlled by the I/O controller 1510.

In some cases, the device 1505 may include a single antenna 1525. However, in some other cases, the device 1505 may have more than one antenna 1525, which may be capable of concurrently transmitting or receiving multiple wireless transmissions. The transceiver 1515 may communicate bi-directionally, via the one or more antennas 1525, wired, or wireless links as described herein. For example, the transceiver 1515 may represent a wireless transceiver and may communicate bi-directionally with another wireless transceiver. The transceiver 1515 may also include a modem to modulate the packets, to provide the modulated packets to one or more antennas 1525 for transmission, and to demodulate packets received from the one or more antennas 1525. The transceiver 1515, or the transceiver 1515 and one or more antennas 1525, may be an example of a transmitter 1215, a transmitter 1315, a receiver 1210, a receiver 1310, or any combination thereof or component thereof, as described herein.

The at least one memory 1530 may include random access memory (RAM) and read-only memory (ROM). The at least one memory 1530 may store computer-readable, computer-executable code 1535 including instructions that, when executed by the at least one processor 1540, cause the device 1505 to perform various functions described herein. The code 1535 may be stored in a non-transitory computer-readable medium such as system memory or another type of memory. In some cases, the code 1535 may not be directly executable by the at least one processor 1540 but may cause a computer (e.g., when compiled and executed) to perform functions described herein. In some cases, the at least one memory 1530 may contain, among other things, a basic I/O system (BIOS) which may control basic hardware or software operation such as the interaction with peripheral components or devices.

The at least one processor 1540 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1540 may be configured to operate a memory array using a memory controller. In some other cases, a memory controller may be integrated into the at least one processor 1540. The at least one processor 1540 may be configured to execute computer-readable instructions stored in a memory (e.g., the at least one memory 1530) to cause the device 1505 to perform various functions (e.g., functions or tasks supporting adapting random access opportunities per SSB index for NES). For example, the device 1505 or a component of the device 1505 may include at least one processor 1540 and at least one memory 1530 coupled with or to the at least one processor 1540, the at least one processor 1540 and at least one memory 1530 configured to perform various functions described herein. In some examples, the at least one processor 1540 may include multiple processors and the at least one memory 1530 may include multiple memories. One or more of the multiple processors may be coupled with one or more of the multiple memories, which may, individually or collectively, be configured to perform various functions herein. In some examples, the at least one processor 1540 may be a component of a processing system, which may refer to a system (such as a series) of machines, circuitry (including, for example, one or both of processor circuitry (which may include the at least one processor 1540) and memory circuitry (which may include the at least one memory 1530)), or components, that receives or obtains inputs and processes the inputs to produce, generate, or obtain a set of outputs. The processing system may be configured to perform one or more of the functions described herein. For example, the at least one processor 1540 or a processing system including the at least one processor 1540 may be configured to, configurable to, or operable to cause the device 1505 to perform one or more of the functions described herein. Further, as described herein, being “configured to,” being “configurable to,” and being “operable to” may be used interchangeably and may be associated with a capability, when executing code stored in the at least one memory 1530 or otherwise, to perform one or more of the functions described herein.

The communications manager 1520 may support wireless communication in accordance with examples as disclosed herein. For example, the communications manager 1520 is capable of, configured to, or operable to support a means for receiving information indicative of a set of multiple quantities of RACH occasions associated with a set of multiple SSB indices, each quantity of RACH occasions of the set of multiple quantities of RACH occasions associated with a respective SSB index of the set of multiple SSB indices. The communications manager 1520 is capable of, configured to, or operable to support a means for transmitting a message via a RACH occasion in accordance with the information.

Additionally, or alternatively, the communications manager 1520 may support wireless communication in accordance with examples as disclosed herein. For example, the communications manager 1520 is capable of, configured to, or operable to support a means for receiving information indicative of a set of multiple quantities of random access preambles associated with a set of multiple SSB indices, each quantity of random access preambles of the set of multiple quantities of random access preambles associated with a respective SSB index of the set of multiple SSB indices. The communications manager 1520 is capable of, configured to, or operable to support a means for transmitting, via a RACH occasion, a message including a random access preamble in accordance with the information.

By including or configuring the communications manager 1520 in accordance with examples as described herein, the device 1505 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1520 may be configured to perform various operations (e.g., receiving, monitoring, transmitting) using or otherwise in cooperation with the transceiver 1515, the one or more antennas 1525, or any combination thereof. Although the communications manager 1520 is illustrated as a separate component, in some examples, one or more functions described with reference to the communications manager 1520 may be supported by or performed by the at least one processor 1540, the at least one memory 1530, the code 1535, or any combination thereof. For example, the code 1535 may include instructions executable by the at least one processor 1540 to cause the device 1505 to perform various aspects of adapting random access opportunities per SSB index for NES as described herein, or the at least one processor 1540 and the at least one memory 1530 may be otherwise configured to, individually or collectively, perform or support such operations.

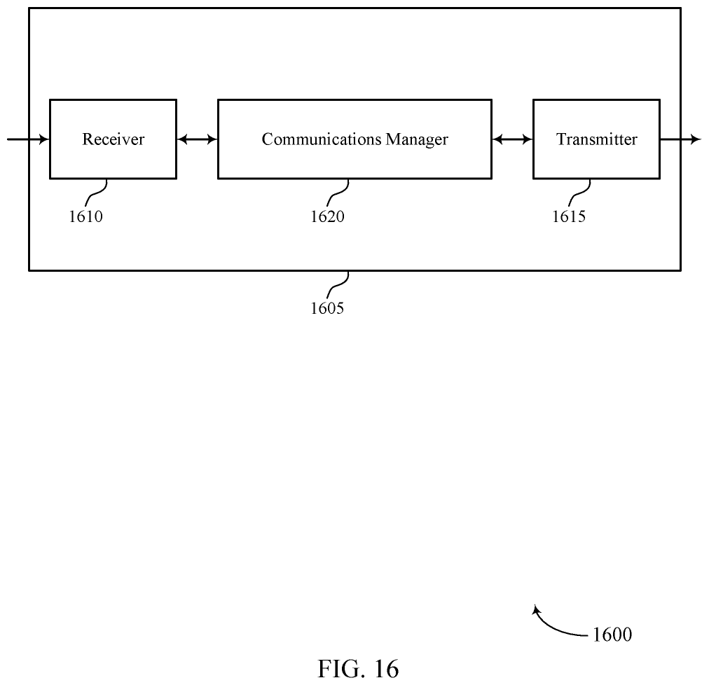

FIG. 16 shows a block diagram 1600 of a device 1605 that supports adapting random access opportunities per SSB index for NES in accordance with one or more aspects of the present disclosure. The device 1605 may be an example of aspects of a network entity 105 as described herein. The device 1605 may include a receiver 1610, a transmitter 1615, and a communications manager 1620. The device 1605, or one or more components of the device 1605 (e.g., the receiver 1610, the transmitter 1615, and the communications manager 1620), may include at least one processor, which may be coupled with at least one memory, to, individually or collectively, support or enable the described techniques. Each of these components may be in communication with one another (e.g., via one or more buses).

The receiver 1610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1605. In some examples, the receiver 1610 may support obtaining information by receiving signals via one or more antennas. Additionally, or alternatively, the receiver 1610 may support obtaining information by receiving signals via one or more wired (e.g., electrical, fiber optic) interfaces, wireless interfaces, or any combination thereof.

The transmitter 1615 may provide a means for outputting (e.g., transmitting, providing, conveying, sending) information generated by other components of the device 1605. For example, the transmitter 1615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1615 may support outputting information by transmitting signals via one or more antennas. Additionally, or alternatively, the transmitter 1615 may support outputting information by transmitting signals via one or more wired (e.g., electrical, fiber optic) interfaces, wireless interfaces, or any combination thereof. In some examples, the transmitter 1615 and the receiver 1610 may be co-located in a transceiver, which may include or be coupled with a modem.

The communications manager 1620, the receiver 1610, the transmitter 1615, or various combinations thereof or various components thereof may be examples of means for performing various aspects of adapting random access opportunities per SSB index for NES as described herein. For example, the communications manager 1620, the receiver 1610, the transmitter 1615, or various combinations or components thereof may be capable of performing one or more of the functions described herein.

In some examples, the communications manager 1620, the receiver 1610, the transmitter 1615, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1620, the receiver 1610, the transmitter 1615, or various combinations or components thereof may be implemented in code (e.g., as communications management software or firmware) executed by at least one processor. If implemented in code executed by at least one processor, the functions of the communications manager 1620, the receiver 1610, the transmitter 1615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1620 may be configured to perform various operations (e.g., receiving, determining, selecting, mapping, obtaining, monitoring, outputting, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to obtain information, output information, or perform various other operations as described herein.

The communications manager 1620 may support wireless communication in accordance with examples as disclosed herein. For example, the communications manager 1620 is capable of, configured to, or operable to support a means for outputting information indicative of a set of multiple quantities of RACH occasions associated with a set of multiple SSB indices, each quantity of RACH occasions of the set of multiple quantities of RACH occasions associated with a respective SSB index of the set of multiple SSB indices. The communications manager 1620 is capable of, configured to, or operable to support a means for obtaining one or more messages via one or more RACH occasions in accordance with the information.

Additionally, or alternatively, the communications manager 1620 may support wireless communication in accordance with examples as disclosed herein. For example, the communications manager 1620 is capable of, configured to, or operable to support a means for outputting information indicative of a set of multiple quantities of random access preambles associated with a set of multiple SSB indices, each quantity of random access preambles of the set of multiple quantities of random access preambles associated with a respective SSB index of the set of multiple SSB indices. The communications manager 1620 is capable of, configured to, or operable to support a means for obtaining one or more messages via one or more RACH occasions, each message of the one or more messages including a respective random access preamble in accordance with the information.

By including or configuring the communications manager 1620 in accordance with examples as described herein, the device 1605 (e.g., at least one processor controlling or otherwise coupled with the receiver 1610, the transmitter 1615, the communications manager 1620, or a combination thereof) may support techniques for reduced processing, reduced power consumption, and more efficient utilization of communication resources.

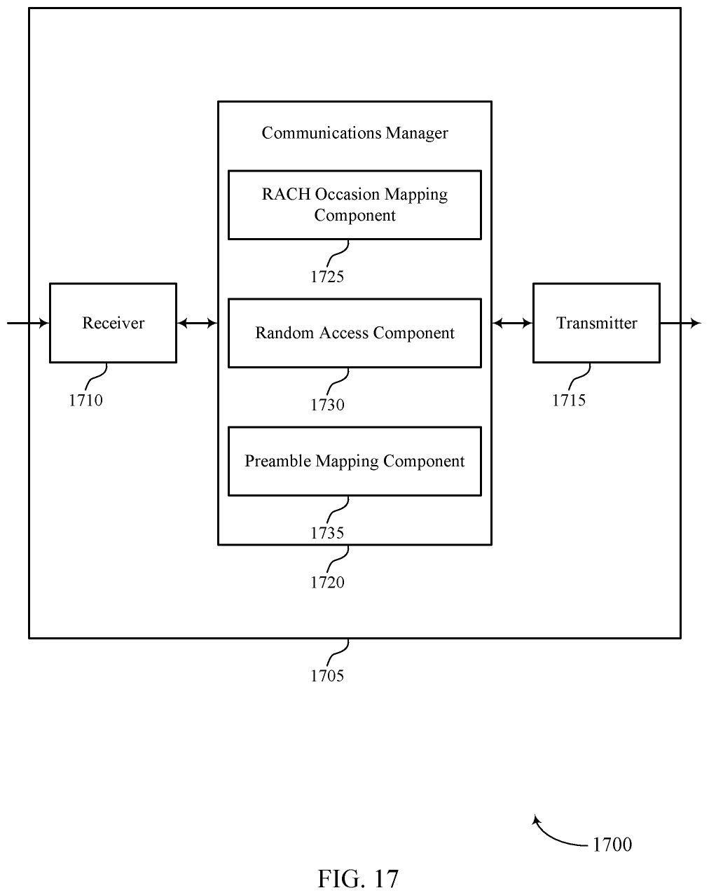

FIG. 17 shows a block diagram 1700 of a device 1705 that supports adapting random access opportunities per SSB index for NES in accordance with one or more aspects of the present disclosure. The device 1705 may be an example of aspects of a device 1605 or a network entity 105 as described herein. The device 1705 may include a receiver 1710, a transmitter 1715, and a communications manager 1720. The device 1705, or one or more components of the device 1705 (e.g., the receiver 1710, the transmitter 1715, and the communications manager 1720), may include at least one processor, which may be coupled with at least one memory, to support the described techniques. Each of these components may be in communication with one another (e.g., via one or more buses).

The receiver 1710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1705. In some examples, the receiver 1710 may support obtaining information by receiving signals via one or more antennas. Additionally, or alternatively, the receiver 1710 may support obtaining information by receiving signals via one or more wired (e.g., electrical, fiber optic) interfaces, wireless interfaces, or any combination thereof.

The transmitter 1715 may provide a means for outputting (e.g., transmitting, providing, conveying, sending) information generated by other components of the device 1705. For example, the transmitter 1715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1715 may support outputting information by transmitting signals via one or more antennas. Additionally, or alternatively, the transmitter 1715 may support outputting information by transmitting signals via one or more wired (e.g., electrical, fiber optic) interfaces, wireless interfaces, or any combination thereof. In some examples, the transmitter 1715 and the receiver 1710 may be co-located in a transceiver, which may include or be coupled with a modem.

The device 1705, or various components thereof, may be an example of means for performing various aspects of adapting random access opportunities per SSB index for NES as described herein. For example, the communications manager 1720 may include a RACH occasion mapping component 1725, a random access component 1730, a preamble mapping component 1735, or any combination thereof. The communications manager 1720 may be an example of aspects of a communications manager 1620 as described herein. In some examples, the communications manager 1720, or various components thereof, may be configured to perform various operations (e.g., receiving, obtaining, monitoring, outputting, transmitting) using or otherwise in cooperation with the receiver 1710, the transmitter 1715, or both. For example, the communications manager 1720 may receive information from the receiver 1710, send information to the transmitter 1715, or be integrated in combination with the receiver 1710, the transmitter 1715, or both to obtain information, output information, or perform various other operations as described herein.

The communications manager 1720 may support wireless communication in accordance with examples as disclosed herein. The RACH occasion mapping component 1725 is capable of, configured to, or operable to support a means for outputting information indicative of a set of multiple quantities of RACH occasions associated with a set of multiple SSB indices, each quantity of RACH occasions of the set of multiple quantities of RACH occasions associated with a respective SSB index of the set of multiple SSB indices. The random access component 1730 is capable of, configured to, or operable to support a means for obtaining one or more messages via one or more RACH occasions in accordance with the information.

Additionally, or alternatively, the communications manager 1720 may support wireless communication in accordance with examples as disclosed herein. The preamble mapping component 1735 is capable of, configured to, or operable to support a means for outputting information indicative of a set of multiple quantities of random access preambles associated with a set of multiple SSB indices, each quantity of random access preambles of the set of multiple quantities of random access preambles associated with a respective SSB index of the set of multiple SSB indices. The random access component 1730 is capable of, configured to, or operable to support a means for obtaining one or more messages via one or more RACH occasions, each message of the one or more messages including a respective random access preamble in accordance with the information.

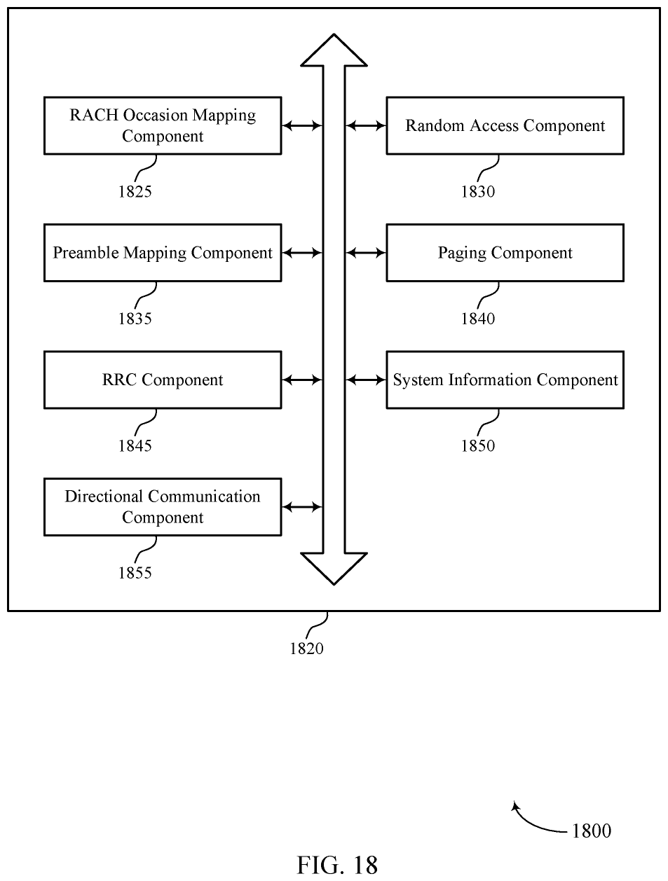

FIG. 18 shows a block diagram 1800 of a communications manager 1820 that supports adapting random access opportunities per SSB index for NES in accordance with one or more aspects of the present disclosure. The communications manager 1820 may be an example of aspects of a communications manager 1620, a communications manager 1720, or both, as described herein. The communications manager 1820, or various components thereof, may be an example of means for performing various aspects of adapting random access opportunities per SSB index for NES as described herein. For example, the communications manager 1820 may include a RACH occasion mapping component 1825, a random access component 1830, a preamble mapping component 1835, a paging component 1840, an RRC component 1845, a system information component 1850, a directional communication component 1855, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1820 may support wireless communication in accordance with examples as disclosed herein. The RACH occasion mapping component 1825 is capable of, configured to, or operable to support a means for outputting information indicative of a set of multiple quantities of RACH occasions associated with a set of multiple SSB indices, each quantity of RACH occasions of the set of multiple quantities of RACH occasions associated with a respective SSB index of the set of multiple SSB indices. The random access component 1830 is capable of, configured to, or operable to support a means for obtaining one or more messages via one or more RACH occasions in accordance with the information.

In some examples, to support outputting the information, the RACH occasion mapping component 1825 is capable of, configured to, or operable to support a means for outputting the information via one or more fields of a RACH configuration information element.

In some examples, the one or more fields include a single field, the single field including an indication of each quantity of RACH occasions of the set of multiple quantities of RACH occasions.

In some examples, a length of the single field is based on a quantity of the set of multiple SSB indices.

In some examples, the one or more fields include a first field and a second field, the first field including an indication of a baseline quantity of RACH occasions and the second field including a set of multiple deltas from the baseline quantity of RACH occasions, each quantity of RACH occasions of the set of multiple quantities of RACH occasions being associated with a respective delta, of the set of multiple deltas, from the baseline quantity of RACH occasions.

In some examples, a length of the second field is based on a quantity of the set of multiple SSB indices.

In some examples, the RACH occasion mapping component 1825 is capable of, configured to, or operable to support a means for mapping the set of multiple SSB indices to RACH occasions in accordance with the information, the obtaining of the one or more messages based on the mapping of the set of multiple SSB indices to the RACH occasions.

In some examples, to support mapping the set of multiple SSB indices to the RACH occasions, the RACH occasion mapping component 1825 is capable of, configured to, or operable to support a means for mapping a first SSB index to a first subset of RACH occasions, the first subset of RACH occasions including a first quantity of RACH occasions, the first quantity of RACH occasions associated with the first SSB index in accordance with the information. In some examples, to support mapping the set of multiple SSB indices to the RACH occasions, the RACH occasion mapping component 1825 is capable of, configured to, or operable to support a means for mapping a second SSB index to a second subset of RACH occasions, the second subset of RACH occasions including a second quantity of RACH occasions, the second quantity of RACH occasions associated with the second SSB index in accordance with the information, the mapping of the second SSB index to the second subset of RACH occasions occurring after the mapping of the first SSB index to the first subset of RACH occasions in accordance with a mapping order.

In some examples, to support mapping the set of multiple SSB indices to the RACH occasions, the RACH occasion mapping component 1825 is capable of, configured to, or operable to support a means for mapping a first SSB index to a first subset of RACH occasions, the first subset of RACH occasions including a largest quantity of RACH occasions of the set of multiple quantities of RACH occasions. In some examples, to support mapping the set of multiple SSB indices to the RACH occasions, the RACH occasion mapping component 1825 is capable of, configured to, or operable to support a means for obtaining a remainder of the first subset of RACH occasions based on a removal of one or more RACH occasions from the first subset of RACH occasions, the remainder of the first subset of RACH occasions including a first quantity of RACH occasions, the first quantity of RACH occasions associated with the first SSB index in accordance with the information.

In some examples, the paging component 1840 is capable of, configured to, or operable to support a means for outputting the information indicative of the set of multiple quantities of RACH occasions associated with the set of multiple SSB indices via a paging indication.

In some examples, the RRC component 1845 is capable of, configured to, or operable to support a means for outputting the information indicative of the set of multiple quantities of RACH occasions associated with the set of multiple SSB indices via RRC signaling.

In some examples, the system information component 1850 is capable of, configured to, or operable to support a means for outputting the information indicative of the set of multiple quantities of RACH occasions associated with the set of multiple SSB indices via an SIB.

In some examples, the directional communication component 1855 is capable of, configured to, or operable to support a means for outputting, to a UE, an indication of an SSB index of the set of multiple SSB indices, the SSB index being associated with a directional communication between the UE and the network entity. In some examples, the random access component 1830 is capable of, configured to, or operable to support a means for obtaining a message from the UE via at least one RACH occasion of a quantity of RACH occasions associated with the SSB index.

Additionally, or alternatively, the communications manager 1820 may support wireless communication in accordance with examples as disclosed herein. The preamble mapping component 1835 is capable of, configured to, or operable to support a means for outputting information indicative of a set of multiple quantities of random access preambles associated with a set of multiple SSB indices, each quantity of random access preambles of the set of multiple quantities of random access preambles associated with a respective SSB index of the set of multiple SSB indices. In some examples, the random access component 1830 is capable of, configured to, or operable to support a means for obtaining one or more messages via one or more RACH occasions, each message of the one or more messages including a respective random access preamble in accordance with the information.

In some examples, to support outputting the information, the preamble mapping component 1835 is capable of, configured to, or operable to support a means for outputting the information via one or more fields of a RACH configuration information element.

In some examples, the one or more fields include a single field, the single field including an indication of each quantity of random access preambles of the set of multiple quantities of random access preambles.

In some examples, a length of the single field is based on a quantity of the set of multiple SSB indices.

In some examples, the one or more fields include a first field and a second field, the first field including an indication of a baseline quantity of random access preambles and the second field including a set of multiple deltas from the baseline quantity of random access preambles, each quantity of random access preambles of the set of multiple quantities of random access preambles associated with a respective delta, of the set of multiple deltas, from the baseline quantity of random access preambles.

In some examples, a length of the second field is based on a quantity of the set of multiple SSB indices.

In some examples, the preamble mapping component 1835 is capable of, configured to, or operable to support a means for selecting a first upper limit quantity of random access preambles per RACH occasion associated with a first SSB index of the set of multiple SSB indices, the first upper limit quantity of random access preambles per RACH occasion being equal to a product of a first quantity of random access preambles and a larger of a value of one or a quantity of SSB indices per RACH occasion, the first quantity of random access preambles associated with the first SSB index in accordance with the information. In some examples, the preamble mapping component 1835 is capable of, configured to, or operable to support a means for selecting a second upper limit quantity of random access preambles per RACH occasion associated with a second SSB index of the set of multiple SSB indices, the second upper limit quantity of random access preambles per RACH occasion being equal to a product of a second quantity of random access preambles and a larger of the value of one or the quantity of SSB indices per RACH occasion, the second quantity of random access preambles associated with the second SSB index in accordance with the information.

In some examples, the preamble mapping component 1835 is capable of, configured to, or operable to support a means for selecting an upper limit quantity of random access preambles per RACH occasion in accordance with a product of a quantity of random access preambles and a larger of a value of one or a quantity of SSB indices per RACH occasion, the quantity of random access preambles being a largest quantity of random access preambles of the set of multiple quantities of random access preambles.

In some examples, the upper limit quantity of random access preambles per RACH occasion is used equally across the set of multiple SSB indices.

In some examples, the paging component 1840 is capable of, configured to, or operable to support a means for outputting the information indicative of the set of multiple quantities of RACH occasions associated with the set of multiple SSB indices via a paging indication.

In some examples, the RRC component 1845 is capable of, configured to, or operable to support a means for outputting the information indicative of the set of multiple quantities of RACH occasions associated with the set of multiple SSB indices via RRC signaling.

In some examples, the system information component 1850 is capable of, configured to, or operable to support a means for outputting the information indicative of the set of multiple quantities of RACH occasions associated with the set of multiple SSB indices via an SIB.

In some examples, the directional communication component 1855 is capable of, configured to, or operable to support a means for outputting, to a UE, an indication of an SSB index of the set of multiple SSB indices, the SSB index being associated with a directional communication between the UE and the network entity. In some examples, the random access component 1830 is capable of, configured to, or operable to support a means for obtaining a message from the UE via a RACH occasion, the message including a random access preamble from a quantity of random access preambles associated with the SSB index.

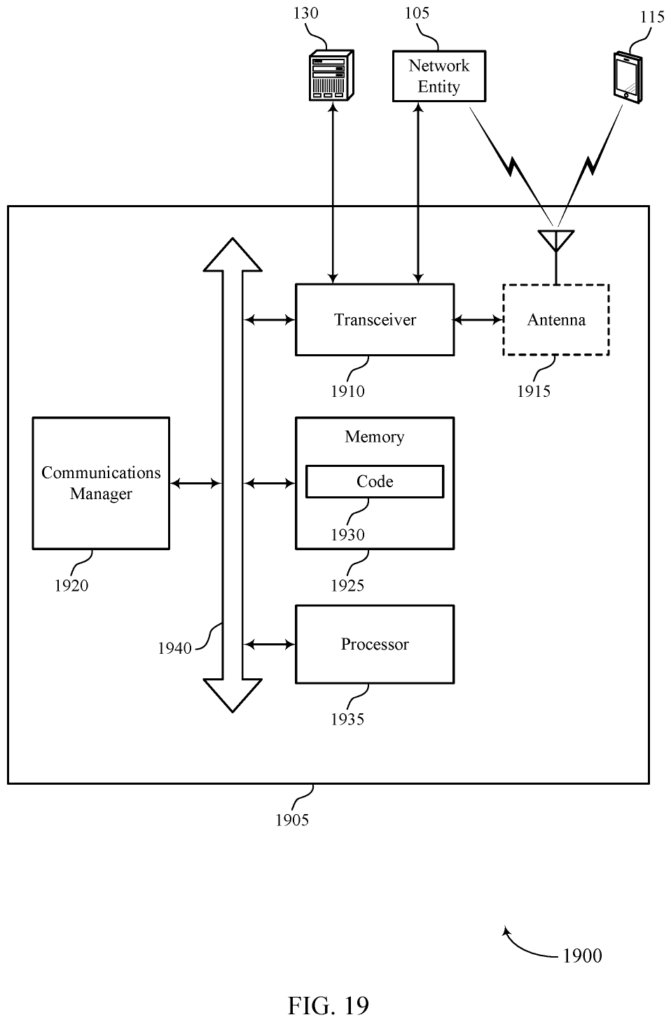

FIG. 19 shows a diagram of a system 1900 including a device 1905 that supports adapting random access opportunities per SSB index for NES in accordance with one or more aspects of the present disclosure. The device 1905 may be an example of or include the components of a device 1605, a device 1705, or a network entity 105 as described herein. The device 1905 may communicate with one or more network entities 105, one or more UEs 115, or any combination thereof, which may include communications over one or more wired interfaces, over one or more wireless interfaces, or any combination thereof. The device 1905 may include components that support outputting and obtaining communications, such as a communications manager 1920, a transceiver 1910, an antenna 1915, at least one memory 1925, code 1930, and at least one processor 1935. These components may be in electronic communication or otherwise coupled (e.g., operatively, communicatively, functionally, electronically, electrically) via one or more buses (e.g., a bus 1940).

The transceiver 1910 may support bi-directional communications via wired links, wireless links, or both as described herein. In some examples, the transceiver 1910 may include a wired transceiver and may communicate bi-directionally with another wired transceiver. Additionally, or alternatively, in some examples, the transceiver 1910 may include a wireless transceiver and may communicate bi-directionally with another wireless transceiver. In some examples, the device 1905 may include one or more antennas 1915, which may be capable of transmitting or receiving wireless transmissions (e.g., concurrently). The transceiver 1910 may also include a modem to modulate signals, to provide the modulated signals for transmission (e.g., by one or more antennas 1915, by a wired transmitter), to receive modulated signals (e.g., from one or more antennas 1915, from a wired receiver), and to demodulate signals. In some implementations, the transceiver 1910 may include one or more interfaces, such as one or more interfaces coupled with the one or more antennas 1915 that are configured to support various receiving or obtaining operations, or one or more interfaces coupled with the one or more antennas 1915 that are configured to support various transmitting or outputting operations, or a combination thereof. In some implementations, the transceiver 1910 may include or be configured for coupling with one or more processors or one or more memory components that are operable to perform or support operations based on received or obtained information or signals, or to generate information or other signals for transmission or other outputting, or any combination thereof. In some implementations, the transceiver 1910, or the transceiver 1910 and the one or more antennas 1915, or the transceiver 1910 and the one or more antennas 1915 and one or more processors or one or more memory components (e.g., the at least one processor 1935, the at least one memory 1925, or both), may be included in a chip or chip assembly that is installed in the device 1905. In some examples, the transceiver 1910 may be operable to support communications via one or more communications links (e.g., a communication link 125, a backhaul communication link 120, a midhaul communication link 162, a fronthaul communication link 168).

The at least one memory 1925 may include RAM, ROM, or any combination thereof. The at least one memory 1925 may store computer-readable, computer-executable code 1930 including instructions that, when executed by one or more of the at least one processor 1935, cause the device 1905 to perform various functions described herein. The code 1930 may be stored in a non-transitory computer-readable medium such as system memory or another type of memory. In some cases, the code 1930 may not be directly executable by a processor of the at least one processor 1935 but may cause a computer (e.g., when compiled and executed) to perform functions described herein. In some cases, the at least one memory 1925 may contain, among other things, a BIOS which may control basic hardware or software operation such as the interaction with peripheral components or devices. In some examples, the at least one processor 1935 may include multiple processors and the at least one memory 1925 may include multiple memories. One or more of the multiple processors may be coupled with one or more of the multiple memories which may, individually or collectively, be configured to perform various functions herein (for example, as part of a processing system).

The at least one processor 1935 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1935 may be configured to operate a memory array using a memory controller. In some other cases, a memory controller may be integrated into one or more of the at least one processor 1935. The at least one processor 1935 may be configured to execute computer-readable instructions stored in a memory (e.g., one or more of the at least one memory 1925) to cause the device 1905 to perform various functions (e.g., functions or tasks supporting adapting random access opportunities per SSB index for NES). For example, the device 1905 or a component of the device 1905 may include at least one processor 1935 and at least one memory 1925 coupled with one or more of the at least one processor 1935, the at least one processor 1935 and the at least one memory 1925 configured to perform various functions described herein. The at least one processor 1935 may be an example of a cloud-computing platform (e.g., one or more physical nodes and supporting software such as operating systems, virtual machines, or container instances) that may host the functions (e.g., by executing code 1930) to perform the functions of the device 1905. The at least one processor 1935 may be any one or more suitable processors capable of executing scripts or instructions of one or more software programs stored in the device 1905 (such as within one or more of the at least one memory 1925). In some examples, the at least one processor 1935 may include multiple processors and the at least one memory 1925 may include multiple memories. One or more of the multiple processors may be coupled with one or more of the multiple memories, which may, individually or collectively, be configured to perform various functions herein. In some examples, the at least one processor 1935 may be a component of a processing system, which may refer to a system (such as a series) of machines, circuitry (including, for example, one or both of processor circuitry (which may include the at least one processor 1935) and memory circuitry (which may include the at least one memory 1925)), or components, that receives or obtains inputs and processes the inputs to produce, generate, or obtain a set of outputs. The processing system may be configured to perform one or more of the functions described herein. For example, the at least one processor 1935 or a processing system including the at least one processor 1935 may be configured to, configurable to, or operable to cause the device 1905 to perform one or more of the functions described herein. Further, as described herein, being “configured to,” being “configurable to,” and being “operable to” may be used interchangeably and may be associated with a capability, when executing code stored in the at least one memory 1925 or otherwise, to perform one or more of the functions described herein.

In some examples, a bus 1940 may support communications of (e.g., within) a protocol layer of a protocol stack. In some examples, a bus 1940 may support communications associated with a logical channel of a protocol stack (e.g., between protocol layers of a protocol stack), which may include communications performed within a component of the device 1905, or between different components of the device 1905 that may be co-located or located in different locations (e.g., where the device 1905 may refer to a system in which one or more of the communications manager 1920, the transceiver 1910, the at least one memory 1925, the code 1930, and the at least one processor 1935 may be located in one of the different components or divided between different components).

In some examples, the communications manager 1920 may manage aspects of communications with a core network 130 (e.g., via one or more wired or wireless backhaul links). For example, the communications manager 1920 may manage the transfer of data communications for client devices, such as one or more UEs 115. In some examples, the communications manager 1920 may manage communications with other network entities 105, and may include a controller or scheduler for controlling communications with UEs 115 in cooperation with other network entities 105. In some examples, the communications manager 1920 may support an X2 interface within an LTE/LTE-A wireless communications network technology to provide communication between network entities 105.

The communications manager 1920 may support wireless communication in accordance with examples as disclosed herein. For example, the communications manager 1920 is capable of, configured to, or operable to support a means for outputting information indicative of a set of multiple quantities of RACH occasions associated with a set of multiple SSB indices, each quantity of RACH occasions of the set of multiple quantities of RACH occasions associated with a respective SSB index of the set of multiple SSB indices. The communications manager 1920 is capable of, configured to, or operable to support a means for obtaining one or more messages via one or more RACH occasions in accordance with the information.

Additionally, or alternatively, the communications manager 1920 may support wireless communication in accordance with examples as disclosed herein. For example, the communications manager 1920 is capable of, configured to, or operable to support a means for outputting information indicative of a set of multiple quantities of random access preambles associated with a set of multiple SSB indices, each quantity of random access preambles of the set of multiple quantities of random access preambles associated with a respective SSB index of the set of multiple SSB indices. The communications manager 1920 is capable of, configured to, or operable to support a means for obtaining one or more messages via one or more RACH occasions, each message of the one or more messages including a respective random access preamble in accordance with the information.

By including or configuring the communications manager 1920 in accordance with examples as described herein, the device 1905 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1920 may be configured to perform various operations (e.g., receiving, obtaining, monitoring, outputting, transmitting) using or otherwise in cooperation with the transceiver 1910, the one or more antennas 1915 (e.g., where applicable), or any combination thereof. Although the communications manager 1920 is illustrated as a separate component, in some examples, one or more functions described with reference to the communications manager 1920 may be supported by or performed by the transceiver 1910, one or more of the at least one processor 1935, one or more of the at least one memory 1925, the code 1930, or any combination thereof (for example, by a processing system including at least a portion of the at least one processor 1935, the at least one memory 1925, the code 1930, or any combination thereof). For example, the code 1930 may include instructions executable by one or more of the at least one processor 1935 to cause the device 1905 to perform various aspects of adapting random access opportunities per SSB index for NES as described herein, or the at least one processor 1935 and the at least one memory 1925 may be otherwise configured to, individually or collectively, perform or support such operations.

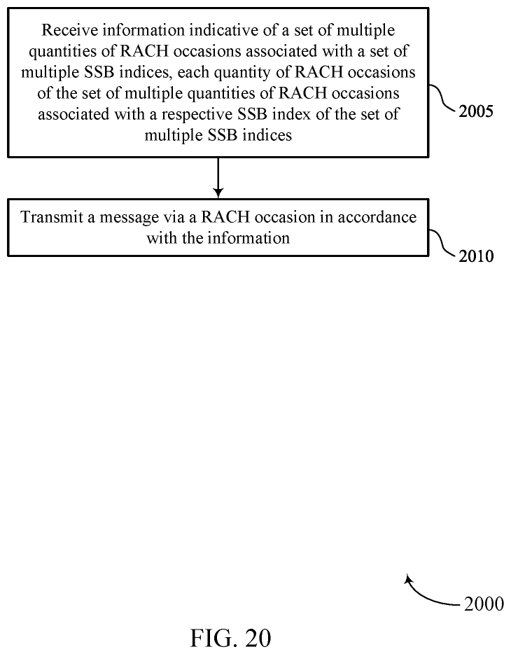

FIG. 20 shows a flowchart illustrating a method 2000 that supports adapting random access opportunities per SSB index for NES in accordance with one or more aspects of the present disclosure. The operations of the method 2000 may be implemented by a UE or its components as described herein. For example, the operations of the method 2000 may be performed by a UE 115 as described with reference to FIGS. 1 through 15. In some examples, a UE may execute a set of instructions to control the functional elements of the UE to perform the described functions. Additionally, or alternatively, the UE may perform aspects of the described functions using special-purpose hardware.

At 2005, the method may include receiving information indicative of a set of multiple quantities of RACH occasions associated with a set of multiple SSB indices, each quantity of RACH occasions of the set of multiple quantities of RACH occasions associated with a respective SSB index of the set of multiple SSB indices. The operations of block 2005 may be performed in accordance with examples as disclosed herein. In some examples, aspects of the operations of 2005 may be performed by a RACH occasion mapping component 1425 as described with reference to FIG. 14.

At 2010, the method may include transmitting a message via a RACH occasion in accordance with the information. The operations of block 2010 may be performed in accordance with examples as disclosed herein. In some examples, aspects of the operations of 2010 may be performed by a random access component 1430 as described with reference to FIG. 14.

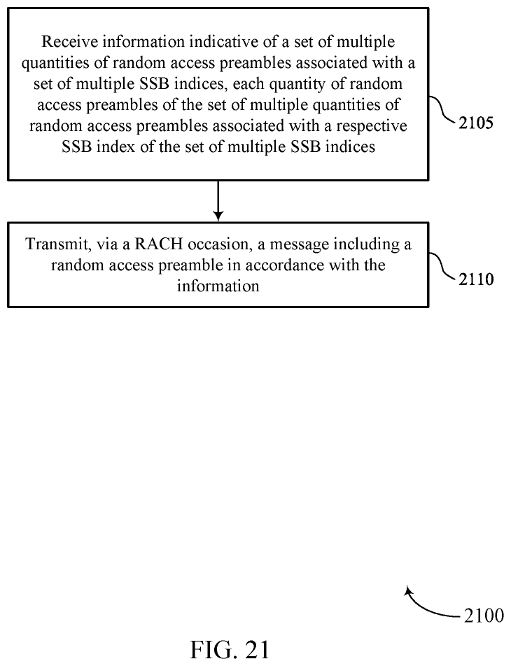

FIG. 21 shows a flowchart illustrating a method 2100 that supports adapting random access opportunities per SSB index for NES in accordance with one or more aspects of the present disclosure. The operations of the method 2100 may be implemented by a UE or its components as described herein. For example, the operations of the method 2100 may be performed by a UE 115 as described with reference to FIGS. 1 through 15. In some examples, a UE may execute a set of instructions to control the functional elements of the UE to perform the described functions. Additionally, or alternatively, the UE may perform aspects of the described functions using special-purpose hardware.

At 2105, the method may include receiving information indicative of a set of multiple quantities of random access preambles associated with a set of multiple SSB indices, each quantity of random access preambles of the set of multiple quantities of random access preambles associated with a respective SSB index of the set of multiple SSB indices. The operations of block 2105 may be performed in accordance with examples as disclosed herein. In some examples, aspects of the operations of 2105 may be performed by a preamble mapping component 1435 as described with reference to FIG. 14.

At 2110, the method may include transmitting, via a RACH occasion, a message including a random access preamble in accordance with the information. The operations of block 2110 may be performed in accordance with examples as disclosed herein. In some examples, aspects of the operations of 2110 may be performed by a random access component 1430 as described with reference to FIG. 14.

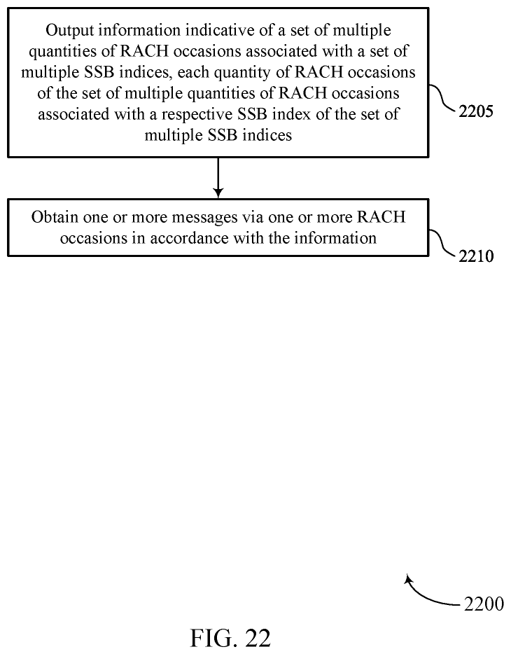

FIG. 22 shows a flowchart illustrating a method 2200 that supports adapting random access opportunities per SSB index for NES in accordance with one or more aspects of the present disclosure. The operations of the method 2200 may be implemented by a network entity or its components as described herein. For example, the operations of the method 2200 may be performed by a network entity as described with reference to FIGS. 1 through 10 and 16 through 19. In some examples, a network entity may execute a set of instructions to control the functional elements of the network entity to perform the described functions. Additionally, or alternatively, the network entity may perform aspects of the described functions using special-purpose hardware.

At 2205, the method may include outputting information indicative of a set of multiple quantities of RACH occasions associated with a set of multiple SSB indices, each quantity of RACH occasions of the set of multiple quantities of RACH occasions associated with a respective SSB index of the set of multiple SSB indices. The operations of block 2205 may be performed in accordance with examples as disclosed herein. In some examples, aspects of the operations of 2205 may be performed by a RACH occasion mapping component 1825 as described with reference to FIG. 18.

At 2210, the method may include obtaining one or more messages via one or more RACH occasions in accordance with the information. The operations of block 2210 may be performed in accordance with examples as disclosed herein. In some examples, aspects of the operations of 2210 may be performed by a random access component 1830 as described with reference to FIG. 18.

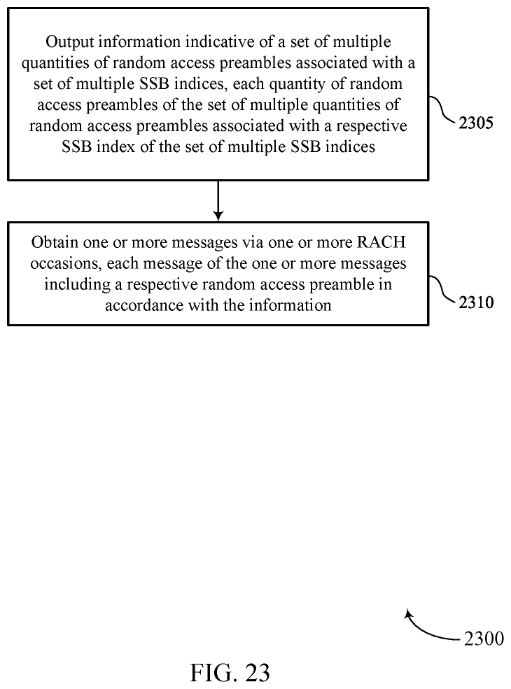

FIG. 23 shows a flowchart illustrating a method 2300 that supports adapting random access opportunities per SSB index for NES in accordance with one or more aspects of the present disclosure. The operations of the method 2300 may be implemented by a network entity or its components as described herein. For example, the operations of the method 2300 may be performed by a network entity as described with reference to FIGS. 1 through 10 and 16 through 19. In some examples, a network entity may execute a set of instructions to control the functional elements of the network entity to perform the described functions. Additionally, or alternatively, the network entity may perform aspects of the described functions using special-purpose hardware.

At 2305, the method may include outputting information indicative of a set of multiple quantities of random access preambles associated with a set of multiple SSB indices, each quantity of random access preambles of the set of multiple quantities of random access preambles associated with a respective SSB index of the set of multiple SSB indices. The operations of block 2305 may be performed in accordance with examples as disclosed herein. In some examples, aspects of the operations of 2305 may be performed by a preamble mapping component 1835 as described with reference to FIG. 18.

At 2310, the method may include obtaining one or more messages via one or more RACH occasions, each message of the one or more messages including a respective random access preamble in accordance with the information. The operations of block 2310 may be performed in accordance with examples as disclosed herein. In some examples, aspects of the operations of 2310 may be performed by a random access component 1830 as described with reference to FIG. 18.

The following provides an overview of aspects of the present disclosure:

Aspect 1: An apparatus for wireless communication at a UE, comprising: one or more memories; and one or more processors coupled with the one or more memories and configured to cause the UE to: receive information indicative of a set of multiple quantities of RACH occasions associated with a set of multiple SSB indices, each quantity of RACH occasions of the set of multiple quantities of RACH occasions associated with a respective SSB index of the set of multiple SSB indices; and transmit a message via a RACH occasion in accordance with the information.

Aspect 2: The apparatus of aspect 1, wherein, to receive the information, the one or more processors are configured to cause the UE to: receive the information via one or more fields of a RACH configuration information element.

Aspect 3: The apparatus of aspect 2, wherein the one or more fields includes a single field, the single field including an indication of each quantity of RACH occasions of the set of multiple quantities of RACH occasions.

Aspect 4: The apparatus of aspect 3, wherein a length of the single field is based on a quantity of the set of multiple SSB indices.

Aspect 5: The apparatus of any of aspects 2-4, wherein the one or more fields include a first field and a second field, the first field including an indication of a baseline quantity of RACH occasions and the second field including a set of multiple deltas from the baseline quantity of RACH occasions, each quantity of RACH occasions of the set of multiple quantities of RACH occasions being associated with a respective delta, of the set of multiple deltas, from the baseline quantity of RACH occasions.

Aspect 6: The apparatus of aspect 5, wherein a length of the second field is based on a quantity of the set of multiple SSB indices.

Aspect 7: The apparatus of any of aspects 1-6, wherein the one or more processors are configured to cause the UE to: map the set of multiple SSB indices to RACH occasions in accordance with the information, the transmitting of the message based on the mapping of the set of multiple SSB indices to the RACH occasions.

Aspect 8: The apparatus of aspect 7, wherein, to map the set of multiple SSB indices to the RACH occasions, the one or more processors are configured to cause the UE to: map a first SSB index to a first subset of RACH occasions, the first subset of RACH occasions including a first quantity of RACH occasions, the first quantity of RACH occasions associated with the first SSB index in accordance with the information; and map a second SSB index to a second subset of RACH occasions, the second subset of RACH occasions including a second quantity of RACH occasions, the second quantity of RACH occasions associated with the second SSB index in accordance with the information, the mapping of the second SSB index to the second subset of RACH occasions occurring after the mapping of the first SSB index to the first subset of RACH occasions in accordance with a mapping order.

Aspect 9: The apparatus of any of aspects 7-8, wherein, to map the set of multiple SSB indices to the RACH occasions, the one or more processors are configured to cause the UE to: map a first SSB index to a first subset of RACH occasions, the first subset of RACH occasions including a largest quantity of RACH occasions of the set of multiple quantities of RACH occasions; and obtain a remainder of the first subset of RACH occasions based on a removal of one or more RACH occasions from the first subset of RACH occasions, the remainder of the first subset of RACH occasions including a first quantity of RACH occasions, the first quantity of RACH occasions associated with the first SSB index in accordance with the information.

Aspect 10: The apparatus of any of aspects 1-9, wherein the one or more processors are configured to cause the UE to: receive the information indicative of the set of multiple quantities of RACH occasions associated with the set of multiple SSB indices via a paging indication.

Aspect 11: The apparatus of any of aspects 1-10, wherein the one or more processors are configured to cause the UE to: receive the information indicative of the set of multiple quantities of RACH occasions associated with the set of multiple SSB indices via RRC signaling.

Aspect 12: The apparatus of any of aspects 1-11, wherein the one or more processors are configured to cause the UE to: receive the information indicative of the set of multiple quantities of RACH occasions associated with the set of multiple SSB indices via an SIB.

Aspect 13: The apparatus of any of aspects 1-12, wherein the one or more processors are configured to cause the UE to: receive an indication of an SSB index of the set of multiple SSB indices, the SSB index being associated with a directional communication between the UE and a network entity; and select the RACH occasion from a quantity of RACH occasions associated with the SSB index.

Aspect 14: An apparatus for wireless communication at a UE, comprising: one or more memories; and one or more processors coupled with the one or more memories and configured to cause the UE to: receive information indicative of a set of multiple quantities of random access preambles associated with a set of multiple SSB indices, each quantity of random access preambles of the set of multiple quantities of random access preambles associated with a respective SSB index of the set of multiple SSB indices; and transmit, via a RACH occasion, a message including a random access preamble in accordance with the information.

Aspect 15: The apparatus of aspect 14, wherein, to receive the information, the one or more processors are configured to cause the UE to: receive the information via one or more fields of a RACH configuration information element.

Aspect 16: The apparatus of aspect 15, wherein the one or more fields include a single field, the single field including an indication of each quantity of random access preambles of the set of multiple quantities of random access preambles.

Aspect 17: The apparatus of aspect 16, wherein a length of the single field is based on a quantity of the set of multiple SSB indices.

Aspect 18: The apparatus of any of aspects 15-17, wherein the one or more fields include a first field and a second field, the first field including an indication of a baseline quantity of random access preambles and the second field including a set of multiple deltas from the baseline quantity of random access preambles, each quantity of random access preambles of the set of multiple quantities of random access preambles being associated with a respective delta, of the set of multiple deltas, from the baseline quantity of random access preambles.

Aspect 19: The apparatus of aspect 18, wherein a length of the second field is based on a quantity of the set of multiple SSB indices.

Aspect 20: The apparatus of any of aspects 14-19, wherein the one or more processors are configured to cause the UE to: select a first upper limit quantity of random access preambles per RACH occasion associated with a first SSB index of the set of multiple SSB indices, the first upper limit quantity of random access preambles per RACH occasion being equal to a product of a first quantity of random access preambles and a larger of a value of one or a quantity of SSB indices per RACH occasion, the first quantity of random access preambles associated with the first SSB index in accordance with the information; and select a second upper limit quantity of random access preambles per RACH occasion associated with a second SSB index of the set of multiple SSB indices, the second upper limit quantity of random access preambles per RACH occasion being equal to a product of a second quantity of random access preambles and a larger of the value of one or the quantity of SSB indices per RACH occasion, the second quantity of random access preambles associated with the second SSB index in accordance with the information.

Aspect 21: The apparatus of any of aspects 14-20, wherein the one or more processors are configured to cause the UE to: select an upper limit quantity of random access preambles per RACH occasion in accordance with a product of a quantity of random access preambles and a larger of a value of one or a quantity of SSB indices per RACH occasion, the quantity of random access preambles being a largest quantity of random access preambles of the set of multiple quantities of random access preambles.

Aspect 22: The apparatus of aspect 21, wherein the upper limit quantity of random access preambles per RACH occasion is used equally across the set of multiple SSB indices.

Aspect 23: The apparatus of any of aspects 14-22, wherein the one or more processors are configured to cause the UE to: receive the information indicative of the set of multiple quantities of RACH occasions associated with the set of multiple SSB indices via a paging indication.

Aspect 24: The apparatus of any of aspects 14-23, wherein the one or more processors are configured to cause the UE to: receive the information indicative of the set of multiple quantities of RACH occasions associated with the set of multiple SSB indices via RRC signaling.

Aspect 25: The apparatus of any of aspects 14-24, wherein the one or more processors are configured to cause the UE to: receive the information indicative of the set of multiple quantities of RACH occasions associated with the set of multiple SSB indices via an SIB.

Aspect 26: The apparatus of any of aspects 14-25, wherein the one or more processors are configured to cause the UE to: receive an indication of an SSB index of the set of multiple SSB indices, the SSB index being associated with a directional communication between the UE and a network entity; and select the random access preamble from a quantity of random access preambles associated with the SSB index.

Aspect 27: An apparatus for wireless communication at a network entity, comprising: one or more memories; and one or more processors coupled with the one or more memories and configured to cause the network entity to: output information indicative of a set of multiple quantities of RACH occasions associated with a set of multiple SSB indices, each quantity of RACH occasions of the set of multiple quantities of RACH occasions associated with a respective SSB index of the set of multiple SSB indices; and obtain one or more messages via one or more RACH occasions in accordance with the information.

Aspect 28: The apparatus of aspect 27, wherein, to output the information, the one or more processors are configured to cause the network entity to: output the information via one or more fields of a RACH configuration information element.

Aspect 29: The apparatus of aspect 28, wherein the one or more fields include a single field, the single field including an indication of each quantity of RACH occasions of the set of multiple quantities of RACH occasions.

Aspect 30: The apparatus of aspect 29, wherein a length of the single field is based on a quantity of the set of multiple SSB indices.

Aspect 31: The apparatus of any of aspects 28-30, wherein the one or more fields include a first field and a second field, the first field including an indication of a baseline quantity of RACH occasions and the second field including a set of multiple deltas from the baseline quantity of RACH occasions, each quantity of RACH occasions of the set of multiple quantities of RACH occasions being associated with a respective delta, of the set of multiple deltas, from the baseline quantity of RACH occasions.

Aspect 32: The apparatus of aspect 31, wherein a length of the second field is based on a quantity of the set of multiple SSB indices.

Aspect 33: The apparatus of any of aspects 27-32, wherein the one or more processors are configured to cause the network entity to: map the set of multiple SSB indices to RACH occasions in accordance with the information, the obtaining of the one or more messages based on the mapping of the set of multiple SSB indices to the RACH occasions.

Aspect 34: The apparatus of aspect 33, wherein, to map the set of multiple SSB indices to the RACH occasions, the one or more processors are configured to cause the network entity to: map a first SSB index to a first subset of RACH occasions, the first subset of RACH occasions including a first quantity of RACH occasions, the first quantity of RACH occasions associated with the first SSB index in accordance with the information; and map a second SSB index to a second subset of RACH occasions, the second subset of RACH occasions including a second quantity of RACH occasions, the second quantity of RACH occasions associated with the second SSB index in accordance with the information, the mapping of the second SSB index to the second subset of RACH occasions occurring after the mapping of the first SSB index to the first subset of RACH occasions in accordance with a mapping order.

Aspect 35: The apparatus of any of aspects 33-34, wherein, to map the set of multiple SSB indices to the RACH occasions, the one or more processors are configured to cause the network entity to: map a first SSB index to a first subset of RACH occasions, the first subset of RACH occasions including a largest quantity of RACH occasions of the set of multiple quantities of RACH occasions; and obtain a remainder of the first subset of RACH occasions based on a removal of one or more RACH occasions from the first subset of RACH occasions, the remainder of the first subset of RACH occasions including a first quantity of RACH occasions, the first quantity of RACH occasions associated with the first SSB index in accordance with the information.

Aspect 36: The apparatus of any of aspects 27-35, wherein the one or more processors are configured to cause the network entity to: output the information indicative of the set of multiple quantities of RACH occasions associated with the set of multiple SSB indices via a paging indication.

Aspect 37: The apparatus of any of aspects 27-36, wherein the one or more processors are configured to cause the network entity to: output the information indicative of the set of multiple quantities of RACH occasions associated with the set of multiple SSB indices via RRC signaling.

Aspect 38: The apparatus of any of aspects 27-37, wherein the one or more processors are configured to cause the network entity to: output the information indicative of the set of multiple quantities of RACH occasions associated with the set of multiple SSB indices via an SIB.

Aspect 39: The apparatus of any of aspects 27-38, wherein the one or more processors are configured to cause the network entity to: output, to a UE, an indication of an SSB index of the set of multiple SSB indices, the SSB index being associated with a directional communication between the UE and the network entity; and obtain a message from the UE via at least one RACH occasion of a quantity of RACH occasions associated with the SSB index.

Aspect 40: An apparatus for wireless communication at a network entity, comprising: one or more memories; and one or more processors coupled with the one or more memories and configured to cause the network entity to: output information indicative of a set of multiple quantities of random access preambles associated with a set of multiple SSB indices, each quantity of random access preambles of the set of multiple quantities of random access preambles associated with a respective SSB index of the set of multiple SSB indices; and obtain one or more messages via one or more RACH occasions, each message of the one or more messages including a respective random access preamble in accordance with the information.

Aspect 41: The apparatus of aspect 40, wherein, to output the information, the one or more processors are configured to cause the network entity to: output the information via one or more fields of a RACH configuration information element.

Aspect 42: The apparatus of aspect 41, wherein the one or more fields include a single field, the single field including an indication of each quantity of random access preambles of the set of multiple quantities of random access preambles.

Aspect 43: The apparatus of aspect 42, wherein a length of the single field is based on a quantity of the set of multiple SSB indices.

Aspect 44: The apparatus of any of aspects 41-43, wherein the one or more fields include a first field and a second field, the first field including an indication of a baseline quantity of random access preambles and the second field including a set of multiple deltas from the baseline quantity of random access preambles, each quantity of random access preambles of the set of multiple quantities of random access preambles being associated with a respective delta, of the set of multiple deltas, from the baseline quantity of random access preambles.

Aspect 45: The apparatus of aspect 44, wherein a length of the second field is based on a quantity of the set of multiple SSB indices.

Aspect 46: The apparatus of any of aspects 40-45, wherein the one or more processors are configured to cause the network entity to: select a first upper limit quantity of random access preambles per RACH occasion associated with a first SSB index of the set of multiple SSB indices, the first upper limit quantity of random access preambles per RACH occasion being equal to a product of a first quantity of random access preambles and a larger of a value of one or a quantity of SSB indices per RACH occasion, the first quantity of random access preambles associated with the first SSB index in accordance with the information; and select a second upper limit quantity of random access preambles per RACH occasion associated with a second SSB index of the set of multiple SSB indices, the second upper limit quantity of random access preambles per RACH occasion being equal to a product of a second quantity of random access preambles and a larger of the value of one or the quantity of SSB indices per RACH occasion, the second quantity of random access preambles associated with the second SSB index in accordance with the information.

Aspect 47: The apparatus of any of aspects 40-46, wherein the one or more processors are configured to cause the network entity to: select an upper limit quantity of random access preambles per RACH occasion in accordance with a product of a quantity of random access preambles and a larger of a value of one or a quantity of SSB indices per RACH occasion, the quantity of random access preambles being a largest quantity of random access preambles of the set of multiple quantities of random access preambles.

Aspect 48: The apparatus of aspect 47, wherein the upper limit quantity of random access preambles per RACH occasion is used equally across the set of multiple SSB indices.

Aspect 49: The apparatus of any of aspects 40-48, wherein the one or more processors are configured to cause the network entity to: output the information indicative of the set of multiple quantities of RACH occasions associated with the set of multiple SSB indices via a paging indication.

Aspect 50: The apparatus of any of aspects 40-49, wherein the one or more processors are configured to cause the network entity to: output the information indicative of the set of multiple quantities of RACH occasions associated with the set of multiple SSB indices via RRC signaling.

Aspect 51: The apparatus of any of aspects 40-50, wherein the one or more processors are configured to cause the network entity to: output the information indicative of the set of multiple quantities of RACH occasions associated with the set of multiple SSB indices via an SIB.

Aspect 52: The apparatus of any of aspects 40-51, wherein the one or more processors are configured to cause the network entity to: output, to a UE, an indication of an SSB index of the set of multiple SSB indices, the SSB index being associated with a directional communication between the UE and the network entity; and obtain a message from the UE via a RACH occasion, the message including a random access preamble from a quantity of random access preambles associated with the SSB index.

Aspect 53: A method for wireless communication by a UE, comprising: receiving information indicative of a plurality of quantities of RACH occasions associated with a plurality of SSB indices, each quantity of RACH occasions of the plurality of quantities of RACH occasions associated with a respective SSB index of the plurality of SSB indices; and transmitting a message via a RACH occasion in accordance with the information.

Aspect 54: The method of aspect 53, wherein receiving the information further comprises: receiving the information via one or more fields of a RACH configuration information element.

Aspect 55: The method of aspect 54, wherein the one or more fields includes a single field, the single field including an indication of each quantity of RACH occasions of the plurality of quantities of RACH occasions.

Aspect 56: The method of aspect 55, wherein a length of the single field is based at least in part on a quantity of the plurality of SSB indices.

Aspect 57: The method of any of aspects 54-56, wherein the one or more fields include a first field and a second field, the first field including an indication of a baseline quantity of RACH occasions and the second field including a plurality of deltas from the baseline quantity of RACH occasions, each quantity of RACH occasions of the plurality of quantities of RACH occasions being associated with a respective delta, of the plurality of deltas, from the baseline quantity of RACH occasions.

Aspect 58: The method of aspect 57, wherein a length of the second field is based at least in part on a quantity of the plurality of SSB indices.

Aspect 59: The method of any of aspects 53-58, further comprising: mapping the plurality of SSB indices to RACH occasions in accordance with the information, the transmitting of the message based at least in part on the mapping of the plurality of SSB indices to the RACH occasions.

Aspect 60: The method of aspect 59, wherein mapping the plurality of SSB indices to the RACH occasions further comprises: mapping a first SSB index to a first subset of RACH occasions, the first subset of RACH occasions including a first quantity of RACH occasions, the first quantity of RACH occasions associated with the first SSB index in accordance with the information; and mapping a second SSB index to a second subset of RACH occasions, the second subset of RACH occasions including a second quantity of RACH occasions, the second quantity of RACH occasions associated with the second SSB index in accordance with the information, the mapping of the second SSB index to the second subset of RACH occasions occurring after the mapping of the first SSB index to the first subset of RACH occasions in accordance with a mapping order.

Aspect 61: The method of any of aspects 59-60, wherein mapping the plurality of SSB indices to the RACH occasions further comprises: mapping a first SSB index to a first subset of RACH occasions, the first subset of RACH occasions including a largest quantity of RACH occasions of the plurality of quantities of RACH occasions; and obtaining a remainder of the first subset of RACH occasions based at least in part on a removal of one or more RACH occasions from the first subset of RACH occasions, the remainder of the first subset of RACH occasions including a first quantity of RACH occasions, the first quantity of RACH occasions associated with the first SSB index in accordance with the information.

Aspect 62: The method of any of aspects 53-61, further comprising: receiving the information indicative of the plurality of quantities of RACH occasions associated with the plurality of SSB indices via a paging indication.

Aspect 63: The method of any of aspects 53-62, further comprising: receiving the information indicative of the plurality of quantities of RACH occasions associated with the plurality of SSB indices via RRC signaling.

Aspect 64: The method of any of aspects 53-63, further comprising: receiving the information indicative of the plurality of quantities of RACH occasions associated with the plurality of SSB indices via an SIB.

Aspect 65: The method of any of aspects 53-64, further comprising: receiving an indication of an SSB index of the plurality of SSB indices, the SSB index being associated with a directional communication between the UE and a network entity; and selecting the RACH occasion from a quantity of RACH occasions associated with the SSB index.

Aspect 66: A method for wireless communication by a UE, comprising: receiving information indicative of a plurality of quantities of random access preambles associated with a plurality of SSB indices, each quantity of random access preambles of the plurality of quantities of random access preambles associated with a respective SSB index of the plurality of SSB indices; and transmitting, via a RACH occasion, a message including a random access preamble in accordance with the information.

Aspect 67: The method of aspect 66, wherein receiving the information further comprises: receiving the information via one or more fields of a RACH configuration information element.

Aspect 68: The method of aspect 67, wherein the one or more fields include a single field, the single field including an indication of each quantity of random access preambles of the plurality of quantities of random access preambles.

Aspect 69: The method of aspect 68, wherein a length of the single field is based at least in part on a quantity of the plurality of SSB indices.

Aspect 70: The method of any of aspects 67-69, wherein the one or more fields include a first field and a second field, the first field including an indication of a baseline quantity of random access preambles and the second field including a plurality of deltas from the baseline quantity of random access preambles, each quantity of random access preambles of the plurality of quantities of random access preambles being associated with a respective delta, of the plurality of deltas, from the baseline quantity of random access preambles.

Aspect 71: The method of aspect 70, wherein a length of the second field is based at least in part on a quantity of the plurality of SSB indices.

Aspect 72: The method of any of aspects 66-71, further comprising: selecting a first upper limit quantity of random access preambles per RACH occasion associated with a first SSB index of the plurality of SSB indices, the first upper limit quantity of random access preambles per RACH occasion being equal to a product of a first quantity of random access preambles and a larger of a value of one or a quantity of SSB indices per RACH occasion, the first quantity of random access preambles associated with the first SSB index in accordance with the information; and selecting a second upper limit quantity of random access preambles per RACH occasion associated with a second SSB index of the plurality of SSB indices, the second upper limit quantity of random access preambles per RACH occasion being equal to a product of a second quantity of random access preambles and a larger of the value of one or the quantity of SSB indices per RACH occasion, the second quantity of random access preambles associated with the second SSB index in accordance with the information.

Aspect 73: The method of any of aspects 66-72, further comprising: selecting an upper limit quantity of random access preambles per RACH occasion in accordance with a product of a quantity of random access preambles and a larger of a value of one or a quantity of SSB indices per RACH occasion, the quantity of random access preambles being a largest quantity of random access preambles of the plurality of quantities of random access preambles.

Aspect 74: The method of aspect 73, wherein the upper limit quantity of random access preambles per RACH occasion is used equally across the plurality of SSB indices.

Aspect 75: The method of any of aspects 66-74, further comprising: receiving the information indicative of the plurality of quantities of RACH occasions associated with the plurality of SSB indices via a paging indication.

Aspect 76: The method of any of aspects 66-75, further comprising: receiving the information indicative of the plurality of quantities of RACH occasions associated with the plurality of SSB indices via RRC signaling.

Aspect 77: The method of any of aspects 66-76, further comprising: receiving the information indicative of the plurality of quantities of RACH occasions associated with the plurality of SSB indices via an SIB.

Aspect 78: The method of any of aspects 66-77, further comprising: receiving an indication of an SSB index of the plurality of SSB indices, the SSB index being associated with a directional communication between the UE and a network entity; and selecting the random access preamble from a quantity of random access preambles associated with the SSB index.

Aspect 79: A method for wireless communication by a network entity, comprising: outputting information indicative of a plurality of quantities of RACH occasions associated with a plurality of SSB indices, each quantity of RACH occasions of the plurality of quantities of RACH occasions associated with a respective SSB index of the plurality of SSB indices; and obtaining one or more messages via one or more RACH occasions in accordance with the information.

Aspect 80: The method of aspect 79, wherein outputting the information further comprises: outputting the information via one or more fields of a RACH configuration information element.

Aspect 81: The method of aspect 80, wherein the one or more fields include a single field, the single field including an indication of each quantity of RACH occasions of the plurality of quantities of RACH occasions.

Aspect 82: The method of aspect 81, wherein a length of the single field is based at least in part on a quantity of the plurality of SSB indices.

Aspect 83: The method of any of aspects 80-82, wherein the one or more fields include a first field and a second field, the first field including an indication of a baseline quantity of RACH occasions and the second field including a plurality of deltas from the baseline quantity of RACH occasions, each quantity of RACH occasions of the plurality of quantities of RACH occasions being associated with a respective delta, of the plurality of deltas, from the baseline quantity of RACH occasions.

Aspect 84: The method of aspect 83, wherein a length of the second field is based at least in part on a quantity of the plurality of SSB indices.

Aspect 85: The method of any of aspects 79-84, further comprising: mapping the plurality of SSB indices to RACH occasions in accordance with the information, the obtaining of the one or more messages based at least in part on the mapping of the plurality of SSB indices to the RACH occasions.

Aspect 86: The method of aspect 85, wherein mapping the plurality of SSB indices to the RACH occasions further comprises: mapping a first SSB index to a first subset of RACH occasions, the first subset of RACH occasions including a first quantity of RACH occasions, the first quantity of RACH occasions associated with the first SSB index in accordance with the information; and mapping a second SSB index to a second subset of RACH occasions, the second subset of RACH occasions including a second quantity of RACH occasions, the second quantity of RACH occasions associated with the second SSB index in accordance with the information, the mapping of the second SSB index to the second subset of RACH occasions occurring after the mapping of the first SSB index to the first subset of RACH occasions in accordance with a mapping order.

Aspect 87: The method of any of aspects 85-86, wherein mapping the plurality of SSB indices to the RACH occasions further comprises: mapping a first SSB index to a first subset of RACH occasions, the first subset of RACH occasions including a largest quantity of RACH occasions of the plurality of quantities of RACH occasions; and obtaining a remainder of the first subset of RACH occasions based at least in part on a removal of one or more RACH occasions from the first subset of RACH occasions, the remainder of the first subset of RACH occasions including a first quantity of RACH occasions, the first quantity of RACH occasions associated with the first SSB index in accordance with the information.

Aspect 88: The method of any of aspects 79-87, further comprising: outputting the information indicative of the plurality of quantities of RACH occasions associated with the plurality of SSB indices via a paging indication.

Aspect 89: The method of any of aspects 79-88, further comprising: outputting the information indicative of the plurality of quantities of RACH occasions associated with the plurality of SSB indices via RRC signaling.

Aspect 90: The method of any of aspects 79-89, further comprising: outputting the information indicative of the plurality of quantities of RACH occasions associated with the plurality of SSB indices via an SIB.

Aspect 91: The method of any of aspects 79-90, further comprising: outputting, to a UE, an indication of an SSB index of the plurality of SSB indices, the SSB index being associated with a directional communication between the UE and the network entity; and obtaining a message from the UE via at least one RACH occasion of a quantity of RACH occasions associated with the SSB index.

Aspect 92: A method for wireless communication by a network entity, comprising: outputting information indicative of a plurality of quantities of random access preambles associated with a plurality of SSB indices, each quantity of random access preambles of the plurality of quantities of random access preambles associated with a respective SSB index of the plurality of SSB indices; and obtaining one or more messages via one or more RACH occasions, each message of the one or more messages including a respective random access preamble in accordance with the information.

Aspect 93: The method of aspect 92, wherein outputting the information further comprises: outputting the information via one or more fields of a RACH configuration information element.

Aspect 94: The method of aspect 93, wherein the one or more fields include a single field, the single field including an indication of each quantity of random access preambles of the plurality of quantities of random access preambles.

Aspect 95: The method of aspect 94, wherein a length of the single field is based at least in part on a quantity of the plurality of SSB indices.

Aspect 96: The method of any of aspects 93-95, wherein the one or more fields include a first field and a second field, the first field including an indication of a baseline quantity of random access preambles and the second field including a plurality of deltas from the baseline quantity of random access preambles, each quantity of random access preambles of the plurality of quantities of random access preambles being associated with a respective delta, of the plurality of deltas, from the baseline quantity of random access preambles.

Aspect 97: The method of aspect 96, wherein a length of the second field is based at least in part on a quantity of the plurality of SSB indices.

Aspect 98: The method of any of aspects 92-97, further comprising: selecting a first upper limit quantity of random access preambles per RACH occasion associated with a first SSB index of the plurality of SSB indices, the first upper limit quantity of random access preambles per RACH occasion being equal to a product of a first quantity of random access preambles and a larger of a value of one or a quantity of SSB indices per RACH occasion, the first quantity of random access preambles associated with the first SSB index in accordance with the information; and selecting a second upper limit quantity of random access preambles per RACH occasion associated with a second SSB index of the plurality of SSB indices, the second upper limit quantity of random access preambles per RACH occasion being equal to a product of a second quantity of random access preambles and a larger of the value of one or the quantity of SSB indices per RACH occasion, the second quantity of random access preambles associated with the second SSB index in accordance with the information.

Aspect 99: The method of any of aspects 92-98, further comprising: selecting an upper limit quantity of random access preambles per RACH occasion in accordance with a product of a quantity of random access preambles and a larger of a value of one or a quantity of SSB indices per RACH occasion, the quantity of random access preambles being a largest quantity of random access preambles of the plurality of quantities of random access preambles.

Aspect 100: The method of aspect 99, wherein the upper limit quantity of random access preambles per RACH occasion is used equally across the plurality of SSB indices.

Aspect 101: The method of any of aspects 92-100, further comprising: outputting the information indicative of the plurality of quantities of RACH occasions associated with the plurality of SSB indices via a paging indication.

Aspect 102: The method of any of aspects 92-101, further comprising: outputting the information indicative of the plurality of quantities of RACH occasions associated with the plurality of SSB indices via RRC signaling.

Aspect 103: The method of any of aspects 92-102, further comprising: outputting the information indicative of the plurality of quantities of RACH occasions associated with the plurality of SSB indices via an SIB.

Aspect 104: The method of any of aspects 92-103, further comprising: outputting, to a UE, an indication of an SSB index of the plurality of SSB indices, the SSB index being associated with a directional communication between the UE and the network entity; and obtaining a message from the UE via a RACH occasion, the message including a random access preamble from a quantity of random access preambles associated with the SSB index.

Aspect 105: The method of any of aspects 53-65, wherein the information indicates that a first set of RACH occasions are associated with a first SSB index and that a second set of RACH occasions are associated with a second SSB index.

Aspect 106: The method of any of aspects 66-78, wherein the information indicates that a first set of random access preambles are associated with a first SSB index and that a second set of random access preambles are associated with a second SSB index.

Aspect 107: The method of any of aspects 79-91, wherein the information indicates that a first set of RACH occasions are associated with a first SSB index and that a second set of RACH occasions are associated with a second SSB index.

Aspect 108: The method of any of aspects 92-104, wherein the information indicates that a first set of random access preambles are associated with a first SSB index and that a second set of random access preambles are associated with a second SSB index.

Aspect 109: An apparatus for wireless communication at a UE, comprising at least one means for performing a method of any of aspects 53-65 or 105.

Aspect 110: A non-transitory computer-readable medium storing code for wireless communication at a UE, the code comprising instructions executable by one or more processors to perform a method of any of aspects 53-65 or 105.

Aspect 111: An apparatus for wireless communication at a UE, comprising at least one means for performing a method of any of aspects 66-78 or 106.

Aspect 112: A non-transitory computer-readable medium storing code for wireless communication at a UE, the code comprising instructions executable by one or more processors to perform a method of any of aspects 66-78 or 106.

Aspect 113: An apparatus for wireless communication at a network entity, comprising at least one means for performing a method of any of aspects 79-91 or 107.

Aspect 114: A non-transitory computer-readable medium storing code for wireless communication at a network entity, the code comprising instructions executable by one or more processors to perform a method of any of aspects 79-91 or 107.

Aspect 115: An apparatus for wireless communication at a network entity, comprising at least one means for performing a method of any of aspects 92-104 or 108.

Aspect 116: A non-transitory computer-readable medium storing code for wireless communication at a network entity, the code comprising instructions executable by one or more processors to perform a method of any of aspects 92-104 or 108.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
one or more memories; and
one or more processors coupled with the one or more memories and configured to cause the UE to:
receive information indicative of a plurality of quantities of random access channel (RACH) occasions associated with a plurality of synchronization signal block (SSB) indices, each quantity of RACH occasions of the plurality of quantities of RACH occasions associated with a respective SSB index of the plurality of SSB indices; and
transmit a message via a RACH occasion in accordance with the information.

2. The apparatus of claim 1, the one or more processors, to receive the information, further configured to cause the UE to:
receive the information via one or more fields of a RACH configuration information element.

3. The apparatus of claim 2, wherein the one or more fields includes a single field, and wherein the single field includes an indication of each quantity of RACH occasions of the plurality of quantities of RACH occasions.

4. The apparatus of claim 3, wherein a length of the single field is based at least in part on a quantity of the plurality of SSB indices.

5. The apparatus of claim 2, wherein the one or more fields include a first field and a second field, and wherein the first field includes an indication of a baseline quantity of RACH occasions and the second field includes a plurality of deltas from the baseline quantity of RACH occasions, each quantity of RACH occasions of the plurality of quantities of RACH occasions associated with a respective delta, of the plurality of deltas, from the baseline quantity of RACH occasions.

6. The apparatus of claim 5, wherein a length of the second field is based at least in part on a quantity of the plurality of SSB indices.

7. The apparatus of claim 1, the one or more processors further configured to cause the UE to:
map the plurality of SSB indices to RACH occasions in accordance with the information, wherein transmission of the message is based at least in part on the map of the plurality of SSB indices to the RACH occasions.

8. The apparatus of claim 7, the one or more processors, to map the plurality of SSB indices to the RACH occasions, further configured to cause the UE to:
map a first SSB index to a first subset of RACH occasions, wherein the first subset of RACH occasions includes a first quantity of RACH occasions, the first quantity of RACH occasions associated with the first SSB index in accordance with the information; and
map a second SSB index to a second subset of RACH occasions, wherein the second subset of RACH occasions includes a second quantity of RACH occasions, the second quantity of RACH occasions associated with the second SSB index in accordance with the information, and wherein the map of the second SSB index to the second subset of RACH occasions occurs after the map of the first SSB index to the first subset of RACH occasions in accordance with a mapping order.

9. The apparatus of claim 7, the one or more processors, to map the plurality of SSB indices to the RACH occasions, further configured to cause the UE to:
map a first SSB index to a first subset of RACH occasions, wherein the first subset of RACH occasions includes a largest quantity of RACH occasions of the plurality of quantities of RACH occasions; and
obtain a remainder of the first subset of RACH occasions based at least in part on a removal of one or more RACH occasions from the first subset of RACH occasions, wherein the remainder of the first subset of RACH occasions includes a first quantity of RACH occasions, the first quantity of RACH occasions associated with the first SSB index in accordance with the information.

10. The apparatus of claim 1, the one or more processors further configured to cause the UE to:
receive the information indicative of the plurality of quantities of RACH occasions associated with the plurality of SSB indices via a paging indication.

11. The apparatus of claim 1, the one or more processors further configured to cause the UE to:
receive the information indicative of the plurality of quantities of RACH occasions associated with the plurality of SSB indices via radio resource control (RRC) signaling.

12. The apparatus of claim 1, the one or more processors further configured to cause the UE to:
receive the information indicative of the plurality of quantities of RACH occasions associated with the plurality of SSB indices via a system information block (SIB).

13. The apparatus of claim 1, further comprising:
an antenna array configured to cause the UE to:
receive an indication of an SSB index of the plurality of SSB indices, wherein the SSB index is associated with a directional communication between the UE and a network entity; and
the one or more processors further configured to cause the UE to:
select the RACH occasion from a quantity of RACH occasions associated with the SSB index.

14. An apparatus for wireless communication at a user equipment (UE), comprising:
one or more memories; and
one or more processors coupled with the one or more memories and configured to cause the UE to:
receive information indicative of a plurality of quantities of random access preambles associated with a plurality of synchronization signal block (SSB) indices, each quantity of random access preambles of the plurality of quantities of random access preambles associated with a respective SSB index of the plurality of SSB indices; and
transmit, via a random access channel (RACH) occasion, a message that includes a random access preamble in accordance with the information.

15. The apparatus of claim 14, the one or more processors, to receive the information, further configured to cause the UE to:
receive the information via one or more fields of a RACH configuration information element.

16. The apparatus of claim 15, wherein the one or more fields include a single field, and wherein the single field includes an indication of each quantity of random access preambles of the plurality of quantities of random access preambles.

17. The apparatus of claim 16, wherein a length of the single field is based at least in part on a quantity of the plurality of SSB indices.

18. The apparatus of claim 15, wherein the one or more fields include a first field and a second field, and wherein the first field includes an indication of a baseline quantity of random access preambles and the second field includes a plurality of deltas from the baseline quantity of random access preambles, each quantity of random access preambles of the plurality of quantities of random access preambles associated with a respective delta, of the plurality of deltas, from the baseline quantity of random access preambles.

19. The apparatus of claim 18, wherein a length of the second field is based at least in part on a quantity of the plurality of SSB indices.

20. The apparatus of claim 14, the one or more processors further configured to cause the UE to:
select a first upper limit quantity of random access preambles per RACH occasion associated with a first SSB index of the plurality of SSB indices, the first upper limit quantity of random access preambles per RACH occasion equal to a product of a first quantity of random access preambles and a larger of a value of one or a quantity of SSB indices per RACH occasion, the first quantity of random access preambles associated with the first SSB index in accordance with the information; and
select a second upper limit quantity of random access preambles per RACH occasion associated with a second SSB index of the plurality of SSB indices, the second upper limit quantity of random access preambles per RACH occasion equal to a product of a second quantity of random access preambles and a larger of the value of one or the quantity of SSB indices per RACH occasion, the second quantity of random access preambles associated with the second SSB index in accordance with the information.

21. The apparatus of claim 14, the one or more processors further configured to cause the UE to:
select an upper limit quantity of random access preambles per RACH occasion in accordance with a product of a quantity of random access preambles and a larger of a value of one or a quantity of SSB indices per RACH occasion, wherein the quantity of random access preambles is a largest quantity of random access preambles of the plurality of quantities of random access preambles.

22. The apparatus of claim 21, wherein the upper limit quantity of random access preambles per RACH occasion is used equally across the plurality of SSB indices.

23. The apparatus of claim 14, the one or more processors further configured to cause the UE to:
receive the information indicative of the plurality of quantities of RACH occasions associated with the plurality of SSB indices via a paging indication.

24. The apparatus of claim 14, the one or more processors further configured to cause the UE to:
receive the information indicative of the plurality of quantities of RACH occasions associated with the plurality of SSB indices via radio resource control (RRC) signaling.

25. The apparatus of claim 14, the one or more processors further configured to cause the UE to:
receive the information indicative of the plurality of quantities of RACH occasions associated with the plurality of SSB indices via a system information block (SIB).

26. The apparatus of claim 14, further comprising:
an antenna array configured to cause the UE to:
receive an indication of an SSB index of the plurality of SSB indices, the SSB index associated with a directional communication between the UE and a network entity; and
the one or more processors further configured to cause the UE to:
select the random access preamble from a quantity of random access preambles associated with the SSB index.

27. An apparatus for wireless communication at a network entity, comprising:
one or more memories; and
one or more processors coupled with the one or more memories and configured to cause the network entity to:
output information indicative of a plurality of quantities of random access channel (RACH) occasions associated with a plurality of synchronization signal block (SSB) indices, each quantity of RACH occasions of the plurality of quantities of RACH occasions associated with a respective SSB index of the plurality of SSB indices; and
obtain one or more messages via one or more RACH occasions in accordance with the information.

28. The apparatus of claim 27, further comprising an antenna array configured to cause the network entity to:
output the information via one or more fields of a RACH configuration information element.

29. An apparatus for wireless communication at a network entity, comprising:
one or more memories; and
one or more processors coupled with the one or more memories and configured to cause the network entity to:
output information indicative of a plurality of quantities of random access preambles associated with a plurality of synchronization signal block (SSB) indices, each quantity of random access preambles of the plurality of quantities of random access preambles associated with a respective SSB index of the plurality of SSB indices; and
obtain one or more messages via one or more random access channel (RACH) occasions, wherein each message of the one or more messages includes a respective random access preamble in accordance with the information.

30. The apparatus of claim 29, further comprising an antenna array configured to cause the network entity to:
output the information via one or more fields of a RACH configuration information element.
